(19) United States
(12) Patent Application Publication
(10) Pub. No.: US 2022/0411665 A1
(43) Pub. Date: Dec. 29, 2022

(54) ADHESIVE COMPOSITIONS AND KITS FOR APPLICATION OF SCREEN PROTECTORS

(71) Applicant: CORNING INCORPORATED, CORNING, NY (US)

(72) Inventors: Daniel James Beyler, Breesport, NY (US); Rui Chang, Corning, NY (US); Hossein Eshraghi, Painted Post, NY (US); George Karl Kaufman, Painted Post, NY (US); Laurence Ralph Morey, Painted Post, NY (US); Patrick Ryan Pruden, Corning, NY (US); Vitor Marino Schneider, Painted Post, NY (US)

(21) Appl. No.: 17/778,726

(22) PCT Filed: Nov. 24, 2020
(86) PCT No.: PCT/US2020/061916

§ 371 Date: May 20, 2022

Related U.S. Application Data
(60) Provisional application No. 62/957,610, filed on Jan. 6, 2020.
(60) Provisional application No. 62/940,983, filed on Nov. 27, 2019.
(60) Provisional application No. 62/941,136, filed on Nov. 27, 2019.
(60) Provisional application No. 62/941,161, filed on Nov. 27, 2019.

(51) Int. Cl. C09J 7/20; C09J 11/06

(52) U.S. Cl. CPC C09J 7/20; C09J 11/06; C09J 2301/122; C09J 2301/204; C09J 2301/312; C09J 2301/416; C09J 2301/408; C09J 2400/143

(57) ABSTRACT

A screen protector application kit includes a glass-based substrate (110) having an adhesive belt (270) and an adhesive container (478) of an uncured adhesive composition. The adhesive belt (270) includes a first major surface (272) adhered to the glass-based substrate (110), a second major surface (274), a distal edge (276) extending between the first major surface (272) and the second major surface (274), and a proximal edge (278) extending between the first major surface (272) and the second major surface (274). The uncured adhesive composition includes 30 wt % to 99.9 wt % of at least one of: (i) a monomer; and (ii) an oligomer; and 0.01 wt % to 10 wt % of a visible-light photoinitiator. The uncured adhesive composition may further include 0.1 wt % to 10 wt % of a co-initiator. The uncured adhesive composition may further include 0.1 wt % to 5 wt % of an oxygen inhibitor.

### CROSS-REFERENCE TO RELATED APPLICATIONS

This application claims the benefit of priority of U.S. Provisional Application Ser. No. 62/940,983 filed on Nov. 27, 2019, U.S. Provisional Application Ser. No. 62/941,136 filed on Nov. 27, 2019, U.S. Provisional Application Ser. No. 62/941,161 filed on Nov. 27, 2019, and U.S. Provisional Application Ser. No. 62/957,610 filed on Jan. 6, 2020, the content of each of which is relied upon and incorporated herein by reference in its entirety.

### BACKGROUND

### Field

The present specification relates to adhesive compositions suitable for use with screen protectors for electronic devices. More specifically, the present specification is directed to optically clear liquid adhesive compositions and kits for applying a screen protector to a cover glass of an electronic device.

### Technical Background

Electronic devices often comprise displays with a display cover integral to the device itself. Damage to the display cover can be costly to repair or replace. As such, there is a desire to protect electronic devices, especially the display cover of the device's display and the display, from damage.

It is known to protect electronic devices from damage by placing the electronic device in a protective housing. However, protective housings with desired mechanical properties are not transparent, which impairs use of the underlying electronic device. It is also known to protect electronic devices from damage by placing a sheet of transparent material (e.g., a screen protector) over the electronic device.

As the design of electronic devices evolves to include curved displays and ultrasonic sensors, such as fingerprint sensors, within or near the display, preexisting screen protectors do not provide adequate performance or protection. Especially when applied to devices with non-flat display covers, preexisting screen protectors may result in bubbles and/or delamination, which are aesthetically unpleasing and may decrease the performance of components of the device, including ultrasonic sensors. Liquid adhesives have been utilized for screen protector applications, but have required the use of specialized curing tools that are costly or not readily available to the end-user. A need exists for screen protector solutions utilizing liquid adhesives that are curable without specialized curing tools, may be applied by the end-user, and that are compatible with ultrasonic sensors to ensure the required optical performance.

### SUMMARY

According to a first aspect A1, a screen protector application kit comprises a glass-based substrate having an adhesive belt, the adhesive belt comprising: a first major surface being adhered to the glass-based substrate; a second major surface opposite the first major surface; a distal edge extending between the first major surface and the second major surface; and a proximal edge extending between the first major surface and the second major surface; and a container of an uncured adhesive composition, the uncured adhesive composition comprising: greater than or equal to 30 wt % and less than or equal to 99.9 wt % of at least one of: (i) a monomer; and (ii) an oligomer; and greater than or equal to 0.01 wt % and less than or equal to 10 wt % of a visible-light photoinitiator.

A second aspect A2 includes the screen protector application kit according to the first aspect A1, wherein the at least one of: (i) a monomer; and (ii) an oligomer comprises cyclic hydrocarbon acrylate, aliphatic acrylate, polysiloxane acrylate, polydimethylsiloxane acrylate, silicone polyetheracrylate, urethane acrylate, monofunctional acrylate, difunctional acrylate, trifunctional acrylate, tetrafunctional acrylate, polyfunctional acrylate, or a combination thereof.

A third aspect A3 includes the screen protector application kit according the first aspect A1 or the second aspect A2, wherein the visible-light photoinitiator comprises phosphine oxide-based compounds, cyanine compounds, indocyanine compounds, xanthene compounds, fluorone compounds, thioxanthone compounds, phenyl glyoxylate-based compounds, cyclic ketoester-based compounds, benzoin ether-based compounds, amine compounds, α-hydroxy ketone-based compounds, fluorinated diaryl titanocene compounds, or a combination thereof.

A fourth aspect A4 includes the screen protector application kit according to any one of the first through third aspects A1-A3, wherein the visible-light photoinitiator has an absorptivity greater than or equal to 200 L/mol/cm and less than or equal to 5000 L/mol/cm in the wavelength range of 380 nm to 750 nm.

A fifth aspect A5 includes the screen protector application kit according to any one of the first through fourth aspects A1-A4, wherein the visible-light photoinitiator has a thickness-normalized absorbance greater than or equal to 2 cm⁻¹ and less than or equal to 50 cm⁻¹ in the wavelength range of 380 nm to 750 nm.

A sixth aspect A6 includes the screen protector application kit according to any one of the first through fifth aspects A1-A5, wherein the visible-light photoinitiator has at least one absorption peak in the wavelength range greater than or equal to 350 nm and less than or equal to 750 nm as determined by Gaussian curve fitting with a coefficient of determination R²>0.95.

A seventh aspect A7 includes the screen protector application kit according to any one of the first through sixth aspects A1-A6, wherein the uncured adhesive composition further comprises greater than or equal to 0.1 wt % and less than or equal to 10 wt % of a co-initiator.

An eighth aspect A8 includes the screen protector application kit according to the seventh aspect A7, wherein the co-initiator comprises a silane, carbazole, iodonium salt, sulfonium salt, borate salt, amine, amine acrylate, acrylamide, or a combination thereof.

A ninth aspect A9 includes the screen protector application kit according to any one of the first through eighth aspects A1-A8, wherein the uncured adhesive composition further comprises greater than or equal to 0.1 wt % and less than or equal to 5 wt % of an oxygen inhibitor.

A tenth aspect A10 includes the screen protector application kit according to the ninth aspect A9, wherein the oxygen inhibitor comprises a phosphine, phosphite, amine, thiol, silane, hydrogen phosphite, stannane, aldehyde, vinyl amide, vinyl lactam, vinylcarbazole, diphenyl furan, dibutyl anthracene, or a combination thereof.

An eleventh aspect A11 includes the screen protector application kit according to any one of the first through tenth aspects A1-A10, wherein the uncured adhesive composition has a viscosity less than or equal to 500 cps as measured at 20° C.

A twelfth aspect A12 includes the screen protector application kit according to any one of the first through eleventh aspects A1-A11, wherein the uncured adhesive composition is cured by irradiation with a visible light source to form a cured adhesive composition.

A thirteenth aspect A13 includes the screen protector application kit according to the twelfth aspect A12, wherein the cured adhesive composition has a loss tangent tan(δ) less than 1.0, wherein tan(δ) is measured at room temperature 20° C. and at frequency greater than or equal to 1 MHz and less than or equal to 100 MHz.

A fourteenth aspect A14 includes the screen protector application kit according to the twelfth aspect A12 or the thirteenth aspect A13, wherein the cured adhesive composition has an acoustic attenuation coefficient α less than or equal to 100000 db/m, wherein a is measured at room temperature (20° C.) and at a frequency greater than or equal to 1 MHz and less than or equal to 100 MHz.

A fifteenth aspect A15 includes the screen protector application kit according to any one of the twelfth through fourteenth aspects A12-A14, wherein the cured adhesive composition has a tensile storage modulus E′ greater than or equal to 10 MPa, wherein E′ is measured at room temperature (20° C.) and at a frequency greater than or equal to 1 MHz and less than or equal to 100 MHz.

A sixteenth aspect A16 includes the screen protector application kit according to any one of the twelfth through fifteenth aspects A12-A15, wherein the cured adhesive composition has a tensile loss modulus E″ less than or equal to 109 MPa, wherein E″ is measured at room temperature (20° C.) and at a frequency greater than or equal to 1 MHz and less than or equal to 100 MHz.

A seventeenth aspect A17 includes the screen protector application kit according to any one of the twelfth through sixteenth aspects A12-A16, wherein the cured adhesive composition is a cured liquid optically clear adhesive such that the cured adhesive composition has a visible light transmission greater than 70%, a transmission haze less than 20%, and a clarity greater than 80% as measured by a technique set forth in ASTM D1003 with a standard CIE-C illuminant with a wavelength range of 380 nm to 720 nm at a thickness of 0.2 mm.

An eighteenth aspect A18 includes the screen protector application kit according to any one of the twelfth through seventeenth aspects A12-A17, wherein the visible-light photoinitiator has an absorptivity greater than or equal to 200 L/mol/cm and less than or equal to 5000 L/mol/cm in the wavelength range of 380 nm to 750 nm.

A nineteenth aspect A19 includes the screen protector application kit according to any one of the twelfth through eighteenth aspects A12-A18, wherein the visible-light photoinitiator has a thickness-normalized absorbance greater than or equal to 2 cm⁻¹ and less than or equal to 50 cm⁻¹ in the wavelength range of 380 nm to 750 nm.

A twentieth aspect A20 includes the screen protector application kit according to any one of the first through nineteenth aspects A1-A19, wherein the adhesive belt has a thickness greater than or equal to 5 μm and less than or equal to 500 μm.

A twenty-first aspect A21 includes the screen protector application kit according to any one of the first through twentieth aspects A1-A20, wherein the adhesive belt has a width between the distal edge and the proximal edge greater than or equal to 0.1 mm and less than or equal to 30 mm.

A twenty-second aspect A22 includes the screen protector application kit according to any one of the first through twenty-first aspects A1-A21, wherein the adhesive belt further comprises a channel extending from the distal edge to the proximal edge.

A twenty-third aspect A23 includes the screen protector application kit according to any one of the first through twenty-second aspects A1-A22, wherein the adhesive belt further comprises a plurality of channels extending from the distal edge to the proximal edge.

A twenty-fourth aspect A24 includes the screen protector application kit according to any one of the first through twenty-third aspects A1-A23, wherein the adhesive belt comprises silicone, acrylic, polyurethane, epoxy, cyanoacrylate, polyethylene terephthalate, or a combination thereof.

A twenty-fifth aspect A25 includes the screen protector application kit according to any one of the first through twenty-fourth aspects A1-A24, wherein the second major surface of the adhesive belt has a peel force on glass greater than or equal to 500 gf/inch and less than or equal to 5000 gf/inch as measured by a technique set forth in ASTM D3330.

A twenty-sixth aspect A26 includes the screen protector application kit according to any one of the first through twenty-fifth aspects A1-A25, wherein the glass-based substrate comprises a strengthened glass-based substrate selected from a group consisting of a chemically strengthened glass-based substrate, a thermally strengthened glass-based substrate, and a chemically and thermally strengthened glass-based substrate.

A twenty-seventh aspect A27 includes the screen protector application kit according to any one of the first through twenty-sixth aspects A1-A26, wherein the glass-based substrate comprises a surface compressive stress greater than or equal to 150 MPa as measured by an FSM-6000 at a wavelength of 596 nm.

A twenty-eighth aspect A28 includes the screen protector application kit according to any one of the first through twenty-seventh aspects A1-A27, wherein the glass-based substrate comprises a depth of compression greater than or equal to 3 μm as measured by an FSM-6000 at a wavelength of 596 nm.

A twenty-ninth aspect A29 includes the screen protector application kit according to any one of the first through twenty-eighth aspects A1-A28, wherein the glass-based substrate has a central tension greater than or equal to 1 MPa and less than or equal to 120 MPa as measured by an FSM-6000 at a wavelength of 596 nm.

A thirtieth aspect A30 includes the screen protector application kit according to any one of the first through twenty-ninth aspects A1-A29, wherein the glass-based substrate has a thickness greater than or equal to 0.05 mm and less than or equal to 1 mm.

A thirty-first aspect A31 includes the screen protector application kit according to any one of the first through twenty-ninth aspects A1-A29, wherein the glass-based substrate has a thickness of mλ_{g}/2±mλ_{g}/10, where m is an integer greater than or equal to 1 and λ_{g}/2 is the half wavelength of an acoustic wave emitted through the glass-based substrate.

A thirty-second aspect A32 includes the screen protector application kit according to any one of the first through twenty-ninth aspects A1-A29, wherein the glass-based substrate has a thickness of mV_{S}/2f±mV_{S}/10f where m is an integer greater than or equal to 1, V_{S} is a velocity of propagation of an acoustic wave emitted through the glass-based substrate at f, and f is a frequency greater than or equal to 1 MHz and less than or equal to 100 MHz

A thirty-third aspect A33 includes the screen protector application kit according to any one of the first through thirty-second aspects A1-A32, wherein the glass-based substrate has a 3-dimensional shape.

According to a thirty-fourth aspect A34, a screen protector application kit comprises: a glass-based substrate; a container of an uncured adhesive composition, the uncured adhesive composition comprising: greater than or equal to 30 wt % and less than or equal to 99.9 wt % of at least one of: (i) a monomer; and (ii) an oligomer; and greater than or equal to 0.01 wt % and less than or equal to 10 wt % of a visible-light photoinitiator; and an application fixture, the application fixture comprising a rectangular frame having a pair of length sides and a pair of width sides.

A thirty-fifth aspect A35 includes the screen protector application kit according to the thirty-fourth aspect A34, wherein the application fixture further comprises: a plurality of tabs extending from one of the pair of width sides in a direction perpendicular to the pair of width sides; a plurality of protrusions extending from each of the pair of length sides in a direction perpendicular to the pair of length sides; and at least one level positioned in one of at least one of the pair of length sides and the pair of width sides.

A thirty-sixth aspect A36 includes the screen protector application kit according to the thirty-fourth aspect A34, wherein the application fixture further comprises: a plurality of tabs extending from one of the pair of width sides in a direction perpendicular to the pair of width sides; at least one groove in the other of the pair of width sides; and a wedge slider insertable into the at least one groove.

A thirty-seventh aspect A37 includes the screen protector application kit according to the thirty-sixth aspect A36, wherein the at least one groove comprises two grooves and the wedge slider comprises a double wedge slider insertable into the two grooves.

A thirty-eighth aspect A38 includes the screen protector application kit according to the thirty-sixth aspect A36 or thirty-seventh aspect A37, wherein the application fixture further includes at least one level positioned in one of at least one of the pair of length sides and the pair of width sides.

A thirty-ninth aspect A39 includes the screen protector application kit according to any one of the thirty-sixth through thirty-eighth aspects A36-A38, wherein the application fixture further comprises an applicator arm extending between and being connectable to the pair of width sides, the applicator arm having an opening configured to hold the container of the uncured adhesive composition therein.

A fortieth aspect A40 includes the screen protector application kit according to any one of the thirty-sixth through thirty-ninth aspects A36-A39, wherein the application fixture further comprises a leveling mat.

A forty-first aspect A41 includes the screen protector application kit according to any one of the thirty-fourth through fortieth aspects A34-A40, wherein the at least one of: (i) a monomer; and (ii) an oligomer comprises cyclic hydrocarbon acrylate, aliphatic acrylate, polysiloxane acrylate, polydimethylsiloxane acrylate, silicone polyetheracrylate, urethane acrylate, monofunctional acrylate, difunctional acrylate, trifunctional acrylate, tetrafunctional acrylate, polyfunctional acrylate, or a combination thereof.

A forty-second aspect A42 includes the screen protector application kit according to any one of the thirty-fourth through forty-first aspects A34-A41, wherein the visible-light photoinitiator comprises phosphine oxide-based compounds, cyanine compounds, indocyanine compounds, xanthene compounds, fluorone compounds, thioxanthone compounds, phenyl glyoxylate-based compounds, cyclic ketoester-based compounds, benzoin ether-based compounds, amine compounds, α-hydroxy ketone-based compounds, fluorinated diaryl titanocene compounds, or a combination thereof.

A forty-third aspect A43 includes the screen protector application kit according to any one of the thirty-fourth through forty-second aspects A34-A42, wherein the visible-light photoinitiator has an absorptivity greater than or equal to 200 L/mol/cm and less than or equal to 5000 L/mol/cm in the wavelength range of 380 nm to 750 nm.

A forty-fourth aspect A44 includes the screen protector application kit according to any one of the thirty-fourth through forty-third aspects A34-A43, wherein the visible-light photoinitiator has a thickness-normalized absorbance greater than or equal to 2 cm⁻¹ and less than or equal to 50 cm⁻¹ in the wavelength range of 380 nm to 750 nm.

A forty-fifth aspect A45 includes the screen protector application kit according to any one of the thirty-fourth through forty-fourth aspects A34-A44, wherein the visible-light photoinitiator has at least one absorption peak in the wavelength range greater than or equal to 350 nm and less than or equal to 750 nm as determined by Gaussian curve fitting with a coefficient of determination R²>0.95.

A forty-sixth aspect A46 includes the screen protector application kit according to any one of the thirty-fourth through forty-fifth aspects A34-A45, wherein the uncured adhesive composition further comprises greater than or equal to 0.1 wt % and less than or equal to 10 wt % of a co-initiator.

A forty-seventh aspect A47 includes the screen protector application kit according to the forty-sixth aspect A46, wherein the co-initiator comprises a silane, carbazole, iodonium salt, sulfonium salt, borate salt, amine, amine acrylate, acrylamide, or a combination thereof.

A forty-eighth aspect A48 includes the screen protector application kit according to any one of the thirty-fourth through forty-seventh aspects A34-A47, wherein the uncured adhesive composition further comprises greater than or equal to 0.1 wt % and less than or equal to 5 wt % of an oxygen inhibitor.

A forty-ninth aspect A49 includes the screen protector application kit according to the forty-eighth aspect A48, wherein the oxygen inhibitor comprises a phosphine, phosphite, amine, thiol, silane, hydrogen phosphite, stannane, aldehyde, vinyl amide, vinyl lactam, vinylcarbazole, diphenyl furan, dibutyl anthracene, or a combination thereof.

A fiftieth aspect A50 includes the screen protector application kit according to any one of the thirty-fourth through forty-ninth aspects A34-A49, wherein the uncured adhesive composition has a viscosity less than or equal to 500 cps as measured at 20° C.

A fifty-first aspect A51 includes the screen protector application kit according to the thirty-fourth through fiftieth aspects A34-A50, wherein the uncured adhesive composition is cured by irradiation with a visible light source to form a cured adhesive composition.

A fifty-second aspect A52 includes the screen protector application kit according to the fifty-first aspect 51, wherein the cured adhesive composition has a loss tangent tan(δ) less than 1.0, wherein tan(δ) is measured at room temperature (20° C.) and at a frequency greater than or equal to 1 MHz and less than or equal to 100 MHz.

A fifty-third aspect A53 includes the screen protector application kit according to the fifty-first aspect A51 or the fifty-second aspect A52, wherein the cured adhesive composition has an acoustic attenuation coefficient α less than or equal to 100000 db/m, wherein a is measured at room temperature (20° C.) and at a frequency greater than or equal to 1 MHz and less than or equal to 100 MHz.

A fifty-fourth aspect A54 includes the screen protector application kit according to any of the fifty-first through fifty-third aspects A51-A53, wherein the cured adhesive composition has a tensile storage modulus E′ greater than or equal to 10 MPa, wherein E′ is measured at room temperature (20° C.) and at a frequency greater than or equal to 1 MHz and less than or equal to 100 MHz.

A fifty-fifth aspect A55 includes the screen protector application kit according to any of the fifty-first through fifty-fourth aspects A51-A54, wherein the cured adhesive composition has a tensile loss modulus E″ less than or equal to 10⁹ MPa, wherein E″ is measured at room temperature (20° C.) and a frequency greater than or equal 1 MHz and less than or equal to 100 MHz.

A fifty-sixth aspect A56 includes the screen protector application kit according to any of the fifty-first through fifty-fifth aspects A51-A55, wherein the cured adhesive composition is a cured liquid optically clear adhesive such that the cured adhesive composition has a visible light transmission greater than 70%, a transmission haze less than 20%, and a clarity greater than 80% as measured by a technique set forth in ASTM D1003 with a standard CIE-C illuminant with a wavelength range of 380 nm to 720 nm at a thickness of 0.2 mm.

A fifty-seventh aspect A57 includes the screen protector application kit according to any of the fifty-first through fifty-sixth aspects A51-A56, wherein the visible-light photoinitiator has an absorptivity greater than or equal to 200 L/mol/cm and less than or equal to 5000 L/mol/cm in the wavelength range of 380 nm to 750 nm.

A fifty-eighth aspect A58 includes the screen protector application kit according to any of the fifty-first through fifty-seventh aspects A51-A57, wherein the visible-light photoinitiator has a thickness-normalized absorbance greater than or equal to 2 cm⁻¹ and less than or equal to 50 cm⁻¹ in the wavelength range of 380 nm to 750 nm.

A fifty-ninth aspect A59 includes the screen protector application kit according to any of the thirty-fourth through fifty-eighth aspects A34-A58, wherein the glass-based substrate includes an adhesive belt, the adhesive belt comprising: a first major surface being adhered to the glass-based substrate; a second major surface opposite the first major surface; a distal edge extending between the first major surface and the second major surface; and a proximal edge extending between the first major surface and the second major surface.

A sixtieth aspect A60 includes the screen protector application kit according to the fifty-ninth aspect A59, wherein the adhesive belt has a thickness greater than or equal to 5 μm and less than or equal to 500 μm.

A sixty-first aspect A61 includes the screen protector application kit according to the fifty-ninth aspect A59 or the sixtieth aspect A60, wherein the adhesive belt has a width between the distal edge and the proximal edge greater than or equal to 0.1 mm and less than or equal to 30 mm.

A sixty-second aspect A62 includes the screen protector application kit according to any one of the fifty-ninth through sixty-first aspects A59-A61, wherein the adhesive belt further comprises a channel extending from the distal edge to the proximal edge.

A sixty-third aspect A63 includes the screen protector application kit according to any one of the fifty-ninth through sixty-second aspects A59-A62, wherein the adhesive belt further comprises a plurality of channels extending from the distal edge to the proximal edge.

A sixty-fourth aspect A64 includes the screen protector application kit according to any one of the fifty-ninth through sixty-third aspects A59-A63, wherein the adhesive belt comprises silicone, acrylic, polyurethane, epoxy, cyanoacrylate, polyethylene terephthalate, or a combination thereof.

A sixty-fifth aspect A65 includes the screen protector application kit according to any one of the fifty-ninth through sixty-fourth aspects A59-A64, wherein the second major surface of the adhesive belt has a peel force on glass greater than or equal to 500 gf/inch and less than or equal to 5000 gf/inch as measured by a technique set forth in ASTM D3330.

A sixty-sixth aspect A66 includes the screen protector application kit according to any one of the thirty-fourth through sixty-fifth aspects A34-A65, wherein the glass-based substrate comprises a strengthened glass-based substrate selected from a group consisting of a chemically strengthened glass-based substrate, a thermally strengthened glass-based substrate, and a chemically and thermally strengthened glass-based substrate.

A sixty-seventh aspect A67 includes the screen protector application kit according to any one of the thirty-fourth through sixty-sixth aspects A34-A66, wherein the glass-based substrate comprises a surface compressive stress greater than or equal to 150 MPa as measured by an FSM-6000 at a wavelength of 596 nm.

A sixty-eighth aspect A68 includes the screen protector application kit according to any one of the thirty-fourth through sixty-seventh A34-A67, wherein the glass-based substrate comprises a depth of compression greater than or equal to 3 μm as measured by an FSM-6000 at a wavelength of 596 nm.

A sixty-ninth aspect A69 includes the screen protector application kit according to any one of the thirty-fourth through sixty-eighth aspects A34-A68, wherein the glass-based substrate has a central tension greater than or equal to 1 MPa and less than or equal to 120 MPa as measured by an FSM-6000 at a wavelength of 596 nm.

A seventieth aspect A70 includes the screen protector application kit according to any one of the thirty-fourth through sixty-ninth aspects A34-A69, wherein the glass-based substrate has a thickness greater than or equal to 0.05 mm and less than or equal to 1 mm.

A seventy-first aspect A71 includes the screen protector application kit according to any one of the thirty-fourth through sixty-ninth aspects A34-A69, wherein the glass-based substrate has a thickness of mλ_{g}/2±mλ_{g}/10, where m is an integer greater than or equal to 1 and λ_{g}/2 is the half wavelength of an acoustic wave emitted through the glass-based substrate.

A seventy-second aspect A72 includes the screen protector application kit according to any one of the thirty-fourth through sixty-ninth aspects A34-A69, wherein the glass-based substrate has a thickness of mV_{S}/2f±mV_{S}/10f where m is an integer greater than or equal to 1, V_{S} is a velocity of propagation of an acoustic wave emitted through glass-based substrate at f, and f is a frequency greater than or equal to 1 MHz and less than or equal to 100 MHz

A seventy-third aspect A73 includes the screen protector application kit according to any one of the thirty-fourth through seventy-second aspects A34-A72, wherein the glass-based substrate has a 3-dimensional shape.

According to a seventy-fourth aspect A74, an uncured adhesive composition comprises: greater than or equal to 30 wt % and less than or equal to 99.9 wt % of at least one of: (i) a monomer; and (ii) an oligomer, the at least one of: (i) a monomer; and (ii) an oligomer comprising isobornyl acrylate, lauryl acrylate, pentaerythritol (EO)ₙ tetraacrylate, siliconepolyether acrylate, polydimethylsiloxane acrylate, polysiloxane acrylate, acrylic resin, or a combination thereof; and greater than or equal to 0.01 wt % and less than or equal to 10 wt % of a visible-light photoinitiator, the visible-light photoinitator having an absorptivity greater than or equal to 200 L/mol/cm and less than or equal to 5000 L/mol/cm in the wavelength range of 380 nm to 750 nm and a thickness-normalized absorbance greater than or equal to 2 cm⁻¹ and less than or equal to 50 cm⁻¹ in the wavelength range of 380 nm to 750 nm.

A seventy-fifth aspect A75 includes the uncured adhesive composition according to the seventy-fourth aspect A74, wherein the uncured adhesive composition comprises: greater than or equal to 70 wt % and less than or equal to 99.9 wt % of the at least one of: (i) a monomer; and (ii) an oligomer; and greater than or equal to 0.05 wt % and less than or equal to 5 wt % of the visible-light photoinitiator.

A seventy-sixth aspect A76 includes the uncured adhesive composition according to the seventy-fifth aspect A75, wherein the uncured adhesive composition comprises: greater than or equal to 95 wt % and less than or equal to 99.9 wt % of the at least one of: (i) a monomer; and (ii) an oligomer; and greater than or equal to 0.1 wt % and less than or equal to 2 wt % of the visible-light photoinitiator.

A seventy-seventh aspect A77 includes the uncured adhesive composition according to any one the seventy-fourth through seventy-sixth aspects A74-A76, wherein the visible-light photoinitiator comprises phenylbis(2,4,6-trimethyl benzoyl)phosphine oxide, bis(eta-5-2,4-cyclopentadien-1-yl)bis[2,6-difluoro-3-(1H-pyrrol-1-yl)phenyl]titanium, 1-butyl-2-[5-(1-butyl-1,3-dihydro-3,3-dimethyl-2H-indol-2-ylidene)-1,3-pentadien-1-yl]-3,3-dimethyl-3H-indolium salt, or a combination thereof.

A seventy-eighth aspect A78 includes the uncured adhesive composition according to any one the seventy-fourth through seventy-seventh aspects A74-A77, the uncured adhesive composition further comprises greater than or equal to 0.1 wt % and less than or equal to 10 wt % of a co-initiator, the co-initiator comprising a silane, carbazole, iodonium salt, sulfonium salt, borate salt, amine, amine acrylate, acrylamide, or a combination thereof.

A seventy-ninth aspect A79 includes the uncured adhesive composition according to the seventy-eighth aspect A78, wherein the uncured adhesive composition comprises greater than or equal to 0.1 wt % and less than or equal to 5 wt % of the co-initiator.

An eightieth aspect A80 includes the uncured adhesive composition according to the seventy-eighth aspect A78 or the seventy-ninth aspect A79, wherein the co-initiator comprises iodonium salt, sulfonium salt, borate salt, amine, amine acrylate, acrylamide, or a combination thereof, and at least one of hexafluorophosphate, hexafluoroarsenate, hexafluoroantimonate, tetrafluoroborate, bifluoride, perchlorate, chloride, bromide, iodide, nitrate, silicate, and sulfonate.

An eighty-first aspect A81 includes the uncured adhesive composition according to the seventy-eighth aspect A78 or the seventy-ninth aspect A79, wherein the co-initiator comprises diphenylsilane, tris(trimethylsilyl)silane, diphenyliodonium hexafluorophosphate, bis(4-t-butylphenyl)iodonium hexafluorophosphate, or a combination thereof.

An eighty-second aspect A82 includes the uncured adhesive composition according to any one of the seventy-fourth through eighty-first aspects A74-A81, wherein the uncured adhesive composition further comprises greater than or equal to 0.1 wt % and less than or equal to 5 wt % of an oxygen inhibitor, the oxygen inhibitor comprising a phosphine, phosphite, amine, thiol, silane, hydrogen phosphite, stannane, aldehyde, vinyl amide, vinyl lactam, vinylcarbazole, diphenyl furan, dibutyl anthracene, or a combination thereof.

An eighty-third aspect A83 includes the uncured adhesive composition according to the eighty-second aspect A82, wherein the uncured adhesive composition comprises greater than or equal to 0.1 wt % and less than or equal to 2 wt % of the oxygen inhibitor.

An eighty-fourth aspect A84 includes the uncured adhesive composition according to the eighty-second aspect A82 or the eighty-third aspect A83, wherein the oxygen inhibitor comprises 4-(dimethylamino)phenyl diphenylphosphene, triphenylphosphine, triphenyl phosphite, or a combination thereof.

An eighty-fifth aspect A85 includes the uncured adhesive composition according to any one of the seventy-fourth through eighty-fourth aspects A74-A84, wherein the uncured adhesive composition further comprises greater than or equal to 0.01 wt % and less than or equal to 1 wt % of a surfactant, the surfactant comprising polysiloxane acrylate, polydimethylsiloxane acrylate, silicone polyether acrylate, perfluoropolyether, perfluorocarbon, or a combination thereof.

An eighty-sixth aspect A86 includes the uncured adhesive composition according to any one of the seventy-fourth through eighty-fifth aspects A74-A85, wherein the uncured adhesive composition has a viscosity less than or equal to 500 cps as measured at 20° C.

An eighty-seventh aspect A87 includes the uncured adhesive composition according to the eighty-sixth aspect A86, wherein the uncured adhesive composition has a viscosity less than or equal to 250 cps as measured at 20° C.

An eighty-eighth aspect A88 includes the uncured adhesive composition according to any one of the seventy-fourth through eighty-seventh aspects A74-A87, wherein the uncured adhesive composition is cured by irradiation with a visible light source to form a cured adhesive composition.

An eighty-ninth aspect A89 includes the uncured adhesive composition according to the eighty-eighth aspect A88, wherein the cured adhesive composition has a loss tangent tan(δ) less than 1.0, wherein tan(δ) is measured at room temperature (20° C.) and at a frequency greater than or equal to 1 MHz and less than or equal to 100 MHz.

An ninetieth aspect A90 includes the uncured adhesive composition according to the eighty-eighth aspect A88 or the eighty-ninth aspect A89, wherein the cured adhesive composition has an acoustic attenuation coefficient α less than or equal to 100000 db/m, wherein a is measured at room temperature (20° C.) and at a frequency greater than or equal to 1 MHz and less than or equal to 100 MHz.

An ninety-first aspect A91 includes the uncured adhesive composition according to any one of the eighty-eighth through ninetieth aspects A88-A90, wherein the cured adhesive composition has a tensile storage modulus E′ greater than or equal to 10 MPa, wherein E′ is measured at room temperature (20° C.) and at a frequency greater than or equal to 1 MHz and less than or equal to 100 MHz.

A ninety-second aspect A92 includes the uncured adhesive composition according to any one of the eighty-eighth through ninety-first aspects A88-A91, wherein the cured adhesive composition has a tensile loss modulus E″ less than or equal to 109 MPa, wherein E″ is measured at room temperature (20° C.) and at a frequency greater than or equal to 1 MHz and less than or equal to 100 MHz.

A ninety-third aspect A93 includes the uncured adhesive composition according to any one of the eighty-eighth through ninety-second aspects A88-A92, wherein the cured adhesive composition is a cured liquid optically clear adhesive such that the cured adhesive composition has a visible light transmission greater than 70%, a transmission haze less than 20%, and a clarity greater than 80% as measured by a technique set forth in ASTM D1003 with a standard CIE-C illuminant with a wavelength range of 380 nm to 720 nm at a thickness of 0.2 mm.

A ninety-fourth aspect A94 includes the uncured adhesive composition according to any one of the eighty-eighth through ninety-third aspects A88-A93, wherein the visible-light photoinitiator has an absorptivity greater than or equal to 200 L/mol/cm and less than or equal to 5000 L/mol/cm in the wavelength range of 380 nm to 750 nm.

A ninety-fifth aspect A95 includes the uncured adhesive composition according to any one of the eighty-eighth through ninety-fourth aspects A88-A94, wherein the visible-light photoinitiator has a thickness-normalized absorbance greater than or equal to 2 cm⁻¹ and less than or equal to 50 cm⁻¹ in the wavelength range of 380 to 750 nm.

According to a ninety-sixth aspect A96, an application fixture comprises a rectangular frame having a pair of length sides and a pair of width sides; a plurality of tabs extending from one of the pair of width sides in a direction perpendicular to the pair of width sides; a plurality of protrusions extending from each of the pair of length sides in a direction perpendicular to the pair of length sides; and at least one level positioned in one of at least one of the pair of length sides and the pair of width sides.

According to a ninety-seventh aspect A97, an application fixture comprises a rectangular frame having a pair of length sides and a pair of width sides; a plurality of tabs extending from one of the pair of width sides in a direction perpendicular to the pair of width sides; at least one groove in the other of the pair of width sides; and a wedge slider insertable into the at least one groove.

A ninety-eighth aspect A98 includes the application fixture according to the ninety-seventh aspect A97, wherein the at least one groove comprises two grooves and the wedge slider comprises a double wedge slider insertable into the two grooves.

A ninety-ninth aspect A99 includes the application fixture according to the ninety-seventh aspect A97 or the ninety-eighth aspect A98, wherein the application fixture further includes at least one level positioned in one of at least one of the pair of length sides and the pair of width sides.

A one-hundredth aspect A100 includes the application fixture according to any one of the ninety-seventh through ninety-ninth aspects A97-A99, wherein the application fixture further comprises an applicator arm extending between and being connectable to the pair of width sides, the applicator arm having an opening configured to hold an adhesive container therein.

A one-hundred-and-first aspect A101 includes the application fixture according to any one of the ninety-seventh through one-hundredth aspects A97-A100, wherein the application fixture further comprises a levelling mat.

According to a one-hundred-and-second aspect A102, an article comprises: an electronic device, comprising: a display; a glass-based cover disposed over the display; and an ultrasonic sensor; a glass-based screen protector, comprising: a glass-based substrate; and an adhesive; wherein: the adhesive adheres the glass-based substrate to the glass-based cover; the adhesive has a thickness of less than or equal to 500 μm; and the glass-based substrate has a thickness of mλ_{g}/2±mλ_{g}/10, where m is an integer greater than or equal to 1, and λ_{g} is the wavelength of a wave in the glass-based substrate at an operating frequency of the ultrasonic sensor.

A one-hundred-and-third aspect A103 includes the article according to the one-hundred-and-second aspect A102, wherein the thickness of the glass-based substrate is greater than or equal to 100 μm to less than or equal to 500 μm.

A one-hundred-and-fourth aspect A104 includes the article according to the one-hundred-and-second A102 or one-hundred-and-third aspect A103, wherein the thickness of the glass-based substrate is mV_{G}/2f±mV_{G}/10f, where f is the operating frequency of the ultrasonic sensor, and V_{G} is the velocity of propagation of sound in the glass-based substrate at the operating frequency f.

A one-hundred-and-fifth aspect A105 includes the article according to any one of the one-hundred-and-second through one-hundred-and-fourth aspects A102-104, wherein the glass-based substrate comprises a compressive stress region extending from a surface to a depth of compression.

A one-hundred-and-sixth aspect A106 includes the article according to the one-hundred-and-fifth aspect A105, wherein the depth of compression is greater than or equal to 3 μm.

A one-hundred-and-seventh aspect A107 includes the article according to the one-hundred-and-fifth aspect A105 or the one-hundred-and-sixth aspect A106, wherein the compressive stress region comprises a surface compressive stress of greater than or equal to 50 MPa.

A one-hundred-and-eighth aspect A108 includes the article according includes the article according to any one of the one-hundred-and-second through one-hundred-and-seventh aspects A102-A107, wherein the glass-based substrate has a Young's modulus of greater than or equal to 50 GPa to less than or equal to 120 GPa.

A one-hundred-and-ninth aspect A109 includes the article according to any one of the one-hundred-and-second through one-hundred-and-eighth aspects A102-A108, wherein the glass-based substrate has a Poisson's ratio of greater than or equal to 0.15 to less than or equal to 0.30.

A one-hundred-and-tenth aspect A110 includes the article according to any one of the one-hundred-and-second through one-hundred-and-ninth aspects A102-A109, wherein the adhesive is a cured liquid optically clear adhesive.

A one-hundred-and-eleventh aspect A111 includes the article according to any one of the one-hundred-and-second through one-hundred-and-tenth aspects A102-A110, wherein the adhesive comprises a silicone, acrylic, polyurethane, epoxy, cyanoacrylate, polyethylene terephthalate, polyvinyl alcohol, polystyrene, poly(methyl methacrylate), polydimethylsiloxane, or combinations thereof.

A one-hundred-and-twelfth aspect A112 includes the article according to any one of the one-hundred-and-second through one-hundred-and-eleventh aspects A102-A111, wherein the adhesive comprises a plurality of layers.

A one-hundred-and-thirteenth aspect A113 includes the article according to any one of the one-hundred-and-second through one-hundred-and-twelfth aspects A102-A112, wherein the adhesive has a thickness of less than or equal to 300 μm.

A one-hundred-and-fourteenth aspect A114 includes the article according to any one of the one-hundred-and-second through one-hundred-and-thirteenth aspects A102-A113, wherein the adhesive has a loss tangent tan(δ) of less than 1.0, wherein tan(δ) is measured at room temperature and the operating frequency of the ultrasonic sensor.

A one-hundred-and-fifteenth aspect A115 includes the article according to any one of the one-hundred-and-second through one-hundred-and-fourteenth aspects A102-A114, wherein the adhesive has an acoustic attenuation coefficient α of less than or equal to 100000 db/m, wherein a is measured at room temperature and the operating frequency of the ultrasonic sensor.

A one-hundred-and-sixteenth aspect A116 includes the article according to any one of the one-hundred-and-second through one-hundred-and-fifteenth aspects A102-A115, wherein the adhesive has a tensile storage modulus E′ of greater than or equal to 10 MPa, wherein E′ is measured at room temperature and the operating frequency of the ultrasonic sensor.

A one-hundred-and-seventeenth aspect A117 includes the article according to any one of the one-hundred-and-second through one-hundred-and-sixteenth aspects A102-A116, wherein the adhesive has a tensile loss modulus E″ of less than or equal to 109 MPa, wherein E″ is measured at room temperature and the operating frequency of the ultrasonic sensor.

A one-hundred-and-eighteenth aspect A118 includes the article according to any one of the one-hundred-and-second through one-hundred-and-seventeenth aspects A102-A117, wherein the glass-based cover comprises a compressive stress region extending from a surface to a depth of compression.

A one-hundred-and-nineteenth aspect A119 includes the article according to the one-hundred-eighteenth aspect A118, wherein the depth of compression is greater than or equal to 3 μm.

A one-hundred-and-twentieth aspect A120 includes the article according to the one-hundred-eighteenth A118 or the one-hundred-nineteenth aspect A119, wherein the compressive stress region comprises a compressive stress on glass surface of greater than or equal to 50 Pa.

A one-hundred-and-twenty-first aspect A121 includes the article according to any one of the one-hundred-and-eighteenth through one-hundred-twentieth aspects A118-A120, wherein the glass-based cover further comprises a center tension region, and the center tension region comprises a maximum center tension of greater than or equal to 5 MPa to less than or equal to 100 MPa.

A one-hundred-and-twenty-second aspect A122 includes the article according to any one of the one-hundred-and-second through one-hundred-and-twenty-first aspects A102-A121, wherein the glass-based cover has a thickness of greater than or equal to 0.2 mm to less than or equal to 1.5 mm.

A one-hundred-and-twenty-third aspect A123 includes the article according to any one of the one-hundred-and-second through one-hundred-and-twenty-second aspects A102-A122, wherein the glass-based cover has a thickness of mλ_{C}/2±mλ_{C}/10, where m is an integer greater than or equal to 1, and c is the wavelength of a wave in the glass-based cover at an operating frequency of the ultrasonic sensor.

A one-hundred-and-twenty-fourth aspect A124 includes the article according to any one of the one-hundred-and-second through one-hundred-and-twenty-third aspects A102-A123, wherein the ultrasonic sensor has an operating frequency f of greater than or equal to 1 MHz to less than or equal to 100 MHz.

A one-hundred-and-twenty-fifth aspect A125 includes the article according to any one of the one-hundred-and-second through one-hundred-and-twenty-fourth aspects A102-A124, wherein a total distance from the ultrasonic sensor to an outer surface of the glass-based substrate is less than or equal to 2.5 mm.

A one-hundred-and-twenty-sixth aspect A126 includes the article according to any one of the one-hundred-and-second through one-hundred-and-twenty-fifth aspects A102-A125, wherein the display is a liquid crystal display or an organic light emitting diode display.

According to a one-hundred-and-twenty-seventh aspect A127, a method comprises: adhering a glass-based substrate to a glass-based cover of an electronic device using an adhesive; wherein the electronic device further comprises a display and an ultrasonic sensor, the glass-based cover is disposed over the display, the glass-based substrate has a thickness of mλ_{S}/2±mλ_{S}/10, where m is an integer greater than or equal to 1, and λ_{S} is the wavelength of a wave in the glass-based substrate at an operating frequency of the ultrasonic sensor.

A one-hundred-and-twenty-eighth aspect A128 includes a method according to the one-hundred-and-twenty-seventh aspect A127 wherein the adhering comprises: disposing a liquid optically clear adhesive over the glass-based cover; disposing the glass-based substrate on the liquid optically clear adhesive; and curing the liquid optically clear adhesive.

A one-hundred-and-twenty-ninth aspect A129 includes a method according to the one-hundred-and-twenty-eighth aspect A128, wherein the curing comprises irradiating the liquid optically clear adhesive with ultraviolet light.

A one-hundred-and-thirtieth aspect A130 includes a method according to the one-hundred-and-twenty-eighth aspect A128, wherein the curing comprises irradiating the liquid optically clear adhesive with visible light.

A one-hundred-and-thirty-first aspect A131 includes a method according to the one-hundred-and-twenty-eighth aspect A128, wherein the curing comprises heating the liquid optically clear adhesive.

According to a one-hundred-and-thirty-second aspect A132 a method comprises: applying a composition over a surface of a glass-based cover of an electronic device; disposing a glass-based substrate on the composition; and irradiating the composition with a visible light source to cure the composition and adhere the glass-based substrate to the glass-based cover; wherein the electronic device comprises a display, and the glass-based cover is disposed over the display, and the composition has a viscosity of less than or equal to 500 cps.

A one-hundred-and-thirty-third aspect A133 includes a method according to the one-hundred-and-thirty-second aspect A132, wherein the visible light source comprises at least one of a fluorescent lamp, a light emitting diode, a laser, tungsten lamp, a halogen lamp, a mercury lamp, incandescent lamp, and sunlight.

A one-hundred-and-thirty-fourth aspect A134 includes a method according to the one of the one-hundred-and-thirty-second A132 or the one-hundred-and-thirty-third aspect A133, wherein the irradiating occurs for a period of greater than or equal to 1 minute to less than or equal to 2 hours.

A one-hundred-and-thirty-fifth aspect A135 includes a method according to any one of the one-hundred-and-thirty-second through one-hundred-and-thirty-fourth aspects A132-A134, wherein immediately after the curing of the composition has a visible light transmission of greater than 70%.

A one-hundred-and-thirty-sixty aspect A136 includes a method according to any one of the one-hundred-and-thirty-second through one-hundred-and-thirty-fifth aspects A132-A135, wherein after irradiating with a visible light source of greater than 500 lux for a period of 24 hours the composition has a visible light transmission of greater than 70%.

A one-hundred-and-thirty-seventh aspect A137 includes a method according to any one of the one-hundred-and-thirty-second through one-hundred-and-thirty-sixth aspects A132-136, wherein after the curing of the composition, the composition has a haze of less than 20%.

A one-hundred-and-thirty-eighth aspect A138 includes a method according to any one of the one-hundred-and-thirty-second through one-hundred-and-thirty-seventh aspects A132-A137, wherein after the curing of the composition, the composition has a clarity of greater than 80%.

A one-hundred-and-thirty-ninth aspect A139 includes a method according to any one of the one-hundred-and-thirty-second through one-hundred-and-thirty-eighth aspects A132-A138, wherein the method does not include irradiating the composition with an ultraviolet light source.

According to a one-hundred-and-fortieth aspect A140, a composition comprises: 30 wt % to 99.9 wt % of an acrylate, wherein the acrylate is in the form of monomers and/or oligomers; and 0.01 wt % to 10 wt % of a photoinitiator, wherein the composition has a viscosity of less than or equal to 500 cps, and the composition is curable by irradiation with a visible light source.

A one-hundred-and-forty-first aspect A141 includes a composition according to the one-hundred-and-fortieth aspect A140, wherein the photoinitiator has an absorptivity of greater than or equal to 200 L/mol/cm to less than or equal to 5000 L/mol/cm in the wavelength range of greater than or equal to 380 nm to less than or equal to 750 nm.

A one-hundred-and-forty-second aspect A142 includes a composition according to the one-hundred-and-fortieth aspect A140 or the one-hundred-and-forty-first aspect A141, wherein the photoinitiator has a thickness normalized absorbance of greater than or equal to 2 cm⁻¹ to less than or equal to 50 cm⁻¹ in the wavelength of greater than or equal to 380 nm to less than or equal to 750 nm.

A one-hundred-and-forty-third aspect A143 includes a composition according to any one of the one-hundred-and-fortieth through one-hundred-and-forty-second aspects A140-A142, wherein the composition has a viscosity of less than or equal to 250 cps.

A one-hundred-and-forty-fourth aspect A144 includes a composition according to any one of the one-hundred-and-fortieth through one-hundred-and-forty-third aspects A140-A143, wherein the photoinitiator has at least one absorption peak in the wavelength range of greater than or equal to 380 nm to less than or equal to 750 nm.

A one-hundred-and-forty-fifth aspect A145 includes a composition according to any one of the one-hundred-and-fortieth through one-hundred-and-forty-fourth aspects A140-A144, wherein the photoinitiator has at least one absorption peak in the wavelength range of greater than or equal to 400 nm to less than or equal to 460 nm.

A one-hundred-and-forty-sixth aspect A146 includes a composition according to any one of the one-hundred-and-fortieth through one-hundred-and-forty-fifth aspects A140-A145, wherein the photoinitiator comprises at least one of: phosphine oxide compounds, cyanine compounds, indocyanine compounds, xanthene compounds, thioxanthone compounds, phenyl glyoxylate compounds, cyclic ketoester compounds, benzoin ether compounds, amine compounds, α-hydroxy ketone compounds, and fluorinated diaryl titanocene compounds.

According to a one-hundred-and-forty-seventh aspect A147, an article comprises: an electronic device, comprising: a display; and a glass-based cover disposed over the display; a glass-based screen protector, comprising: a glass-based substrate; and a cured liquid optically clear adhesive; wherein: the cured liquid optically clear adhesive adheres the glass-based substrate to the glass-based cover.

A one-hundred-and-forty-eighth aspect A148 includes an article according to the one-hundred-and-forty-seventh aspect A147, wherein the electronic device further comprises an ultrasonic sensor.

A one-hundred-and-forty-ninth aspect A149 includes an article according the one-hundred-and-forty-seventh A147 or one-hundred-and-forty-eighth aspects A148, wherein the cured liquid optically clear adhesive has a visible light transmission of greater than 70%.

A one-hundred-and-fiftieth aspect A150 includes an article according to any one of the one-hundred-and-forty-seventh through one-hundred-and-forty-ninth aspects A147-A149, wherein the cured liquid optically clear adhesive has a haze of less than 20%.

A one-hundred-and-fifty-first aspect A151 includes an article according to any one of the one-hundred-and-forty-seventh through one-hundred-and-fiftieth aspects A147-A150, wherein the cured liquid optically clear adhesive has a clarity of greater than 80%.

A one-hundred-and-fifty-second aspect A152 includes an article according to any one of the one-hundred-and-forty-seventh through one-hundred-and-fifty-first aspects A147-A151, wherein the cured liquid optically clear adhesive comprises a photoinitiator.

A one-hundred-and-fifty-third aspect A153 includes an article according to the one-hundred-and-fifty-second aspect A152, wherein the photoinitiator has an absorptivity of greater than or equal to 200 L/mol/cm to less than or equal to 5000 L/mol/cm in the wavelength range of greater than or equal to 380 nm to less than or equal to 750 nm.

A one-hundred-and-fifty-fourth aspect A154 includes an article according to the one-hundred-and-fifty-second aspect A152 or the one-hundred-and-fifty-third aspect A153, wherein the photoinitiator has a thickness normalized absorbance of greater than or equal to 1 cm⁻¹ to less than or equal to 50 cm⁻¹ in the wavelength of greater than or equal to 380 nm to less than or equal to 750 nm.

A one-hundred-and-fifty-fifth aspect A155 includes an article according to any one of the one-hundred-and-fifty-second through one-hundred-and-fifty-fourth aspects A152-A154, wherein the photoinitiator comprises at least one of: phosphine oxide compounds, cyanine compounds, indocyanine compounds, xanthene compounds, thioxanthone compounds, phenyl glyoxylate compounds, cyclic ketoester compounds, benzoin ether compounds, amine compounds, α-hydroxy ketone compounds, and fluorinated diaryl titanocene compounds.

A one-hundred-and-fifty-sixth aspect A156 includes an article according to any one of the one-hundred-and-fifty-second through one-hundred-and-fifty-fifth aspects A152-A155, wherein the cured liquid optically clear adhesive comprises an acrylate.

According to a one-hundred-fifty-seventh aspect A157, an apparatus comprises: an electronic device comprising a mounting surface; a glass-based substrate, comprising: a first major surface; a second major surface; and an edge extending between the first major surface and the second major surface; a first adhesive, comprising: a first major surface adhered to the second major surface of the glass-based substrate; a second major surface adhered to the mounting surface; a distal edge extending between the first major surface and the second major surface proximate to the edge of the glass-based substrate; and a proximal edge extending between the first major surface and the second major surface proximate to a center of the mounting surface; and a second adhesive, comprising: a cured liquid optically clear adhesive; a first major surface adhered to the second major surface of the glass-based substrate; a second major surface adhered to the mounting surface; and an edge extending between the first major surface and the second major surface; wherein the edge of the second adhesive is in contact with the proximal edge of the first adhesive.

A one-hundred-and-fifty-eighth aspect A158 includes an apparatus according to the one-hundred-fifty-seventh aspect A157, wherein the second major surface of the glass-based substrate comprises a decorative layer.

A one-hundred-and-fifty-ninth aspect A159 includes an apparatus according to the one-hundred-and-fifty-seventh A157 or one-hundred-and-fifty-eighth aspect A158, wherein the glass-based substrate comprises a strengthened glass-based substrate selected from a group consisting of a chemically strengthened glass-based substrate, a thermally strengthened glass-based substrate, and a chemically and thermally strengthened glass-based substrate.

A one-hundred-and-sixtieth aspect A160 includes an apparatus according to any one of the one-hundred-and-fifty-seventh through one-hundred-and-fifty-ninth aspects A157-A159, wherein the glass-based substrate comprises a compressive stress of greater than or equal to 50 MPa.

A one-hundred-and-sixty-first aspect A161 includes an apparatus according to any one of the one-hundred-and-fifty-seventh through one-hundred-and-sixtieth aspects A157-A160, wherein the glass-based substrate comprises a depth of compression of greater than or equal to 3 μm.

A one-hundred-and-sixty-second aspect A162 includes an apparatus according to any one of the one-hundred-and-fifty-seventh through one-hundred-and-sixty-first aspects A157-A161, wherein the glass-based substrate has a thickness of greater than or equal to 0.05 mm to less than or equal to 1 mm.

A one-hundred-and-sixty-third aspect A163 includes an apparatus according to any one of the one-hundred-and-fifty-seventh through one-hundred-and-sixty-second aspects A157-A162, wherein the first adhesive has a thickness of greater than or equal to 0.005 mm to less than or equal to 0.5 mm.

A one-hundred-and-sixty-fourth aspect A164 includes an apparatus according to any one of the one-hundred-and-fifty-seventh through one-hundred-and-sixty-third aspects A157-A163, wherein the first adhesive has a width between the distal edge and the proximal edge of greater than or equal to 0.1 mm to less than or equal to 30 mm.

A one-hundred-and-sixty-fifth aspect A165 includes an apparatus according to any one of the one-hundred-and-fifty-seventh through one-hundred-and-sixty-fourth aspects A157-A164, wherein the first adhesive further comprises a channel extending from the distal edge to the proximal edge.

A one-hundred-and-sixty-sixth aspect A166 includes an apparatus according the one-hundred-and-sixty-fifth aspect A165, wherein the channel has a depth extending from the second major surface of the first adhesive of greater than or equal to 0.005 mm to less than or equal to 0.5 mm.

A one-hundred-and-sixty-seventh aspect A167 includes an apparatus according to the one-hundred-and-sixty-fifth A165 or one-hundred-and-sixty-sixth aspects A166, wherein the channel extends from the first major surface of the first adhesive to the second major surface of the first adhesive.

A one-hundred-and-sixty-eighth aspect A168 includes an apparatus according to any one of the one-hundred-and-sixty-fifth through one-hundred-and-sixty-seventh aspects A165-A167, wherein the channel has a width extending parallel to an edge of the first adhesive of greater than or equal to 0.005 mm to less than or equal to 5 cm.

A one-hundred-and-sixty-ninth aspect A169 includes an apparatus according to any one of the one-hundred-and-fifty-seventh through one-hundred-and-sixty-eighth aspects A157-A168, wherein the first adhesive further comprises a plurality of channels extending from the distal edge to the proximal edge.

A one-hundred-and-seventieth aspect A170 includes an apparatus according to any one of the one-hundred-and-fifty-seventh through one-hundred-and-sixty-ninth aspects A157-169, wherein the first adhesive has a peel force on stainless steel of greater than or equal to 20 gf/inch to less than or equal to 5000 gf/inch.

A one-hundred-and-seventy-first aspect A171 includes an apparatus according to any one of the one-hundred-and-fifty-seventh through one-hundred-and-seventieth aspects A157-A170, wherein the first adhesive has a peel force on glass of greater than or equal to 20 gf/inch to less than or equal to 5000 gf/inch.

A one-hundred-and-seventy-second aspect A172 includes an apparatus according to any one of the one-hundred-and-fifty-seventh through one-hundred-and-seventy-first aspects A157-A171, wherein the first adhesive comprises a plurality of layers.

A one-hundred-and-seventy-third aspect A173 includes an apparatus according to any one of the one-hundred-and fifty-seventh through one-hundred-and-seventy-second aspects A157-A172, wherein a distance between the distal edge of the first adhesive and the edge of the glass-based substrate in a direction perpendicular to a thickness direction of the glass-based substrate is greater than or equal to 100 nm to less than or equal to 1 mm.

A one-hundred-and-seventy-fourth aspect A174 includes an apparatus according to any one of the one-hundred-and-fifty-seventh through one-hundred-and-seventy-third aspects A157-A173, wherein the second adhesive has a thickness of greater than or equal to 1 μm to less than or equal to 500 μm.

A one-hundred-and-seventy-fifth aspect A175 includes an apparatus according to any one of the one-hundred-and-fifty-seventh through one-hundred-and-seventy-fourth aspects A157-A174, wherein the glass-based substrate has a 3D shape.

A one-hundred-and-seventy-sixth aspect A176 includes an apparatus according to any one of the one-hundred-and-fifty-seventh through one-hundred-and-seventy-fifth aspects A157-A175, wherein mounting surface comprises a fluoropolymer coating.

A one-hundred-and-seventy-seventh aspect A177 includes an apparatus according to any one of the one-hundred-and-fifty-seventh through one-hundred-and-seventy-sixth aspects A157-A176, wherein the electronic device further comprises a display, wherein the mounting surface is disposed over the display.

A one-hundred-and-seventy-eighth aspect A178 includes an apparatus according to any one of the one-hundred-and-fifty-seventh through one-hundred-and-seventy-seventh aspects A157-A177, wherein the first adhesive comprises at least one of silicone, acrylic, polyurethane, epoxy, cyanoacrylate, and polyethylene terephthalate.

A one-hundred-and-seventy-ninth aspect A179 includes an apparatus according to any one of the one-hundred-and-fifty-seventh through one-hundred-and-seventy-eighth aspects A157-A178, wherein the first adhesive is different from the second adhesive.

A one-hundred-and-eightieth aspect A180 includes an apparatus according to any one of the one-hundred-and-fifty-seventh through one-hundred-and-seventy-ninth aspects A157-A179, wherein the glass-based substrate has a refractive index RI_{g}, the first adhesive has a refractive index RI₁, and the second adhesive has a refractive index RI₂, RI₁=RI₂±0.3, RI_{g}=RI₁±0.2, and RI_{g}=RI₂±0.2.

According to a one-hundred-and-eighty-first aspect A181, a method comprises: disposing a liquid optically clear adhesive over a mounting surface of an electronic device; adhering a second major surface of a first adhesive to the mounting surface, wherein the first adhesive comprises: a first major surface adhered to a second major surface of a glass-based substrate; a distal edge extending between the first major surface and the second major surface proximate to an edge of the glass-based substrate extending between a first major surface and the second major surface of the glass-based substrate; and a proximal edge extending between the first major surface and the second major surface proximate to a center of the mounting surface; and curing the liquid optically clear adhesive to form a second adhesive comprising: a cured liquid optically clear adhesive; a first major surface adhered to the second major surface of the glass-based substrate; a second major surface adhered to the mounting surface; and an edge extending between the first major surface and the second major surface; wherein the edge of the second adhesive is in contact with the proximal edge of the first adhesive.

A one-hundred-and-eighty-second aspect A182 includes a method according to the one-hundred-and-eighty-first aspect A181, wherein the first adhesive comprises at least one of silicone, acrylic, polyurethane, epoxy, cyanoacrylate, and polyethylene terephthalate.

A one-hundred-and-eighty-third aspect A183 includes a method according to the one-hundred-and-eighty-first aspect A181 or the one-hundred-and-eighty-second aspects A182, wherein the liquid optically clear adhesive comprises at least one of silicone, acrylate, polyurethane, epoxy, cyanoacrylate, and pinene.

A one-hundred-and-eighty-fourth aspect A184 includes a method according to any one of the one-hundred-and-eighty-first through one-hundred-and-eighty-third aspects A181-A183, wherein the liquid optically clear adhesive comprises at least one of a photo initiator, a heat initiator, a cross linker, nanoparticles, microparticles, a hydrocarbon, a polymer, an oligomer, a plasticizer, a stabilizer, an optical brightener, and a fragrance.

A one-hundred-and-eighty-fifth aspect A185 includes a method according to any one of the one-hundred-and-eighty-first through one-hundred-and-eighty-fourth aspects A181-A184, wherein curing the liquid optically clear adhesive comprises irradiating the liquid optically clear adhesive with ultraviolet light and/or visible light.

A one-hundred-and-eighty-sixty aspect A186 includes a method according to any one of the one-hundred-and-eighty-first through one-hundred-and-eighty-fifth aspects A181-A185, wherein curing the liquid optically clear adhesive comprises heating the liquid optically clear adhesive.

A one-hundred-and-eighty-seventh aspect A187 includes a method according to any one of the one-hundred-and-eighty-first through one-hundred-and-eighty-sixth aspects A181-A186, wherein curing the liquid optically clear adhesive comprises aging the liquid optically clear adhesive.

A one-hundred-and-eighty-eighth aspect A188 includes a method according to any one of the one-hundred-and-eighty-first through one-hundred-and-eighty-seventh aspects A181-A187, wherein the liquid optically clear adhesive has a viscosity of less than or equal to 2500 cps in the temperature range of −20° C. to 50° C. at a pressure of 1 atm.

A one-hundred-and-eighty-ninth aspect A189 includes a method according to any one of the one-hundred-and-eighty-first through one-hundred-and-eighty-eighth aspects A181-A188, further comprising disposing a protective mask over at least one of a button, speaker, microphone, camera, charging port, or accessory port of the electronic device prior to disposing the liquid optically clear adhesive.

A one-hundred-and-ninetieth aspect A190 includes a method according to any one of the one-hundred-and-eighty-first through one-hundred-and-eighty-ninth aspects A181-A189, further comprising disposing an absorptive material adjacent to a channel in the first adhesive extending from the distal edge to the proximal edge.

A one-hundred-and-ninety-first aspect A191 includes a method according to any one of the one-hundred-and-eighty-first through one-hundred-and-ninetieth aspects A181-A190, wherein the first adhesive is different from the second adhesive.

A one-hundred-and-ninety-second aspect A192 includes a method according to any one of the one-hundred-and-eighty-first through one-hundred-and-ninety-first aspects A181-A191, wherein the glass-based substrate has a refractive index RI_{g}, the first adhesive has a refractive index RI₁, and the second adhesive has a refractive index RI₂, RI₁=RI₂±0.3, RI_{g}=RI₁±0.2, and RI_{g}=RI₂±0.2.

According to a one-hundred-and-ninety-third aspect A193, a method comprises: adhering a second major surface of a first adhesive to a mounting surface of an electronic device, wherein the first adhesive comprises: a first major surface adhered to a second major surface of a glass-based substrate; a distal edge extending between the first major surface and the second major surface proximate to an edge of the glass-based substrate extending between a first major surface and the second major surface of the glass-based substrate; a proximal edge extending between the first major surface and the second major surface proximate to a center of the mounting surface; and a channel extending from the distal edge to the proximal edge; disposing a liquid optically clear adhesive on the mounting surface such that the liquid optically clear adhesive is in contact with the channel at the proximal edge of the first adhesive; and curing the liquid optically clear adhesive to form a second adhesive comprising: a cured liquid optically clear adhesive; a first major surface adhered to the second major surface of the glass-based substrate; a second major surface adhered to the mounting surface; and an edge extending between the first major surface and the second major surface; wherein the edge of the second adhesive is in contact with the proximal edge of the first adhesive.

A one-hundred-and-ninety-fourth aspect A194 includes a method according to the one-hundred-and-ninety-third aspect A193, wherein the first adhesive comprises at least one of silicone, acrylic, polyurethane, epoxy, cyanoacrylate, and polyethylene terephthalate.

A one-hundred-and-ninety-fifth aspect A195 includes a method according to the one-hundred-and-ninety-third aspect A193 or the one-hundred-and-ninety-fourth aspect A194, wherein the liquid optically clear adhesive comprises at least one of silicone, acrylate, polyurethane, epoxy, cyanoacrylate, and pinene.

A one-hundred-and-ninety-sixty aspect A196 includes a method according to any one of the one-hundred-and-ninety-third through one-hundred-and-ninety-fifth aspects A193-A195, wherein the liquid optically clear adhesive comprises at least one of a photo initiator, a heat initiator, a cross linker, nanoparticles, microparticles, a hydrocarbon, a polymer, an oligomer, a plasticizer, a stabilizer, an optical brightener, and a fragrance.

A one-hundred-and-ninety-seventh aspect A197 includes a method according to any one of the one-hundred-and-ninety-third through one-hundred-and-ninety-sixth aspects A193-A196, wherein curing the liquid optically clear adhesive comprises irradiating the liquid optically clear adhesive with ultraviolet light and/or visible light.

A one-hundred-and-ninety-eighth aspect A198 includes a method according to any one of the one-hundred-and-ninety-third through one-hundred-and-ninety-seventh aspects A193-A197, wherein curing the liquid optically clear adhesive comprises heating the liquid optically clear adhesive.

A one-hundred-and-ninety-ninth aspect A199 includes a method according to anyone of the one-hundred-and-ninety-third through one-hundred-and-ninety-eighth aspects A193-A198, wherein curing the liquid optically clear adhesive comprises aging the liquid optically clear adhesive.

A two-hundredth aspect A200 includes a method according to any one of the one-hundred-and-ninety-third through one-hundred-and-ninety-ninth aspects A193-A199, wherein the liquid optically clear adhesive has a viscosity of less than or equal to 2500 cps in the temperature range of −20° C. to 50° C. at a pressure of 1 atm.

A two-hundred-and-first aspect A201 includes a method according to any one of the one-hundred-and-ninety-third through two-hundredth aspect A193-A200, further comprising disposing a protective mask over at least one of a button, speaker, microphone, camera, charging port, or accessory port of the electronic device prior to disposing the liquid optically clear adhesive.

A two-hundred-and-second aspect A202 includes a method according to any one of the one-hundred-and-ninety-third through two-hundred-and-first aspects A193-A201, wherein the first adhesive is different from the second adhesive.

A two-hundred-and-third aspect A203 includes a method according to any one of the one-hundred-and-ninety-third through two-hundred-and-second aspects A193-A202, wherein the glass-based substrate has a refractive index RI_{g}, the first adhesive has a refractive index RI₁, and the second adhesive has a refractive index RI₂, RI₁=RI₂±0.3, RI_{g}=RI₁±0.2, and RI_{g}=RI₂±0.2.

Additional features and advantages will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a cross-sectional view of an exemplary screen protector system;

FIG. 2 is top down view of another exemplary screen protector system;

FIG. 3 is a cross-sectional view of the screen protector system of FIG. 2 taken along line A-A in FIG. 2;

FIG. 4 is a top down view of an embodiment of the screen protector system of FIG. 2;

FIG. 5 is a top down view of another embodiment of the screen protector system of FIG. 2;

FIG. 6 is a top down view of another embodiment of the screen protector system of FIG. 2;

FIG. 7 is a top down view of another embodiment of the screen protector system of FIG. 2;

FIG. 8 is a top down view of another embodiment of the screen protector system of FIG. 2;

FIG. 9 is a top down view of another embodiment of the screen protector system of FIG. 2;

FIG. 10 is a top down view of another embodiment of the screen protector system of FIG. 2;

FIG. 11 is a plan view of an exemplary electronic device incorporating any of the screen protectors disclosed herein;

FIG. 12 is a perspective view of the exemplary electronic device of FIG. 11;

FIG. 13 is a perspective view of an exemplary application fixture;

FIG. 14 is an exploded perspective view of another exemplary application fixture;

FIG. 15 is a perspective view of the application fixture of FIG. 14;

FIG. 16 is a another perspective view of the application fixture of FIG. 14;

FIG. 17 is another perspective view of the application fixture of FIG. 14;

FIG. 18 is another perspective view of the application fixture of FIG. 14;

FIG. 19 is another perspective view of the application fixture of FIG. 14;

FIG. 20 is a chart of ultrasonic fingerprint sensor (FPS) performance for various adhesive film thicknesses and glass substrate thicknesses for an adhesive according to an embodiment;

FIG. 21 is a chart of ultrasonic FPS performance for various adhesive film thicknesses and glass substrate thicknesses for an adhesive according to an embodiment;

FIG. 22 is a chart of ultrasonic FPS performance for various adhesive film thicknesses and glass substrate thicknesses for an adhesive according to an embodiment;

FIG. 23 is a chart of ultrasonic FPS performance for various adhesive film thicknesses and glass substrate thicknesses for an adhesive according to an embodiment;

FIG. 24 is a chart of ultrasonic FPS performance for various adhesive film thicknesses and glass substrate thicknesses for an adhesive according to an embodiment;

FIG. 25 is a chart of ultrasonic FPS performance for various adhesive film thicknesses and glass substrate thicknesses for an adhesive according to an embodiment;

FIG. 26 is a dynamic mechanical analysis temperature ramping measurement of the storage tensile modulus E′ of adhesive materials according to an embodiment;

FIG. 27 is a dynamic mechanical analysis temperature ramping measurement of the loss tensile modulus E″ of the adhesive materials of FIG. 26;

FIG. 28 is a dynamic mechanical analysis temperature ramping measurement of the damping factor tan(δ) of the adhesive materials of FIG. 26;

FIG. 29 is a dynamic mechanical analysis master curve at 20° C. of the storage tensile modulus E′ as a function of frequency of adhesive materials according to an embodiment;

FIG. 30 is a dynamic mechanical analysis master curve at 20° C. of the loss tensile modulus E″ as a function of frequency of the adhesive materials of FIG. 29;

FIG. 31 is a dynamic mechanical analysis master curve at 20° C. of the damping factor tan(δ) as a function of frequency of the adhesive materials of FIG. 29;

FIG. 32 is the computed real impedance at the adhesive and device cover interface for an adhesive according to an embodiment;

FIG. 33 is the computed difference in power received by the sensor detector between the area of fingerprint ridges and valleys for the adhesive of FIG. 32;

FIG. 34 is the computed real impedance at the adhesive and device cover interface for an adhesive according to an embodiment;

FIG. 35 is the computed difference in power received by the sensor detector between the area of fingerprint ridges and valleys for the adhesive of FIG. 34;

FIG. 36 is the computed real impedance at the adhesive and device cover interface for the adhesive of FIG. 32;

FIG. 37 is the computed difference in power received by the sensor detector between the area of fingerprint ridges and valleys for the adhesive of FIG. 32;

FIG. 38 is an intensity spectrum of a display, an intensity spectrum of the display with a screen protector according to an embodiment, and an intensity spectrum of the display with a commercially available screen protector;

FIG. 39 is intensity spectra of the difference, at various aging times, between an intensity of a display after application of a screen protector according to embodiments discussed herein and an intensity of a display without a screen protector;

FIG. 40 is the intensity spectra of FIG. 39 at wavelengths of 400-500 nm;

FIG. 41 is the intensity spectra of FIG. 39 at wavelengths of 500-600 nm;

FIG. 42 is the intensity spectra of FIG. 39 at wavelengths of 600-700 nm;

FIG. 43 is intensity spectra of the difference, at various aging times, between an intensity of a display after application of a screen protector according to embodiments discussed herein and an intensity of a display without a screen protector;

FIG. 44 is the intensity spectra of FIG. 43 at wavelengths of 400-500 nm;

FIG. 45 is the intensity spectra of FIG. 43 at wavelengths of 500-600 nm;

FIG. 46 is intensity spectra of 43 at wavelengths of 600-700 nm;

FIG. 47 is intensity spectra of the difference, at various aging times, between an intensity of a display after application of a screen protector according to embodiments discussed herein and an intensity of a display without a screen protector;

FIG. 48 is the intensity spectra of FIG. 47 at wavelengths of 400-500 nm;

FIG. 49 is the intensity spectra of FIG. 47 at wavelengths of 500-600 nm;

FIG. 50 is the intensity spectra of FIG. 47 at wavelengths of 600-700 nm;

FIG. 51 is intensity spectra of the difference, at various aging times, between an intensity of a display after application of a screen protector according to embodiments discussed herein and an intensity of a display without a screen protector;

FIG. 52 is the intensity spectra of FIG. 51 at wavelengths of 400-500 nm;

FIG. 53 is the intensity spectra of FIG. 51 at wavelengths of 500-600 nm;

FIG. 54 is the intensity spectra of FIG. 51 at wavelengths of 600-700 nm;

FIG. 55 is normalized intensity spectra for various light sources;

FIG. 56 is transmission spectra of cured liquid adhesives according to embodiments and a comparative adhesive film;

FIG. 57 is normalized absorbance spectra of cured liquid adhesives according to embodiments;

FIG. 58 is absorptivity spectra of the cured liquid adhesives of FIG. 57;

FIG. 59 is transmission spectra of cured liquid adhesives according to embodiments and a comparative adhesive film;

FIG. 60 is normalized absorbance spectra of cured liquid adhesives according to embodiments and a comparative adhesive film;

FIG. 61 is absorptivity spectra of the liquid adhesives of FIG. 60;

FIG. 62 is a normalized absorbance spectrum of a liquid adhesive at various aging times according to embodiments;

FIG. 63 is a normalized absorptivity spectrum for various concentrations of the adhesive of FIG. 62 before photobleaching;

FIG. 64 is a normalized absorptivity spectrum for various concentrations of the adhesive of FIG. 62 after photobleaching;

FIG. 65 is infrared spectra of cured and uncured adhesive composition according to embodiments;

FIG. 66 is the infrared spectra of FIG. 65 at wavelengths of 700-900 nm;

FIG. 67 is a chart of the percent of polymerization as a function of time according to embodiments;

FIG. 68 is infrared spectra of TTMSS in an uncured adhesive formulation;

FIG. 69 is infrared spectra of TTMSS in a cured adhesive formulation;

FIG. 70 is a chart of the percent of polymerization as a function of time according to an embodiment;

FIG. 71A is a high-resolution photograph of a cured adhesive composition embodiment between a cover glass and a screen protector;

FIG. 71B is a high-resolution photograph of a cured adhesive composition embodiment between a cover glass and a screen protector;

FIG. 72A is a magnified high-resolution photograph of the embodiment of FIG. 71A;

FIG. 72B is a magnified high-resolution photograph of the embodiment of FIG. 71B;

FIG. 73A is a magnified high-resolution photograph of a cured adhesive composition embodiment between a cover glass and a screen protector;

FIG. 73B is a magnified high-resolution photograph of a cured adhesive composition embodiment between a cover glass and a screen protector;

FIG. 74 is a chart of areal shrinkage as a function of time of an adhesive composition embodiment at room temperature and approximately 50% relative humidity;

FIG. 75 is a chart of areal shrinkage as a function of time the adhesive composition embodiment at 80° C. and 50% relative humidity;

FIG. 76 is a chart of fixing time as a function of final shrinkage percentage of adhesive composition embodiments;

FIG. 77 is a photograph of a screen protector removed from a device cover glass with a heavily degraded ETC layer including adhesive composition embodiments;

FIG. 78 is a photograph of the device cover glass of FIG. 77 with heavily degraded ETC layer including adhesive composition embodiments;

FIG. 79 is a photograph of another screen protector removed from a device cover glass with a heavily degraded ETC layer including adhesive composition embodiments;

FIG. 80 is a photograph of the device cover glass of FIG. 79 with a heavily degraded ETC layer including adhesive composition embodiments;

FIG. 81 is a chart showing the residue that remained on the cover glass as a function of the degree of degradation of the cover glass ETC layer represented by contact angles (CA) of water (H₂O) and hexadecane (HD);

FIG. 82 is another chart showing the residue that remained on the cover glass as a function of the degree of degradation of the cover glass ETC layer and adhesive composition embodiments represented by contact angles of water (H₂O) and hexadecane (HD);

FIG. 83 is a top-down view of a screen protector assembly after being applied to an electronic device;

FIG. 84 is a perspective view of the screen protector assembly of FIG. 83;

FIG. 85 is a top-down view of a screen protector assembly after being applied to an electronic device;

FIG. 86 is a top-down view of a screen protector assembly after being applied to an electronic device;

FIG. 87 is a top-down view of a screen protector assembly after being applied to an electronic device; and

FIG. 88 is a top-down view of a screen protector assembly after being applied to an electronic device.

### DETAILED DESCRIPTION

Reference will now be made in detail to various adhesive compositions and kits for applying a screen protector to a cover glass of an electronic device. According to embodiments, a screen protector application kit includes a glass-based substrate having an adhesive belt and a container of an uncured adhesive composition. The adhesive belt includes a first major surface adhered to the glass-based substrate, a second major surface, a distal edge extending between the first major surface and the second major surface, and a proximal edge extending between the first major surface and the second major surface. The uncured adhesive composition includes 30 wt % to 99.9 wt % of at least one of: (i) a monomer; and (ii) an oligomer; and 0.01 wt % to 10 wt % of a visible-light photoinitiator. The uncured adhesive composition may further include 0.1 wt % to 10 wt % of a co-initiator. The uncured adhesive composition may further include 0.1 wt % to 5 wt % of an oxygen inhibitor. In embodiments, a screen protector application kit includes a glass-based substrate, a container of an uncured adhesive composition, and an application fixture. The uncured adhesive composition includes 30 wt % to 99.9 wt % of at least one of: (i) a monomer; and (ii) an oligomer; and 0.01 wt % to 10 wt % of a visible-light photoinitiator. The application fixture includes a rectangular frame having a pair of length sides and a pair of width sides. In embodiments, the application fixture further includes a plurality of tabs extending from one of the pair of width sides in a direction perpendicular to the pair of width sides, a plurality of protrusions extending from each of the pair of length sides in a direction perpendicular to the pair of length sides, and at least one level positioned in one of at least one of the pair of length sides and the pair of width sides. In embodiments, the application fixture further includes a plurality of tabs extending from one of the pair of width sides in a direction perpendicular to the pair of width sides, at least one groove in the other of the pair of width sides, and a wedge slider insertable into the at least one groove.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation; and the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

When a definition used herein conflicts with a definition incorporated by reference, the definition used herein controls.

The phrase “percent of polymerization,” as used herein, is defined via the initial area (A₀) and the area at a given time (Aₜ) of a peak centered at 809 cm⁻¹ (799-818 cm⁻¹), which corresponds to the C═C bond, as measured by Fourier-transform infrared spectroscopy (FTIR) by:

$$\% polymerization = \frac{{A}_{0} - {A}_{t}}{{A}_{0}} \times 100 \%$$

The baseline of the peak is taken to be the straight line that connects the intensity of the FTIR spectrum at 799 cm⁻¹ and 819 cm⁻¹ (or the isosbestic points near 799 cm⁻¹ and 819 cm⁻¹) because this range has minimal interference from other neighboring peaks and to minimize the effect of gradual shifts in the baseline of the spectrum.

The phrase “second derivative of degree of polymerization,” as used herein, is defined by the area (A) of a peak centered at 809 cm⁻¹ as measured by Fourier-transform infrared spectroscopy (FTIR) by:

$$\frac{{d}^{2} A}{{dt}^{2}}$$

The phrase “uncured adhesive composition,” as used herein, refers to an adhesive composition that has not been exposed to a light source having an emission spectrum less than 700 nm or to an adhesive composition having a degree of polymerization less than 10% as measured by FTIR after being exposed to 6500 K fluorescent light with an illuminance of at least 300 lux for 60-120 minutes at a thickness of 0.1 mm.

The phrase “cured adhesive composition,” as used herein, refers to an adhesive composition having a degree of polymerization greater than or equal to 10% as measured by FTIR after being exposed to 6500 K fluorescent light with an illuminance of at least 300 lux for 60-120 minutes at a thickness of 0.1 mm and having a second derivative degree of polymerization that has not reached a minimum as measured by FTIR after being exposed to 6500 K fluorescent light with an illuminance of at least 300 lux for 30-60 minutes at a thickness of 0.1 mm.

The phrase “fixed adhesive composition,” as used herein, refers to an adhesive composition having a second derivative degree of polymerization that has reached a minimum as measured by FTIR after being exposed to 6500 K fluorescent light with an illuminance of at least 300 lux for 30-60 minutes at a thickness of 0.1 mm.

The phrase “visible light source,” as used herein, refers to a light source that has an integrated emission intensity wherein the area attributable to wavelengths less than 410 nm is less than 15% of the total integrated emission intensity in the wavelength range of 10 nm to 900 nm. The visible light source may include any appropriate light-producing element. In embodiments, the visible light source includes at least one of a fluorescent lamp, a light-emitting diode, a laser, a tungsten lamp, a halogen lamp, a mercury lamp, an incandescent lamp, and sunlight.

The phrase “UV light source,” as used herein, refers to a light source that has integrated emission intensity wherein the area attributable to wavelengths less than 410 nm is greater than 15% of the total integrated emission intensity in the wavelength range of 10 nm to 900 nm.

Transmission, as described herein, is measured in accordance with ASTM D1003 with a standard CIE-C illuminant with a wavelength range of 380 nm to 720 nm at a thickness of 0.2 mm, unless otherwise indicated.

The phrase “transmission haze,” as used herein, refers to the ratio of transmitted light scattered at an angle greater than 2.5° from normal to all transmitted light over the total transmission. Transmission haze, as described herein, is measured in accordance with ASTM D1003 with a standard CIE-C illuminant with a wavelength range of 380 nm to 720 nm at a thickness of 0.2 mm, unless otherwise indicated.

The term “clarity,” as used herein refers to the ratio of transmitted light scattered at an angle less than 2.5° from normal to all transmitted light over the total transmission. Clarity, as described herein, is measured in accordance with ASTM D1003 with a standard CIE-C illuminant with a wavelength range of 380 nm to 720 nm at a thickness of 0.2 mm, unless otherwise indicated.

The term “absorbance (A),” as used herein, is defined via the incident intensity (Jo) and transmitted intensity (I) by:

$$A = {log}_{10} ( \frac{{I}_{0}}{I} )$$

The term “absorptivity,” as used herein, refers to the property of a chemical that determined the ability of the chemical to absorb incident light in a given wavelength range. The absorptivity was measured when the photoinitiator was dissolved in the liquid adhesive composition and immediately after curing with minimal photobleaching effect. “Absorptivity” may also be referred to as “extinction coefficient.”

According to the Beer-Lambert Law, the absorbance is proportional to the concentration of the visible-light photoinitiator (c) and the thickness of the film (l) by the absorptivity or extinction coefficient (e):

A=εcl

An absorption peak, as described herein, is determined by Gaussian curve fitting with a coefficient of determination R²>0.95. The peak location is the wavelength of the local maximum of the spectrum identified by Gaussian curve fitting with the coefficient of determination R²>0.95.

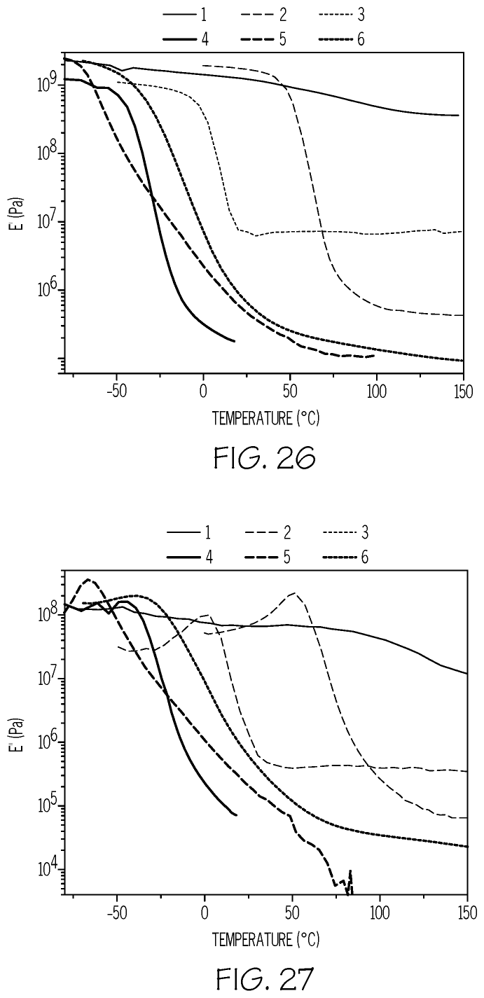

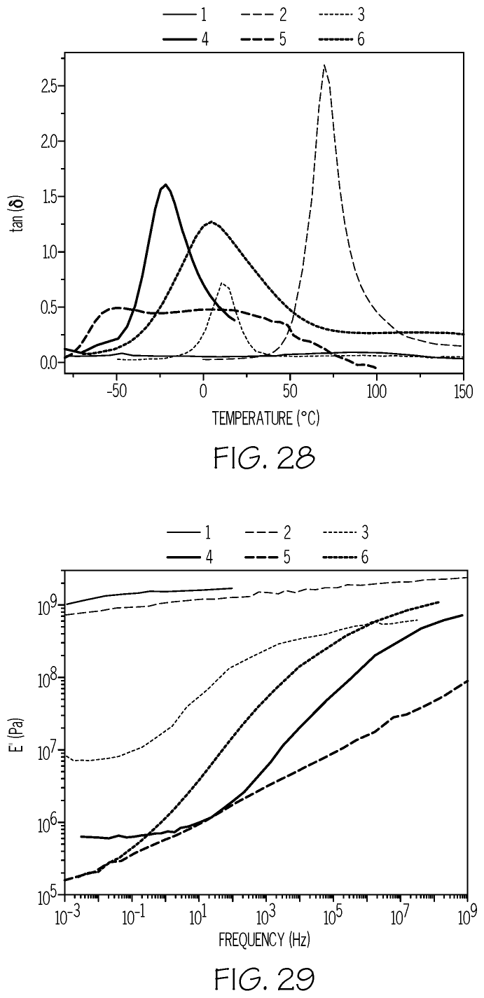

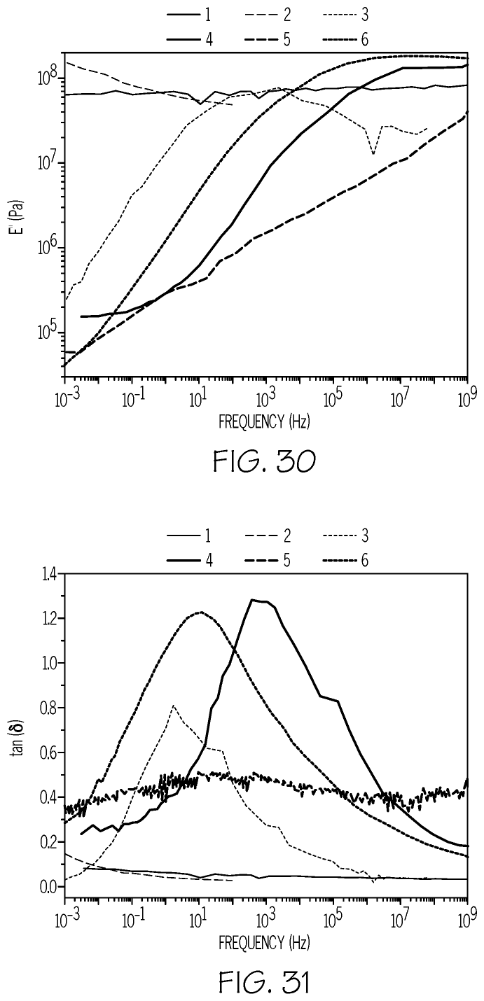

The tensile properties storage modulus (E′) and loss modulus (E″), as described herein, are measured by dynamic mechanical analysis (DMA). Specifically, E′ and E″ are measured by an RSA-G2 instrument (TA instruments) using rectangular film geometry fixtures. The samples are cut to the dimension of 10-12 mm in length, 5-8 mm in width, and about 0.2 mm in thickness. Firstly, temperature ramp tests are performed dynamically in tension using FRT normal force transducer mode. Axial force is set to active in tension mode with a level of 1 N±0.1 N. Force tracking mode is used with a setting of axial force>dynamic force equal to 20% and a minimum force of 0.005 N. Auto strain adjustment mode is enabled to optimize the signal to noise ratio using a strain adjust setting of 80%, minimum strain of 0.02%, maximum strain of 2%, minimum force of 0.01 N, and maximum force of 2 N. Once the specimen is loaded, it is cooled to −50° C. by liquid nitrogen. Once equilibrated, the test is started by oscillating the specimen at a frequency of 1 Hz, 0.2% initial strain, and heated from −50 to 120° C. at a rate of 2° C./min. Results of the temperature ramp are shown at FIGS. 26, 27, and 28. Temperature sweep tests are performed dynamically in tension using an RSA-G2 instrument (TA Instruments). The dimension of the specimen is in the same range as the specimen for temperature ramp. The transducer, force tracking, and auto strain adjustment modes are also the same. Rate sweeps are conducted from 0.1 to 100 Hz with a temperature from 0 to 60° C. every 10° C. at an initial dynamic strain of 0.1%. Results of temperature sweep tests shifted to a new reference temperature of 20° C. (room temperature) using the WLF (William, Landel, and Ferry) equation (called master curves) are shown at FIGS. 29, 30, and 31.

Emission intensity spectra of light sources, as described herein, are measured by Ocean Optics Spectrophotometer. Spectra collected are the average of 3 spectra, with a boxcar smoothing of 3. The integration time is adjusted from 50 ms to 3 s to avoid saturating the detector. The illuminance (luminous intensity of the light source that reaches the detector) is measured by a lux meter.

The phrase “glass-based,” as described herein, includes both glasses and glass-ceramics, wherein glass-ceramics have one or more crystalline phases and an amorphous, residual glass phase. The glass-based substrate may comprise an amorphous material (e.g., glass) and optionally one or more crystalline materials (e.g., ceramic). Amorphous materials and glass-based materials comprising the glass-based substrate may be thermally or chemically strengthened, as described below. Exemplary glass-based materials, which may be free of lithia or not, comprise soda lime glass, alkali aluminosilicate glass, alkali borosilicate glass, alkali aluminophosphosilicate glass, and alkali aluminoborosilicate glass.

Young's modulus values, as described herein, refer to a value as measured by a resonant ultrasonic spectroscopy technique of the general type set forth in ASTM E2001-13, titled “Standard Guide for Resonant Ultrasound Spectroscopy for Defect Detection in Both Metallic and Non-metallic Parts,” unless otherwise indicated.

Poisson's ratio values, as described herein, refer to a value as measured by a resonant ultrasonic spectroscopy technique of the general type set forth in ASTM E2001-13, titled “Standard Guide for Resonant Ultrasound Spectroscopy for Defect Detection in Both Metallic and Non-metallic Parts,” unless otherwise indicated.

Peel force measurements, as described herein, refer to a value as measured by the technique set forth in ASTM D3330, unless otherwise indicated.

Surface compressive stress (CS), as described herein, is measured by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass under stress. SOC in turn is measured according to Procedure C (Glass Disc Method) described in ASTM standard C770-16, entitled “Standard Test Method for Measurement of Glass Stress-Optical Coefficient,” the contents of which are incorporated herein by reference in their entirety.

A liquid optically clear adhesive (LOCA) is an attractive choice for screen protector applications, especially for screen protectors that are applied to devices with complex, non-flat surfaces and include ultrasonic sensors (e.g., fingerprint sensors). A LOCA is compatible with ultrasonic sensors and provides good wetting and spreading properties to allow it to fill the gap produced by the shape mismatch of a screen protector and the surface to which it is being applied. Previously, screen protector applications have employed uncured adhesive compositions that must be cured by exposure to ultraviolet (UV) irradiation. The curing process for these types of uncured adhesive compositions requires a UV light source, which increases the cost of the product and complexity of the application of the screen protector. Additionally, a potential danger of UV exposure is created for the users applying the screen protectors.

The LOCA compositions described herein may be cured by exposure to a visible light source because of the presence of visible-light-sensitive photoinitiators in the uncured adhesive compositions. With the addition of co-initiators, oxygen inhibitors, and polymerizable crosslinkers and surfactants, the LOCA compositions described herein fix in a relatively short period of time after application, have minimal shrinkage after curing, and have a low enough peel force so that the screen protector may be removed if the screen protector is damaged. The composition and thickness of the LOCA are optimized to be compatible with ultrasonic sensors and to maximize optical clarity of the LOCA. Application kits described herein provide for quick, easy, and successful application of the screen protector by consumers who may have no experience with installing screen protectors.

The uncured adhesive compositions described herein may be generally described as uncured LOCA. The uncured adhesive compositions described herein comprise at least one of: (i) a monomer; and (ii) an oligomer; and a visible-light photoinitiator having sufficient absorption in the visible light wavelength range to achieve curing of the uncured adhesive composition by exposure to a visible light source. In addition, the uncured adhesive compositions described herein may further contain at least one of a co-initiator and an oxygen inhibitor, which may assist in shortening the curing time of the uncured adhesive compositions and reducing areal shrinkage of the cured adhesive compositions. The cured adhesive compositions described herein may have a reduced peel strength such that no residue is left on the cover glass when the screen protector is removed.

The uncured adhesive compositions described herein may comprise a monomer, an oligomer, or a combination thereof that is polymerized during the curing process. The monomers and oligomers of the uncured adhesive composition may be selected such that they are capable of polymerizing to form a desired polymer, such as a polyacrylate. In embodiments, the monomers and oligomers may be capable of radical polymerization. In embodiments, the at least one of a monomer and an oligomer may comprise silicone, polyacrylic, polyurethane, epoxy, cyanoacrylate, polyethylene, polyterephthalate, poly(vinyl alcohol), polystyrene, methacrylate (e.g., poly(methyl methacrylate)), polydimethylsiloxane, or a combination thereof. In embodiments, the at least one of a monomer and an oligomer may comprise cyclic hydrocarbon polyacrylate, aliphatic polyacrylate, polysiloxane acrylate, polydimethylsiloxane acrylate, silicone polyetheracrylate, urethane acrylate, monofunctional acrylate, difunctional acrylate, trifunctional acrylate, tetrafunctional acrylate, polyfunctional acrylate, or a combination thereof. In embodiments, the uncured adhesive composition may comprise greater than or equal to 30 wt % and less than 99.9 wt % of the at least one of: (i) a monomer; and (ii) an oligomer. In embodiments, the uncured adhesive composition may comprise greater than or equal to 80 wt % and less than or equal to 99.9 wt % of the at least one of: (i) a monomer; and (ii) an oligomer. In embodiments, the uncured adhesive composition may comprise greater than or equal to 95 and less than or equal to 99.9 wt % of the at least one of: (i) a monomer; and (ii) an oligomer. In embodiments, the concentration of the at least one of: (i) a monomer; and (ii) an oligomer in the uncured adhesive composition may be greater than or equal to 30 wt %, greater than or equal to 40 wt %, greater than or equal to 50 wt %, greater than or equal to 60 wt %, greater than or equal to 70 wt %, greater than or equal to 80 wt %, greater than or equal to 85 wt %, greater than or equal to 90 wt %, or even greater than or equal to 95 wt %. In embodiments, the concentration of the at least one of: (i) a monomer; and (ii) an oligomer in the uncured adhesive composition may be greater than or equal to 30 wt % and less than or equal to 99.9 wt %, greater than or equal to 40 wt % and less than or equal to 99.9 wt %, greater than or equal to 50 wt % and less than or equal to 99.9 wt %, greater than or equal to 60 wt % and less than or equal to 99.9 wt %, greater than or equal to 70 wt % and less than or equal to 99.9 wt %, greater than or equal to 80 wt % and less than or equal to 99.9 wt %, greater than or equal to 85 wt % and less than or equal to 99.9 wt %, greater than or equal to 90 wt % and less than or equal to 99.9 wt %, greater than or equal to 93 wt % and less than or equal to 99.9 wt %, greater than or equal to 95 wt % and less than or equal to 99.9 wt %, greater than or equal to 97 wt % and less than or equal to 99.9 wt %, greater than or equal to 98 wt % and less than or equal to 99.9 wt %, greater than or equal to 50 wt % and less than or equal to 95 wt %, greater than or equal to 60 wt % and less than or equal to 95 wt %, greater than or equal to 80 wt % and less than or equal to 95 wt %, greater than or equal to 85 wt % and less than or equal to 95 wt %, greater than or equal to 70 wt % and less than or equal to 90 wt %, greater than or equal to 80 wt % and less than or equal to 90 wt %, greater than or equal to 83 wt % and less than or equal to 90 wt %, greater than or equal to 85 wt % and less than or equal to 90 wt %, greater than or equal to 86 wt % and less than or equal to 90 wt %, greater than or equal to 87 wt % and less than or equal to 90 wt %, greater than or equal to 88 wt % and less than or equal to 90 wt %, greater than or equal to 80 wt % and less than or equal to 89 wt %, greater than or equal to 83 wt % and less than or equal to 89 wt %, greater than or equal to 85 wt % and less than or equal to 89 wt %, or even greater than or equal to 87 wt % and less than or equal to 89 wt %, or any and all sub-ranges formed from any of these endpoints.

The visible-light photoinitiators included in the uncured adhesive compositions described herein are selected to match the spectra of the lighting source intended for curing of the uncured adhesive composition. The uncured adhesive compositions described herein may be cured by exposure to a visible light source. The curing of the uncured adhesive composition by exposure to a visible light source is achieved by inclusion of a visible-light photoinitiator that has sufficient absorption in the visible light wavelength range. The absorption of the visible-light photoinitiator may be weighted to relatively short wavelengths in the visible wavelength range, such as less than about 500 nm, because this wavelength range has a relatively high energy, which facilitates the initiation of polymerization. The absorption of the photoinitiator may be weighted to relatively long wavelengths in the visible wavelength range, such as more than about 500 nm, because many household light sources emit more light in this wavelength range, which facilitates the initiation of polymerization. Absorption of wavelengths of less than about 500 nm corresponds to the absorption of purple/blue light, which may produce a yellow/orange appearance of the uncured adhesive composition and the cured adhesive composition produced from the uncured adhesive composition. Absorption of wavelength greater than 500 nm corresponds to the absorption of yellow to red light, which may produce a blue appearance of the LOCA and the cured adhesive film produced from the LOCA. The absorption by the visible-light photoinitiator, the spectra of the curing light sources, and the color appearance of the cured adhesive composition are important considerations when determining the appropriate uncured adhesive composition for use in screen protector applications. Similarly, it may be desirable to select a visible-light photoinitiator that photobleaches, meaning that the reaction of the visible-light photoinitiator under the light results in loss of color. Additionally, to reduce the curing time of the uncured adhesive composition, it may be desirable to include a visible-light photoinitiator that, by itself or with a co-initiator, assists with radical polymerization.

In embodiments, the visible-light photoinitiator may comprise phosphine oxide-based compounds, cyanine compounds, indocyanine compounds, xanthene compounds, fluorone compounds, thioxanthone compounds, phenyl glyoxylate-based compounds, cyclic ketoester-based compounds, benzoin ether-based compounds, amine compounds, α-hydroxy ketone-based compounds, fluorinated diaryl titanocene compounds, or a combination thereof. In embodiments, the photinitiator may comprise, phenylbis(2,4,6-trimethyl benzoyl)phosphine oxide (e.g., Irgacure 819), bis(eta-5-2,4-cyclopentadien-1-yl)bis[2,6-difluoro-3-(1H-pyrrol-1-yl phenyl]titanium (e.g., Irgacure 784), 1-butyl-2-[5-(1-butyl-1,3-dihydro-3,3-dimethyl-2H-indol-2-ylidene)-1,3-pentadien-1-yl]-3,3-dimethyl-3H-indolium salt (e.g., H-Nu 640 MP), or combinations thereof.

In embodiments, the uncured adhesive composition may comprise greater than or equal to 0.01 wt % and less than or equal to 10 wt % of the visible-light photoinitiator. In embodiments, the uncured adhesive composition may comprise greater than or equal to 0.05 wt % and less than or equal to 5 wt % of the visible-light photoinitiator. In embodiments, the uncured adhesive composition may comprise greater than or equal to 0.1 wt % and less than or equal to 2 wt % of the visible-light photoinitiator. In embodiments, the concentration of the visible-light photoinitiator in the uncured adhesive composition may be greater than or equal to greater than or equal to 0.01 wt %, greater than or equal to 0.05 wt %, greater than or equal 0.1 wt %, greater than or equal to 0.5 wt %, greater than or equal to 0.7 wt %, or even greater than or equal to 0.8 wt %. In embodiments, the concentration of the visible-light photoinitiator in the uncured adhesive composition may be less than or equal to 10 wt %, less than or equal to 7 wt %, less than or equal to 5 wt %, less than or equal to 3 wt %, less than or equal to 2 wt %, less than or equal to 1.5 wt %, less than or equal to 1.3 wt %, less than or equal to 1.1 wt %, or even less than or equal to 1.0 wt %. In embodiments, the concentration of the visible-light photoinitiator in the uncured adhesive composition may be greater than or equal to 0.01 wt % and less than or equal to 10 wt %, greater than or equal to 0.01 wt % and less than or equal to 7 wt %, greater than or equal to 0.01 wt % and less than or equal to 5 wt %, greater than or equal to 0.01 wt % and less than or equal to 3 wt %, greater than or equal to 0.01 wt % and less than or equal to 2 wt %, greater than or equal to 0.01 wt % and less than or equal to 1.5 wt %, greater than or equal to 0.01 wt % and less than or equal to 1.3 wt %, greater than or equal to 0.01 wt % and less than or equal to 1.1 wt %, greater than or equal to 0.01 wt % and less than or equal to 1.0 wt %, greater than or equal to 0.05 wt % and less than or equal to 10 wt %, greater than or equal to 0.05 wt % and less than or equal to 7 wt %, greater than or equal to 0.05 wt % and less than or equal to 5 wt %, greater than or equal to 0.05 wt % and less than or equal to 3 wt %, greater than or equal to 0.05 wt % and less than or equal to 2 wt %, greater than or equal to 0.05 wt % and less than or equal to 1.5 wt %, greater than or equal to 0.05 wt % and less than or equal to 1.3 wt %, greater than or equal to 0.05 wt % and less than or equal to 1.1 wt %, greater than or equal to 0.05 wt % and less than or equal to 1.0 wt %, greater than or equal to 0.1 wt % and less than or equal to 10 wt %, greater than or equal to 0.1 wt % and less than or equal to 7 wt %, greater than or equal to 0.1 wt % and less than or equal to 5 wt %, greater than or equal to 0.1 wt % and less than or equal to 3 wt %, greater than or equal to 0.1 wt % and less than or equal to 2 wt %, greater than or equal to 0.1 wt % and less than or equal to 1.5 wt %, greater than or equal to 0.1 wt % and less than or equal to 1.3 wt %, greater than or equal to 0.1 wt % and less than or equal to 1.1 wt %, greater than or equal to 0.1 wt % and less than or equal to 1.0 wt %, greater than or equal to 0.5 wt % and less than or equal to 10 wt %, greater than or equal to 0.5 wt % and less than or equal to 7 wt %, greater than or equal to 0.5 wt % and less than or equal to 5 wt %, greater than or equal to 0.5 wt % and less than or equal to 3 wt %, greater than or equal to 0.5 wt % and less than or equal to 2 wt %, greater than or equal to 0.5 wt % and less than or equal to 1.5 wt %, greater than or equal to 0.5 wt % and less than or equal to 1.3 wt %, greater than or equal to 0.5 wt % and less than or equal to 1.1 wt %, greater than or equal to 0.5 wt % and less than or equal to 1.0 wt %, greater than or equal to 0.7 wt % and less than or equal to 10 wt %, greater than or equal to 0.7 wt % and less than or equal to 7 wt %, greater than or equal to 0.7 wt % and less than or equal to 5 wt %, greater than or equal to 0.7 wt % and less than or equal to 3 wt %, greater than or equal to 0.7 wt % and less than or equal to 2 wt %, greater than or equal to 0.7 wt % and less than or equal to 1.5 wt %, greater than or equal to 0.7 wt % and less than or equal to 1.3 wt %, greater than or equal to 0.7 wt % and less than or equal to 1.1 wt %, greater than or equal to 0.7 wt % and less than or equal to 1.0 wt %, greater than or equal to 0.9 wt % and less than or equal to 10 wt %, greater than or equal to 0.9 wt % and less than or equal to 7 wt %, greater than or equal to 0.9 wt % and less than or equal to 5 wt %, greater than or equal to 0.9 wt % and less than or equal to 3 wt %, greater than or equal to 0.9 wt % and less than or equal to 2 wt %, greater than or equal to 0.9 wt % and less than or equal to 1.5 wt %, greater than or equal to 0.9 wt % and less than or equal to 1.3 wt %, greater than or equal to 0.9 wt % and less than or equal to 1.1 wt %, or even greater than or equal to 0.9 wt % and less than or equal to 1.0 wt %, or any and all sub-ranges formed between any of these endpoints.

The absorptivity of the visible-light photoinitiator included in the uncured adhesive composition in the visible light spectrum, prior to photobleaching, may be sufficient to allow for initiation of the polymerization of the uncured adhesive composition upon exposure to visible light. In embodiments, the visible-light photoinitiator may have an absorptivity in the wavelength range of 380 nm to 750 nm greater than or equal to 200 L/mol/cm and less than or equal to 5000 L/mol/cm, greater than or equal to 250 L/mol/cm and less than or equal to 4000 L/mol/cm, greater than or equal to 300 L/mol/cm and less than or equal to 3000 L/mol/cm, greater than or equal to 350 L/mol/cm and less than or equal to 2000 L/mol/cm, greater than or equal to 400 L/mol/cm and less than or equal to 1000 L/mol/cm, or even greater than or equal to 450 L/mol/cm and less than or equal to 850 L/mol/cm, or any and all sub-ranges formed between any of these endpoints. “Photobleaching” of the photoinitiator, means that the uncured adhesive composition with the photoinitiator, when irradiated by light sources in the wavelength range of 380 nm to 750 nm, loses color because of chemical changes to the photoinitiator. Where the absorptivity of the visible-light photoinitiator in the wavelength range of 380 nm to 750 nm is too low, the uncured adhesive composition may not be able to be cured by exposure to visible light. In cases where the absorbance (the product of absorptivity and concentration) of the visible-light photoinitiator in the wavelength range of 380 nm to 750 nm is too high, undesirable optical effects may be produced.

The visible-light photoinitiators included in the uncured adhesive composition may also be characterized by their absorbance. In embodiments, the visible-light photoinitiator has a thickness-normalized absorbance in the wavelength range of 380 nm to 750 nm greater than or equal to 2 cm⁻¹ and less than or equal to 50 cm⁻¹, greater than or equal to 3 cm⁻¹ and less than or equal to 45 cm⁻¹, greater than or equal to 4 cm⁻¹ and less than or equal to 40 cm⁻¹, greater than or equal to 5 cm⁻¹ and less than or equal to 35 cm⁻¹, greater than or equal to 10 cm⁻¹ and less than or equal to 30 cm⁻¹, or even greater than or equal to 15 cm⁻¹ and less than or equal to 25 cm⁻¹, or any and all sub-ranges formed from any of these endpoints. The ranges of the normalized absorbance are without the photobleaching of the photoinitiator, which means that the uncured adhesive composition with the photoinitiator is not irradiated by any type of light source that has a wavelength range that overlaps with the absorption spectrum of the photoinitiator. Where the thickness-normalized absorbance of the visible-light photoinitiator in the wavelength range of 380 nm to 750 nm is too low, the uncured adhesive composition may not be able to be cured by exposure to visible light. In cases where the thickness-normalized absorbance of the visible-light photoinitiator in the wavelength range of 380 nm to 750 nm is too high, undesirable optical effects may be produced.

The performance of the visible-light photoinitiator may also be characterized by the location of absorption peaks. In embodiments, the visible-light photoinitiator may have an absorption peak in a wavelength range greater than or equal to 350 nm and less than or equal to 750 nm, greater than or equal to 350 nm and less than or equal to 600 nm, greater than or equal to 350 nm and less than or equal to 500 nm, greater than or equal to 350 nm and less than or equal to 450 nm, greater than or equal to 350 nm and less than or equal to 400 nm, greater than or equal to 350 nm and less than or equal to 390 nm, greater than or equal to 360 nm and less than or equal to 750 nm, greater than or equal to 360 nm and less than or equal to 600 nm, greater than or equal to 360 nm and less than or equal to 500 nm, greater than or equal to 360 nm and less than or equal to 450 nm, greater than or equal to 360 nm and less than or equal to 400 nm, greater than or equal to 360 nm and less than or equal to 390 nm, greater than or equal to 370 nm and less than or equal to 750 nm, greater than or equal to 370 nm and less than or equal to 600 nm, greater than or equal to 370 nm and less than or equal to 500 nm, greater than or equal to 370 nm and less than or equal to 450 nm, greater than or equal to 370 nm and less than or equal to 400 nm, or even greater than or equal to 370 nm and less than or equal to 390 nm, or any and all sub-ranges formed between these endpoints. In embodiments, the visible-light photoinitiator has an absorption peak outside the visible light range, but may cure in the visible light range because it has an absorptivity or a thickness-normalized absorbance falling within the ranges described hereinabove.

The co-initiators included in the uncured adhesive compositions described herein are selected to decrease the fixing and curing times of the uncured adhesive composition. While the presence of visible-light photoinitiators in the uncured adhesive compositions described herein allows for curing in the visible light range, such uncured adhesive compositions may have relatively slow fixing and curing times. The co-initiators described herein promote polymerization, particularly radical polymerization. Increasing the rate of polymerization reduces the fixing and curing times of the uncured adhesive composition, which may help to reduce shrinkage of the cured adhesive composition.

In embodiments, the co-initiator may comprise a silane, carbazole, iodonium salt, sulfonium salt, borate salt, amine, amine acrylate, acrylamide, or a combination thereof. In embodiments, the iodonium or sulfonium salt may have an anion counter-ion such as hexafluorophosphate, hexafluoroarsenate, hexafluoroantimonate, tetrafluoroborate, bifluoride, perchlorate, chloride, bromide, iodide, nitrate, silicate (e.g., difluorotrimethylsilicate and/or hexafluorosilicate), sulfonate (e.g., triflate, p-toluenesulfonate, and/or perfluoro-1-butanesufonate), or a combination thereof. In embodiments, the uncured adhesive composition may comprise greater than or equal to 0.1 wt % and less than or equal to 10 wt % of the co-initiator. In embodiments, the uncured adhesive composition may comprise greater than or equal to 0.1 wt % and less than or equal to 5 wt % of the co-initiator. In embodiments, the concentration of the co-initiator in the uncured adhesive composition may be less than or equal to 10 wt %, less than or equal to 7 wt %, less than or equal to 5 wt %, less than or equal to 3 wt %, less than or equal to 2 wt %, less than or equal to 1.5 wt %, less than or equal to 1.3 wt %, less than or equal to 1.1 wt %, or even less than or equal to 1.0 wt %. In embodiments, the concentration of the co-initiator in the uncured adhesive composition may be greater than or equal to 0.1 wt % and less than or equal to 10 wt %, greater than or equal to 0.1 wt % and less than or equal to 7 wt %, greater than or equal to 0.1 wt % and less than or equal to 5 wt %, greater than or equal to 0.1 wt % and less than or equal to 3 wt %, greater than or equal to 0.1 wt % and less than or equal to 2 wt %, greater than or equal to 0.1 wt % and less than or equal to 1.5 wt %, greater than or equal to 0.1 wt % and less than or equal to 1 wt %, greater than or equal to 0.5 wt % and less than or equal to 10 wt %, greater than or equal to 0.5 wt % and less than or equal to 7 wt %, greater than or equal to 0.5 wt % and less than or equal to 5 wt %, greater than or equal to 0.5 wt % and less than or equal to 3 wt %, greater than or equal to 0.5 wt % and less than or equal to 2 wt %, greater than or equal to 0.5 wt % and less than or equal to 1.5 wt %, greater than or equal to 0.1 wt % and less than or equal to 1.0 wt %, greater than or equal to 0.7 wt % and less than or equal to 10 wt %, greater than or equal to 0.7 wt % and less than or equal to 7 wt %, greater than or equal to 0.7 wt % and less than or equal to 5 wt %, greater than or equal to 0.7 wt % and less than or equal to 3 wt %, greater than or equal to 0.7 wt % and less than or equal to 2 wt %, greater than or equal to 0.7 wt % and less than or equal to 1.5 wt %, greater than or equal to 0.7 wt % and less than or equal to 1.3 wt %, greater than or equal to 0.7 wt % and less than or equal to 1.1 wt %, greater than or equal to 0.7 wt % and less than or equal to 1.0 wt %, greater than or equal to 0.9 wt % and less than or equal to 1.1 wt %, or even greater than or equal to 0.9 wt % and less than or equal to 1.0 wt %, or any and all sub-ranges formed from any of these endpoints.

Similar to the co-initiators, the oxygen inhibitors, otherwise known as antioxidants or anti-oxygen inhibitor, included in the uncured adhesive compositions described herein are selected to promote polymerization, particularly radical polymerization, by decreasing the fixing and curing times of the uncured adhesive composition and may help to reduce shrinkage of the cured adhesive composition. While not wishing to be bound by theory, it is believed that oxygen dissolved in the uncured adhesive composition reacts with highly reactive radicals and transforms them into less reactive peroxyl radicals, thereby inhibiting and decreasing the rate of radical driven polymerization of monomers. An oxygen inhibitor not only reacts with oxygen in the uncured adhesive composition, but also reacts with the peroxyl radicals to increase their reactivity.

In embodiments, the oxygen inhibitor may comprise a reducing agent (e.g., phosphine and/or phosphite), a hydrogen donor (e.g., amine, thiol, silane, hydrogen phosphite, stannane, and/or aldehyde), vinyl amide, vinyl lactam (e.g., N-vinylpyrrolidone and N-vinyl-s-caprolactam), vinylcarbazole, a singlet oxygen scavenger (e.g., diphenyl furan and/or dibutyl anthracene), or a combination thereof. In embodiments, the oxygen inhibitor may comprise 4-(dimethylamino)phenyl diphenylphosphene, triphenylphosphine, triphenyl phosphite, or a combination thereof. In embodiments, the uncured adhesive composition may comprise greater than or equal to 0.1 wt % and less than or equal to 5 wt % of the oxygen inhibitor. In embodiments, the uncured adhesive composition may comprise greater than or equal to 0.1 wt % and less than or equal to 2 wt % of the oxygen inhibitor. In embodiments, the concentration of the oxygen inhibitor in the uncured adhesive composition may be less than or equal to 5 wt %, less than or equal to 4 wt %, less than or equal to 3 wt %, less than or equal to 2 wt %, less than or equal to 1.5 wt %, less than or equal to 1.3 wt %, less than or equal to 1.1 wt %, or even less than or equal to 1.0 wt %. In embodiments, the concentration of the oxygen inhibitor in the uncured adhesive composition may be greater than or equal to 0.1 wt % and less than or equal to 5 wt %, greater than or equal to 0.1 wt % and less than or equal to 4 wt %, greater than or equal to 0.1 wt % and less than or equal to 3 wt %, greater than or equal to 0.1 wt % and less than or equal to 2 wt %, greater than or equal to 0.1 wt % and less than or equal to 1.5 wt %, greater than or equal to 0.1 wt % and less than or equal to 1 wt %, greater than or equal to 0.5 wt % and less than or equal to 5 wt %, greater than or equal to 0.5 wt % and less than or equal to 4 wt %, greater than or equal to 0.5 wt % and less than or equal to 3 wt %, greater than or equal to 0.5 wt % and less than or equal to 2 wt %, greater than or equal to 0.5 wt % and less than or equal to 1.5 wt %, greater than or equal to 0.5 wt % and less than or equal to 1.0 wt %, greater than or equal to 0.7 wt % and less than or equal to 5 wt %, greater than or equal to 0.7 wt % and less than or equal to 4 wt %, greater than or equal to 0.7 wt % and less than or equal to 3 wt %, greater than or equal to 0.7 wt % and less than or equal to 2 wt %, greater than or equal to 0.7 wt % and less than or equal to 1.5 wt %, greater than or equal to 0.7 wt % and less than or equal to 1.3 wt %, greater than or equal to 0.7 wt % and less than or equal to 1.1 wt %, greater than or equal to 0.7 wt % and less than or equal to 1.0 wt %, greater than or equal to 0.9 wt % and less than or equal to 1.1 wt %, or even greater than or equal to 0.9 wt % and less than or equal to 1.0 wt %, or any and all sub-ranges formed from any of these endpoints.

In embodiments, the uncured adhesive composition may include a surfactant. The surfactant may comprise polysiloxane acrylate, polydimethylsiloxane acrylate, silicone polyether acrylate, perfluoropolyether, perfluorocarbon, or a combination thereof. In embodiments, the uncured adhesive composition may comprise greater than or equal to 0.01 wt % and less than or equal to 1 wt % surfactant. In embodiments, the concentration of the surfactant in the uncured adhesive composition may be less than or equal to 1 wt %, less than or equal to 0.7 wt %, or even less than or equal to 0.5 wt %. In embodiments, the concentration of surfactant in the uncured adhesive composition may be greater than or equal to 0.01 wt % and less than or equal to 1 wt %, greater than or equal to 0.01 wt % and less than or equal to 0.7 wt %, greater than or equal to 0.01 wt % and less than or equal to 0.5 wt %, greater than or equal to 0.01 wt % and less than or equal to 0.3 wt %, greater than or equal to 0.01 wt % and less than or equal to 0.1 wt %, greater than or equal to 0.1 wt % and less than or equal to 1 wt %, greater than or equal to 0.1 wt % and less than or equal to 0.7 wt %, greater than or equal to 0.1 wt % and less than or equal to 0.5 wt %, greater than or equal to 0.1 wt % and less than or equal to 0.3 wt %, greater than or equal to 0.3 wt % and less than or equal to 1 wt %, greater than or equal to 0.3 wt % and less than or equal to 0.7 wt %, greater than or equal to 0.3 wt % and less than or equal to 0.5 wt %, greater than or equal to 0.5 wt % and less than or equal to 1 wt %, greater than or equal to 0.5 wt % and less than or equal to 0.7 wt %, or even greater than or equal to 0.7 wt % and less than or equal to 1 wt %, or any and all sub-ranges formed from any of these endpoints.

The viscosity of the uncured adhesive composition described herein ensures fast wetting and spreading between a glass-based substrate and a mounting surface of a device to which the screen protector will be adhered. If the viscosity is too high, insufficient spreading or wetting of the uncured adhesive composition may result. Additionally, if the viscosity of the uncured adhesive composition is not low enough, bubbles may be trapped within the cured adhesive composition. In embodiments, the uncured adhesive compositions described herein may have a viscosity less than or equal to 500 cps, less than or equal to 450 cps, less than or equal to 400 cps, less than or equal to 350 cps, less than or equal to 300 cps, less than or equal to 250 cps, less than or equal to 200 cps, less than or equal to 150 cps, less than or equal to 100 cps, less than or equal to 50 cps, less than or equal to 20 cps, or even less than or equal to 10 cps. The viscosities reported herein were obtained from the data sheet of the materials and are measured at 20° C., unless otherwise indicated.

The uncured adhesive compositions may be cured in a time period that allows for the convenient application of a screen protector. A fixed adhesive composition does not allow a screen protector to which it is adhered to be moved relative to the mounting surface by a user and does not seep or leak from the edges of the screen protector. The cured adhesive composition allows any sensors positioned such that they operate through the cured adhesive composition, such as a fingerprint sensor located within or below a display, to operate normally.

Light sources with different spectra and intensities may result in different fix and cure times even when the same visible-light photoinitiator is employed. In embodiments, immediately after irradiation with the visible light source, the adhesive composition may be fixed. In embodiments, immediately after irradiation with the visible light source, the adhesive composition may be cured. In embodiments, irradiation of the uncured adhesive composition with a visible light source extends for a period greater than or equal to 10 seconds and less than or equal to 10 minutes, greater than or equal to 30 seconds and less than or equal to 10 minutes, greater than or equal to 1 minute and less than or equal to 10 minutes, greater than or equal to 2 minutes and less than or equal to 10 minutes, greater than or equal to 10 seconds and less than or equal to 7 minutes, greater than or equal to 30 seconds and less than or equal to 7 minutes, greater than or equal to 1 minute and less than or equal to 7 minutes, greater than or equal to 2 minutes and less than or equal to 7 minutes, greater than or equal to 10 seconds and less than or equal to 5 minutes, greater than or equal to 30 s and less than or equal to 5 minutes, greater than or equal to 1 minute and less than or equal to 5 minutes, or even greater than or equal to 2 minutes and less than or equal to 5 minutes, or any and all sub-ranges formed between any these endpoints.

The uncured adhesive composition may form a polymer upon curing. In embodiments, the polymer formed when the uncured adhesive composition is cured may be a polymer generated by radical polymerization. In embodiments, the polymer formed when the uncured adhesive composition is cured may be a polyacrylate, such as poly(isobornyl acrylate).

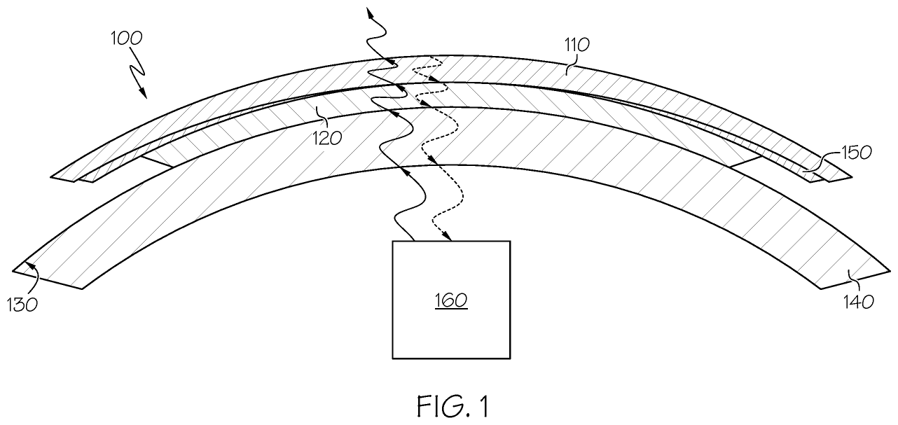

Referring now to FIG. 1, a screen protector system that utilizes the cured adhesive composition described herein is shown at 100. The screen protector system 100 includes a glass-based substrate 110 and a cured adhesive composition 120. The screen protector system 100 is adhered to a mounting surface 130 of a cover glass 140 of an electronic device.

The glass-based substrate 110 may have a shape that reflects the shape of the cover glass 140 of the electronic device to which it will be applied. Stated differently, the shape of the glass-based substrate 110 may reflect the shape of the mounting surface 130 of the cover glass 140. In embodiments, the glass-based substrate 110 may have a 2-dimensional (2D), a 2.5-dimensional (2.5D), or a 3-dimensional (3D) shape. As utilized herein, a 2D shape refers to a glass-based substrate where both major surfaces are flat (planar). As utilized herein, a 2.5D shape refers to a glass-based substrate where one major surface is flat (planar) and one major surface is curved. As utilized herein, a 3D shape refers to a glass-based substrate where both major surfaces are curved. By way of example, a 3D glass-based substrate may be appropriately employed when the mounting surface to which it will be adhered and which it will protect is curved.

The glass-based substrate 110 may comprise a length and a width. In embodiments, the length of the glass-based substrate 110 may be greater than or equal to 10 millimeters (mm), greater than or equal to 30 mm, greater than or equal to 50 mm, greater than or equal to 100 mm, greater than or equal to 130 mm, greater than or equal to 150 mm, greater than or equal to 160 mm, greater than or equal to 200 mm. In embodiments, the length of the glass-based substrate 110 may be less than or equal to 500 mm, less than or equal to 300 mm, or less than or equal to 200 mm. In embodiments, the length of the glass-based substrate 110 may be greater than or equal to 10 mm and less than or equal to 500 mm, greater than or equal to 10 mm and less than or equal to 300 mm, greater than or equal to 10 mm and less than or equal to 200 mm, greater than or equal to 10 mm and less than or equal to 200 mm, greater than or equal to 30 mm and less than or equal to 500 mm, greater than or equal to 30 mm and less than or equal to 300 mm, greater than or equal to 30 mm and less than or equal to 200 mm, greater than or equal to 50 mm and less than or equal to 500 mm, greater than or equal to 50 mm and less than or equal to 300 mm, greater than or equal to 50 mm and less than or equal to 200 mm, greater than or equal to 100 mm and less than or equal to 500 mm, greater than or equal to 100 mm and less than or equal to 300 mm, greater than or equal to 100 mm and less than or equal to 200 mm, greater than or equal to 120 mm and less than or equal to 200 mm, greater than or equal to 130 mm and less than or equal to 200 mm, greater than or equal to 50 mm and less than or equal to 160 mm, or even greater than or equal to 50 mm and less than or equal to 150 mm, or any and all subranges formed between these endpoints. In embodiments, the width of the glass-based substrate 110 may be about the same, greater than, or less than the length of the glass-based substrate 110. In embodiments, the width of the glass-based substrate 110 may comprise the ranges presented above for the length of the glass-based substrate 110. In embodiments, the length and width of the glass-based substrate 110 may be the same as the corresponding dimensions of a device or portion of the device (e.g., screen of the device) that the glass-based substrate 110 has been designed to protect. In embodiments, the length and width of the glass-based substrate 110 may be proportional to the corresponding dimensions of the device or portion of the device (e.g., screen of the device) that the glass-based substrate 110 has been designed to protect. In embodiments, the length and/or width of the glass-based substrate 110 may be less than or greater than the corresponding dimensions of the device or portion of the device (e.g., screen of the device) that the glass-based substrate 110 has been designed to protect.

In embodiments, the glass-based substrate 110 may include an anti-splinter layer 150. The anti-splinter layer 150 prevents shattering of the glass-based substrate 110 once the glass-based substrate is broken. The anti-splinter layer 150 may cover all or a portion of the glass-based substrate 110. In embodiments, the anti-splinter layer 150 is provided at the periphery of the glass-based substrate 110 and serves to provide a pleasing aesthetic appearance or decoration to the screen protector system 100, and holds the shattered glass if the screen protector is broken. The anti-splinter layer 150 may be opaque or translucent. Decoration may be added to the anti-splinter layer 150 by any appropriate process, such as screen printing or other printing method.

The consumer electronic device may include an ultrasonic sensor 160 located below the cover glass 140 that is configured to operate through the cover glass 140. In FIG. 1, the solid wavy lines represent the acoustic waves emitted by the ultrasonic sensor 160 and the dashed wavy lines represent the reflected acoustic waves from each interface encountered by the emitted acoustic waves. In embodiments, the display of the consumer electronic device may be disposed between the ultrasonic sensor 160 and the cover glass 140, such that the emitted acoustic waves pass through the display and the ultrasonic sensor appears to be located within the display.

The ultrasonic sensor 160 may be a fingerprint sensor (FPS). The FPS may recognize a fingerprint pattern of a user's finger by the difference in ultrasonic power returning to the sensor detector due to the difference in the ultrasonic impedances of finger ridges and valleys (the impedances of skin and air). For the FPS to be compatible with the screen protector, the sensor must have enough power to transmit an acoustic wave through the screen protector and have a reflected acoustic wave return to the sensor detector within a specific time of flight. The acoustic wave produced by the ultrasonic sensor 160 may be a matrix of longitudinal plane waves. It should be understood that where the performance of a FPS is described herein, the principles allowing for the FPS compatibility are also applicable to compatibility with other ultrasonic sensors.

The ultrasonic sensor 160 of the electronic device may be characterized by its operating frequency. In embodiments, the ultrasonic sensor 160 may have an operating frequency greater than or equal to 1 MHz and less than or equal to 50 MHz, greater than or equal to 1 MHz and less than or equal to 40 MHz, greater than or equal to 1 MHz and less than or equal to 30 MHz, greater than or equal to 1 MHz and less than or equal to 20 MHz, greater than or equal to 1 MHz and less than or equal to 15 MHz, greater than or equal to 5 MHz and less than or equal to 50 MHz, greater than or equal to 5 MHz and less than or equal to 40 MHz, greater than or equal to 5 MHz and less than or equal to 30 MHz, greater than or equal to 5 MHz and less than or equal to 20 MHz, greater than or equal to 5 MHz and less than or equal to 15 MHz, greater than or equal to 10 MHz and less than or equal to 50 MHz, greater than or equal to 10 MHz and less than or equal to 40 MHz, greater than or equal to 10 MHz and less than or equal to 30 MHz, greater than or equal to 10 MHz and less than or equal to 20 MHz, or even greater than or equal to 10 MHz and less than or equal to 15 MHz, or any and all sub-ranges formed from any of these endpoints. In embodiments, the ultrasonic sensor 160 may have an operating frequency of 12 MHz. In embodiments, the ultrasonic sensor 160 may have an operating frequency of 10 MHz.

The design parameters of the screen protector system 100 including the glass-based substrate 110 and cured adhesive composition 120 may be selected such that the cured adhesive composition 120 is compatible with the functionality of an ultrasonic sensor 160 of the electronic device to which the screen protector system 100 is adhered. For example, the thickness of the glass-based substrate 110 and cured adhesive composition 120 may be selected to maximize the response of the ultrasonic sensor 160 while also providing a tolerance for a large variety of cured adhesive composition 120 thicknesses. The cured adhesive composition 120 thickness may be as thin as possible to provide the desired ultrasonic sensor 160 performance. The ability of the screen protector to provide adequate adhesion and a bubble-free appearance requires at least a minimum thickness of the cured adhesive composition 120. Thin adhesive layers may allow the ultrasonic sensor 160 to operate properly even when the glass-based substrate 110 thickness is outside of the preferred range. The rheology of the adhesive composition 120 is also important to the functionality of the ultrasonic FPS.

In embodiments, the glass-based substrate 110 may have a thickness greater than or equal to 200 μm and less than or equal to 250 μm±30 μm. This glass-based substrate thickness is in coincidence with the half wavelength of a 12 MHz ultrasonic wave in the glass-based substrate, resulting in resonance and enhancing the transmitted power of the wave. In general, the velocity of a longitudinal ultrasonic wave in glass (v_{g}) can be expressed as a function of Young's modulus (E), density (ρ), and Poisson's ratio (v), as shown by the below equation.

$${v}_{g} = \sqrt{\frac{E ( 1 - v )}{ρ ( 1 + v ) ( 1 - 2 v )}}$$

The wavelength of the ultrasonic wave (λ_{g}) in glass can be calculated by the below equation, where f is the operation frequency of the ultrasonic sensor.

$${λ}_{g} = \frac{{v}_{g}}{f}$$

The half wavelength (λ_{g}/2) of a 12 MHz ultrasonic wave in commercially available alkali aluminosilicate glasses may be about 200-270 μm, indicating that a glass-based substrate thickness in this range may provide desirable resonance and performance. Similarly, thicknesses of the glass-based substrate in accordance with multiples of the half wavelength (λ_{g}/2) will also provide resonance and improved performance. The glass-based substrate thicknesses that provide resonance, and are thus preferred, are described by mλ_{g}/2±mλ_{g}/10, where m is an integer greater than or equal to 1, such as 1, 2, 3, 4, or more. It is expected that thicker glass-based substrates may cause a lag (delay) in the ultrasonic wave reflected back to the sensor's detector that is longer than the designed time of flight of the projected detector circuit. The time of flight may be compensated by electronic adjustment of the ultrasonic sensor, but it may be desirable for that reason to keep the thickness of the glass small. Additionally, a thick glass may increase the noise when the emission direction of the ultrasonic wave has small deviation from normal (90°) to the display cover. Therefore the order m of the glass resonance is as small a number as possible, with m=1 being a preferred condition.

In embodiments, the glass-based substrate 110 may have a thickness greater than or equal to 100 μm and less than or equal to 500 μm, greater than or equal to 150 μm and less than or equal to 400 μm, greater than or equal to 175 μm and less than or equal to 300 μm, greater than or equal to 200 μm and less than or equal to 275 μm, greater than or equal to 210 μm and less than or equal to 260 μm, or even greater than or equal to 225 μm and less than or equal to 250 μm, or any and all sub-ranges formed from any of these endpoints.

The thickness of the glass-based substrate may also be characterized as a function of the operating frequency f of the ultrasonic sensor and the velocity of propagation of the ultrasonic wave V_{S} in the glass-based substrate at the operating frequency. In embodiments, the thickness of the glass-based substrate may be defined as mV_{S}/2f±mV_{S}/10f, where m is an integer greater than or equal to 1, such as 1 or 2.

For a given glass-based substrate thickness, a thinner cured adhesive composition will provide improved ultrasonic sensor functionality, as influence of the cured adhesive composition on the performance of the ultrasonic sensor may be primarily damping controlled. Consequently, the selection of the damping properties of the cured adhesive composition is important to ensure the desired functionality of the ultrasonic sensor.

Damping of a cured adhesive composition may be characterized by dynamic mechanical analysis (DMA) in either tensile and shear modes. There is a correlation between tensile (E) and shear (G) moduli by Poisson's ratio (v), as shown by the below equation:

$$G = \frac{E}{2 ( 1 + v )}$$

Both the tensile and shear moduli are complex parameters, with a real part (storage modulus, E′ and G′) and an imaginary part (loss modulus, E″ and G″). Assuming the Poisson's ratio is a constant, the damping, as characterized by the loss tangent (tan(δ)) of the cured adhesive composition, may be calculated by either shear or tensile mode, as expressed in the equation below:

$$tan δ = \frac{{E}^{″}}{{E}^{′}} = \frac{{G}^{″}}{{G}^{′}}$$

In the case of weakly compressible polymers, such as acrylic rubbers, the Poisson's ratio is about 0.5, leading to G=E/3. Since the ultrasonic waves described herein are assumed to be longitudinal, the tensile moduli play more important roles than shear moduli in the damping behavior of the cured adhesive compositions. As a result, the tensile moduli of the cured adhesive compositions are generally discussed herein.

The storage modulus (F′), loss modulus (E″), and loss tangent (tan(δ)) recited herein are reported at a reference temperature of 20° C. (room temperature), unless otherwise indicated. Cured adhesive compositions that provide improved ultrasonic sensor performance typically have a higher E′, a higher E″, and a lower tan(δ). The rheology of the cured adhesive composition is also a function of the frequency, and for that reason the rheology is generally considered at the operating frequency of the ultrasonic sensor with which it will be utilized.

The reflection coefficient (R) of an ultrasonic wave at the interface of the cured adhesive composition and glass-based substrate is a function of the acoustic impedance difference (Z_{g}−Zₚ) between the acoustic impedance of the glass-based substrate Z_{g} and the acoustic impedance of the cured adhesive composition Zₚ, as expressed by the equation below.

$$R = {( \frac{{Z}_{g} - {Z}_{p}}{{Z}_{g} + {Z}_{p}} )}^{2}$$

The ultrasonic transmission of the screen protectors described herein may be calculated. The computational calculation of the transmission is based on the theoretical equations of acoustic wave transmission in a stack of layered materials, which is equivalent to an electrical circuit using electrical waves. The equivalency of acoustic waves and electrical circuits may be rationalized by the fact that both originate from sinusoidal waves interacting with each other and have similar boundary conditions. Once the equation is derived, it may be used to solve either electrical or acoustic problems. The only modification required is the substitution by their equivalent components either in the electrical or acoustic domain.

In performing the ultrasonic transmission calculations, it is assumed that the ultrasonic sensor is located under the cover glass and display of the consumer electronic device, with an equivalent acoustic impedance matching with the acoustic impedance of a finger skin (finger ridges and valleys) on the surface of the cover of the device to maximize the transmission of ultrasonic waves without the use of any screen protectors. Therefore, in the optimal scenario with a glass-based screen protector, the equivalent acoustic impedance at the interface of the glass-based substrate and cured adhesive composition should also match with, or be as close as possible to, the acoustic impedance of the human finger. The equivalent acoustic impedance Z(L) at the interface of glass-based substrate and cured adhesive composition can be computed by the equation below, where Zₒ is the characteristic acoustic impedance of the glass-based substrate. Z_{L} is the acoustic impedance of finger skin or air, corresponding to locations of fingerprint ridges and valleys.

$$Z ( L ) = {Z}_{o} \frac{[ {Z}_{L} cosh ( γ L ) + {Z}_{o} sinh ( γ L ) ]}{[ {Z}_{o} cosh ( γ L ) + {Z}_{L} sinh ( γ L ) ]}$$

L is the thickness of the glass-based substrate,

$$sinh ( x ) = \frac{{e}^{- x} + {e}^{+ x}}{2} , cosh ( x ) = \frac{{e}^{- x} - {e}^{+ x}}{2} ,$$

and γ is a complex propagation constant given by

$$γ = α + \frac{2 π f}{{v}_{p}} i .$$

In this case, α is the attenuation factor correlated with damping, and i is the imaginary unit. Similarly, the equivalent acoustic impedance at the interface of the cured adhesive composition and the cover glass may also be computed by successively applying the same equation above. Here, Zₒ is the characteristic acoustic impedance polymer adhesive, and Z_{L} is equivalent acoustic impedance at the interface of glass-based substrate and polymer adhesive. In the ideal case the equivalent impedance Z(L) at the interface of display cover and polymer adhesive should match with the acoustic impedance of the finger skin.

In liquid and solid materials that are isotropic, the acoustic longitudinal waves have a velocity as described above, and an acoustic impedance Z given by the below equation:

Z=\sqrt{Eρ}

where ρ is the density of the material in the absence of acoustic waves (as the wave affects the local density of the material). E is the Young's modulus of the material.

Typical values of these parameters of the finger and glass can be found in the literature. The attenuation coefficient α (db/m) can be converted to α (Neper/m) by dividing it by 8.686 to be used in the computation of the complex propagation constant γ. The attenuation of the polymer (αₚ) is correlated with the loss tangent tan(δ), frequency (f, in kHz), and the speed of an ultrasonic wave in the medium (vₚ):

$${α}_{P} = {k}_{P} f = \frac{tan δ f}{1.83 \times 1 {0}^{- 5} {v}_{P}}$$

In addition to the equivalent acoustic impedance at the interface, the power of the ultrasonic wave transmitting through the screen protector and reflecting back to the detector was also calculated. With the calculated equivalent acoustic impedance on the cover glass/cured adhesive composition interface, the power (P) returning back to the detector can simplified to only one reflection on the cover glass/cured adhesive composition interface, which is expressed as the equation below with the assumption that the initial power (P₀) under the cover glass/cured adhesive composition interface is 1.

$$P = {P}_{0} {\vert \frac{{Z}_{cg} - {Z}_{eq}}{{Z}_{cg} + {Z}_{eq}} \vert}^{2} = {\vert \frac{{Z}_{cg} - {Z}_{eq}}{{Z}_{cg} + {Z}_{eq}} \vert}^{2}$$

Z_{cg} is the acoustic impedance of the cover glass. Z_{eq} is the computed complex equivalent acoustic impedance on the cover glass/cured adhesive composition interface.

To identify a fingerprint, the ultrasonic FPS detects the power difference of the ultrasonic wave reflected from the interface in contact with skin (fingerprint ridges) and air (fingerprint valleys). Therefore, the signal of the ultrasonic FPS, ΔP, is expressed in the equation below as the difference in the ultrasonic power received by the sensor detector.

$$Δ P = {P}_{0} {\vert \frac{{Z}_{cg} - {Z}_{eq , a}}{{Z}_{cg} + {Z}_{eq , a}} \vert}^{2} - {P}_{0} {\vert \frac{{Z}_{cg} - {Z}_{eq , f}}{{Z}_{cg} + {Z}_{eq , f}} \vert}^{2} = {\vert \frac{{Z}_{cg} - {Z}_{eq , a}}{{Z}_{cg} + {Z}_{eq , a}} \vert}^{2} - {\vert \frac{{Z}_{cg} - {Z}_{eq , f}}{{Z}_{cg} + {Z}_{eq , f}} \vert}^{2}$$

Z_{eg,f} is the calculated complex equivalent acoustic impedance on the cover glass/cured adhesive composition interface with skin as the semi-infinite exterior medium (fingerprint ridges). Z_{eg,a} is the calculated complex equivalent acoustic impedance on the cover glass/cured adhesive composition interface with air as the semi-infinite exterior medium (fingerprint valleys).

In embodiments, the difference in power ΔP received by the sensor detector is greater than or equal to 0.4 times the initial power P₀. A difference in power in this range indicates the compatibility of the ultrasonic sensor with the screen protector.

In embodiments, the glass-based substrate 110 may be strengthened, creating a strengthened glass-based substrate. Methods of creating a strengthened glass-based substrate comprise chemical strengthening, thermal strengthening, or a combination of chemical strengthening and thermal strengthening. In embodiments, the glass-based substrate may not be strengthened (unstrengthened).

The strengthened glass-based substrate may be characterized by a surface compressive stress (CS), which may be defined as the maximum surface compressive stress inside the strengthened glass-based substrate as measured using a scattered light polarizing scope (SCALP) technique or a film stress measurement (FSM) technique known in the art. In embodiments, the strengthened glass-based substrate may have a CS greater than or equal to 150 MegaPascals (MPa), greater than or equal to 300 MPa, greater than or equal to 400 MPa, greater than or equal to 500 MPa, or even greater than or equal to 600 MPa. In embodiments, the strengthened glass-based substrate may have a CS less than or equal to 1000 MPa, less than or equal to 900 MPa, or even less than or equal to 800 MPa. In embodiments, the strengthened glass-based substrate may have a CS greater than or equal to 150 MPa and less than or equal to 1000 MPa, greater than or equal to 150 MPa and less than or equal to 900 MPa, greater than or equal to 150 MPa and less than or equal to 800 MPa, greater than or equal to 300 MPa and less than or equal to 1000 MPa, greater than or equal to 300 MPa and less than or equal to 900 MPa, greater than or equal to 300 MPa and less than or equal to 800 MPa, greater than or equal to 400 MPa and less than or equal to 1000 MPa, greater than or equal to 400 MPa and less than or equal to 900 MPa, greater than or equal to 400 MPa and less than or equal to 800 MPa, greater than or equal to 500 MPa and less than or equal to 1000 MPa, greater than or equal to 500 MPa and less than or equal to 900 MPa, greater than or equal to 500 MPa and less than or equal to 800 MPa, greater than or equal to 600 MPa and less than or equal to 1000 MPa, greater than or equal to 600 MPa and less than or equal to 900 MPa, or even greater than or equal to 600 MPa and less than or equal to 800 MPa, or any and all subranges formed from any of these endpoints.

The strengthened glass-based substrate may be characterized by a central tension (CT), which may be defined as the tension at the half thickness of the glass-based substrate as measured using a scattered light polarizing scope (SCALP) technique or a film stress measurement (FSM) technique known in the art. In embodiments, the strengthened glass-based substrate may have a CT greater than or equal to 1 MPa, greater than or equal to 5 MPa, greater than or equal to 10 MPa, greater than or equal to 15 MPa, greater than or equal to 20 MPa, or even greater than or equal to 25 MPa. In embodiments, the strengthened glass-based substrate may have a CT less than or equal to 120 MPa, less than or equal to 100 MPa, less than or equal to 90 MPa, or even less than or equal to 80 MPa. In embodiments, the strengthened glass-based substrate may have a CT greater than or equal to 1 MPa and less than or equal to 120 MPa, greater than or equal to 1 MPa and less than or equal to 100 MPa, greater than or equal to 1 MPa and less than or equal to 90 MPa, greater than or equal to 1 MPa and less than or equal to 80 MPa, greater than or equal to 5 MPa and less than or equal to 120 MPa, greater than or equal to 5 MPa and less than or equal to 100 MPa, greater than or equal to 5 MPa and less than or equal to 90 MPa, greater than or equal to 5 MPa and less than or equal to 80 MPa, greater than or equal to 10 MPa and less than or equal to 120 MPa, greater than or equal to 10 MPa and less than or equal to 100 MPa, greater than or equal to 10 MPa and less than or equal to 90 MPa, greater than or equal to 10 MPa and less than or equal to 80 MPa, greater than or equal to 15 MPa and less than or equal to 120 MPa, greater than or equal to 15 MPa and less than or equal to 100 MPa, greater than or equal to 15 MPa and less than or equal to 90 MPa, greater than or equal to 15 MPa and less than or equal to 80 MPa, greater than or equal to 20 MPa and less than or equal to 120 MPa, greater than or equal to 20 MPa and less than or equal to 100 MPa, greater than or equal to 20 MPa and less than or equal to 90 MPa, greater than or equal to 20 MPa and less than or equal to 80 MPa, greater than or equal to 25 MPa and less than or equal to 120 MPa, greater than or equal to 25 MPa and less than or equal to 100 MPa, greater than or equal to 25 MPa and less than or equal to 90 MPa, or even greater than or equal to 25 MPa and less than or equal to 80 MPa, or any and all subranges formed from any of these endpoints.

The strengthened glass-based substrate may be characterized by a depth of compression (DOC), which may be defined as the depth from the surface to which a surface compressive stress region extends. Stated differently the DOC is the depth where the stress transitions from compressive to tensile. The DOC of the glass-based substrate is measured using a scattered light polariscope (SCALP) technique or a film stress measurement (FSM) technique known in the art. In embodiments, the strengthened glass-based substrate has a DOC greater than or equal to 3 μm, greater than or equal to 5 μm, or even greater than or equal to 10 μm. In embodiments, the strengthened glass-based substrate has a DOC less than or equal to 50 μm, less than or equal to 25 μm, or even less than or equal to 15 μm. In embodiments, the strengthened glass-based substrate has a DOC greater than or equal to 3 μm and less than or equal to 50 μm, greater than or equal to 3 μm and less than or equal to 25 μm, greater than or equal to 3 μm and less than or equal to 15 μm, greater than or equal to 5 μm and less than or equal to 50 μm, greater than or equal to 5 μm and less than or equal to 25 μm, greater than or equal to 5 μm and less than or equal to 15 μm, greater than or equal to 10 μm and less than or equal to 50 μm, greater than or equal to 10 μm and less than or equal to 25 μm, or even greater than or equal to 10 μm and less than or equal to 15 μm, or any and all sub-ranges formed from any of these endpoints.

Chemical strengthening comprises contacting a glass-based substrate, which may or may not already be thermally strengthened, with an ion exchange medium to exchange ions in the glass-based substrate with those in the ion exchange medium. This process may be referred to as “ion exchange” because ions at or near the surface of the glass-based substrate are replaced by (i.e., exchanged with) ions of the ion exchange medium. In embodiments, the ions exchanged out of the glass-based substrate may be monovalent alkali metal cations, for example Li⁺, Na⁺, K⁺, Rb⁺, and Cs⁺. In embodiments, the ions exchanged into the glass-based substrate may be alkali metal cations or other metal cations, for example Ag⁺ and Cu²⁺. In embodiments, the ion exchange medium may include any one or more of KNO₃, NaNO₃, LiNO₃, and AgNO₃. The ion exchange medium may be sprayed onto the surface of the glass-based substrate or the glass-based substrate may be submerged in an ion exchange bath, such as a molten salt bath. The molten salt bath or ionic salt solution may be at a temperature greater than or equal to 300° C., greater than or equal to 350° C., or even greater than or equal to 400° C. The molten salt bath may be at a temperature greater than or equal to 300° C. and less than or equal to 500° C., greater than or equal to 350° C. and less than or equal to 450° C., greater than or equal to 380° C. and less than or equal to 430° C., or even greater than or equal to 400° C. and less than or equal to 420° C., or any and all subranges formed from any of these endpoints. In embodiments, the ion exchange may extend for a period greater than or equal to 10 minutes, greater than or equal to 30 minutes, or greater than or equal to 1 hour. In embodiments, the ion exchange may extend for a period greater than or equal to 10 minutes and less than or equal to 48 hours, greater than or equal to 30 minutes and less than or equal to 24 hours, greater than or equal to 1 hour and less than or equal to 16 hours, greater than or equal to 2 hours and less than or equal to 12 hours, or even greater than or equal to 3 hours and less than or equal to 8 hours, or any and all subranges formed from any of these endpoints.

In embodiments, the Young's modulus (E) of the glass-based substrate may be greater than or equal to 40 GPa and less than or equal to 120 GPa, greater than or equal to 40 GPa and less than or equal to 100 GPa, greater than or equal to 40 GPa and less than or equal to 80 GPa, greater than or equal to 50 GPa and less than or equal to 120 GPa, greater than or equal to 50 GPa and less than or equal to 100 GPa, greater than or equal to 50 GPa and less than or equal to 80 GPa, greater than or equal to 60 GPa and less than or equal to 120 GPa, greater than or equal to 60 GPa and less than or equal to 100 GPa, or even greater than or equal to 60 GPa and less than or equal to 80 GPa, or any and all sub-ranges between these endpoints.

In embodiments, the glass-based substrates may have a Poisson's ratio (v) greater than or equal to 0.15 and less than or equal to 0.30, greater than or equal to 0.16 and less than or equal to 0.29, greater than or equal to 0.17 and less than or equal to 0.28, greater than or equal to 0.18 and less than or equal to 0.27, greater than or equal to 0.19 and less than or equal to 0.26, greater than or equal to 0.20 and less than or equal to 0.25, greater than or equal to 0.21 and less than or equal to 0.25, or even greater than or equal to 0.22 and less than or equal to 0.24, or any and all sub-ranges between these endpoints.

For the sake of simplicity, the cured adhesive composition 120 is generally referred to herein as a single layer. In embodiments, the cured adhesive composition 120 may include a plurality of layers, such as greater than or equal to 2 and less than or equal to 5 layers. The layers of the cured adhesive composition 120 may have different compositions and properties.

In embodiments, the cured adhesive composition 120 may have a thickness less than or equal to 500 μm, less than or equal to 450 μm, less than or equal to 400 μm, less than or equal to 350 μm, less than or equal to 300 μm, less than or equal to 250 μm, less than or equal to 200 μm, less than or equal to 150 μm, or even less than or equal to 125 μm. The cured adhesive composition 120 may have a higher thickness while still enabling the desired ultrasonic performance if the glass-based substrate 110 has a thickness that is approximately a multiple of the half wavelength of a wave in the glass-based substrate 110 at the operating frequency of the ultrasonic sensor 160, as described above.

The damping of the cured adhesive composition 120 may be characterized by the loss tangent tan(δ). In embodiments, the cured adhesive composition 120 may have a tan(δ) less than 1.0, less than or equal to 0.9, less than or equal to 0.8, less than or equal to 0.7, less than or equal to 0.6, less than or equal to 0.5, less than or equal to 0.4, less than or equal to 0.3, less than or equal to 0.2, or even less than or equal to 0.1 as measured at room temperature (20° C.) and the operating frequency of the ultrasonic sensor 160. In general, a lower tan(δ) value indicates improved compatibility with an ultrasonic sensor 160.

The cured adhesive composition 120 may be characterized by an acoustic attenuation coefficient. In embodiments, the cured adhesive composition 120 may have an acoustic attenuation coefficient α less than 100000 db/m, less than 90000 db/m, less than 80000 db/m, less than 70000 db/m, less than 60000 db/m, less than 50000 db/m, less than 40000 db/m, less than 30000 db/m, or even less than 26000 db/m as measured at 20° C. and the operating frequency of the ultrasonic sensor 160.

The cured adhesive composition 120 may be characterized by the tensile storage modulus. In embodiments, the cured adhesive composition 120 may have a tensile storage modulus E′ greater than or equal to 10 MPa, greater than or equal to 50 MPa, greater than or equal to 100 MPa, greater than or equal to 150 MPa, greater than or equal to 200 MPa, greater than or equal to 250 MPa, greater than or equal to 300 Pa, greater than or equal to 350 Pa, greater than or equal to 400 MPa, greater than or equal to 450 MPa, greater than or equal to 500 MPa, greater than or equal to 550 MPa, greater than or equal to 600 MPa, greater than or equal to 650 MPa, greater than or equal to 700 MPa, greater than or equal to 750 MPa, greater than or equal to 800 MPa, greater than or equal to 850 MPa, greater than or equal to 900 MPa, greater than or equal to 950 MPa, or even greater than or equal to 1000 MPa as measured at room temperature (20° C.) and at the operating frequency of the ultrasonic sensor 160. In general, a cured adhesive composition with a higher E′ value at the operating frequency of the ultrasonic sensor 160 has a higher degree of compatibility with the ultrasonic sensor 160.

The cured adhesive composition 120 may be characterized by the tensile loss modulus. In embodiments, the cured adhesive composition 120 may have a tensile loss modulus E″ less than or equal to 10⁹ MPa, less than or equal to 10^{8.5} MPa, less than or equal to 10⁸ MPa, or even less than or equal to 10^{7.5} MPa at room temperature (20° C.) and the operating frequency of the ultrasonic sensor 160.

The cured adhesive composition may have optical properties that do not degrade the optical performance of the device to which the screen protector is applied. In embodiments, the cured adhesive composition may have a transmission greater than or equal to 70%, greater than or equal to 75%, greater than or equal to 80%, greater than or equal to 85%, or even greater than or equal to 90% as measured at a thickness of 0.2 mm. In embodiments, the cured adhesive composition has a transmission haze less than or equal to 20%, less than or equal to 15%, less than or equal to 10%, less than or equal to 5%, or even less than or equal to 2% as measured at a thickness of 0.2 mm. In embodiments, the cured adhesive composition has a clarity greater than or equal to 80%, such as greater than or equal to 85%, greater than or equal to 90%, or even greater than or equal to 95% as measured at a thickness of 0.2 mm. In embodiments, the cured adhesive composition is optically clear such that the cured adhesive composition has a visible light transmission greater than 70%, a transmission haze less than 20%, and a clarity greater than 80% as measured at a thickness of 0.2 mm.

The cured adhesive composition after photobleaching may have optical properties that do not degrade the optical performance of the device to which the screen protector is applied. The cured adhesive composition in its as-applied state may not have these optical properties. The cured adhesive composition state after photobleaching may be defined by irradiating with a visible light source (e.g. 5000 K LED light) of illumination >1000 lux for more than 10 min, more than 30 min, more than 4 h, more than 24 h, or more. In its cured state after photobleaching, the cured adhesive composition has a transmission of greater than or equal to 85%, greater than or equal to 90%, greater than or equal to 95%, or more; the cured adhesive composition has a haze of less than or equal to 10%, less than or equal to 5%, less than or equal to 2%, or less; the cured adhesive composition has a clarity of greater than or equal to 90%, greater than or equal to 95%, greater than or equal to 98%, or more.

The optical properties of the cured adhesive composition may be characterized with reference to a specific curing treatment. In embodiments, the cured adhesive composition obtained after irradiating an uncured adhesive composition with a visible light source for a period of 24 hours may have a transmission greater than or equal to 70%, greater than or equal to 75%, greater than or equal to 80%, greater than or equal to 85%, or even greater than or equal to 90%.

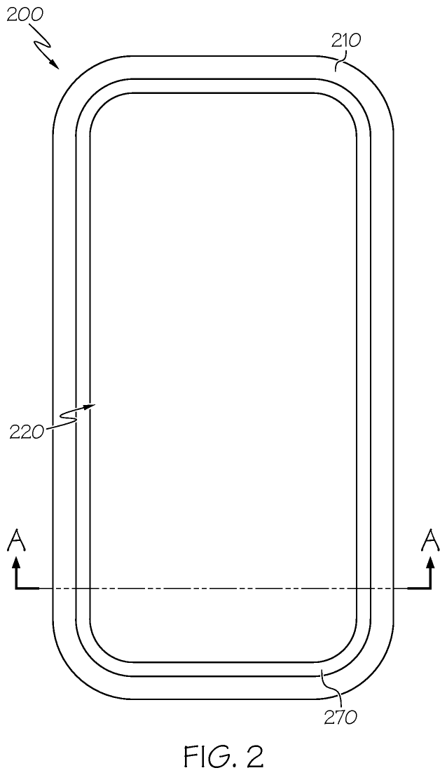

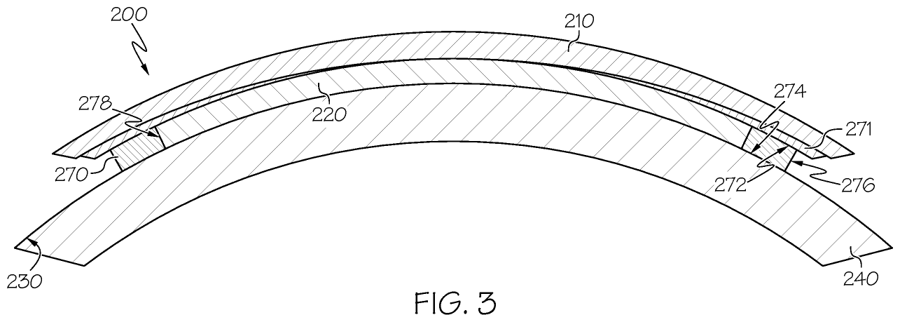

Referring now to FIGS. 2 and 3, another exemplary screen protector 200 includes a glass-based substrate 210 having an adhesive belt 270 and a cured adhesive composition 220. The adhesive belt 270 is adapted to control the thickness and to contain the uncured adhesive composition used to form the cured adhesive composition 220 during the application and curing process. Systems that utilize an uncured adhesive composition application may be difficult. For example, the uncured adhesive composition may leak from the perimeter of the screen protector making a mess or contaminating portions of the electronic device that were not intended to contact the uncured adhesive composition. Additionally, the thickness of the uncured adhesive composition is difficult to control.

The adhesive belt 270 allows the glass-based substrate 210 to be adhered to a mounting surface 230 of the cover glass 240 of the electronic device before the cured adhesive composition 220 is cured. The adhesive belt 270 contains the uncured adhesive composition in the desired area of the screen protector 200, preventing leakage and/or the contamination of unintended portions of the electronic device with the uncured adhesive composition. The adhesive belt 270 also controls the thickness of the cured adhesive composition 220, as the thickness of the adhesive belt 270 is selected to produce a desired separation between the lower surface of the glass-based substrate 210 and the mounting surface 230 of the electronic device. The separation produced by the thickness of the adhesive belt 270 defines the thickness of the cured adhesive composition 220.

The adhesive belt 270 is located at and adhered to the periphery of the glass-based substrate 210 or, alternatively to an anti-splinter layer 271 of the glass-based substrate 210. The adhesive belt 270 includes a first major surface 272, a second major surface 274, a distal edge 276 extending between the first major surface 272 and the second major surface 274, and a proximal edge 278 extending between the first major surface 272 and the second major surface 274. An edge portion of the cured adhesive composition 220 is in contact with the proximal edge 278 of the adhesive belt 270. The first major surface 272 of the adhesive belt 270 is adhered to the glass-based substrate 210 and the second major surface 274 is adhered to the mounting surface 230. The cured adhesive composition 220 is contained between the glass-based substrate 210 and the mounting surface 230 by the adhesive belt 270.

The adhesive belt 270 may comprise one or more materials, such as synthetic polymers and natural materials. Embodiments of natural materials may comprise animal glue, casein glue, blood albumen glue, starch, dextrin agar, mastic, or combinations thereof. Embodiments of suitable polymers may comprise, without limitation, copolymers such as di-block copolymers, co-block copolymers, etc. and blends thereof: thermoplastics comprising polystyrene (PS), polycarbonate (PC), polyesters comprising poly(ethylene terephthalate) (PET), polyolefins comprising polyethylene (PE), polyvinylchloride (PVC), acrylic polymers comprising poly(methyl methacrylate) (PMMA), thermoplastic urethanes (TPU), polyetherimide (PEI), epoxies, silicones comprising polydimethylsiloxane (PDMS), or combinations thereof. In embodiments, the adhesive belt 270 may include at least one of silicone, acrylic, polyurethane, epoxy, cyanoacrylate, and poly(ethylene terephthalate). The adhesive belt 270 may be different than the cured adhesive composition 220, for example the adhesive belt 270 may have a different composition than the cured adhesive composition 220. In embodiments, the adhesive belt 270 may include a plurality of layers, where the layers may have the same or different compositions. In other embodiments, the adhesive belt 270 may be a single layer.

In embodiments, the thickness of the adhesive belt 270 may be greater than or equal to 5 μm, greater than or equal to 10 μm, greater than or equal to 20 μm, greater than or equal to 30 μm, greater than or equal to 40 μm, greater than or equal to 50 μm, greater than or equal to 60 μm, greater than or equal to 70 μm, greater than or equal to 80 μm, greater than or equal to 90 μm, or even greater than or equal to 100 μm. In embodiments, the thickness of the adhesive belt 270 may be less than or equal to 500 μm, less than or equal to 450 μm, less than or equal to 400 μm, less than or equal to 350 μm, less than or equal to 300 μm, less than or equal to 250 μm, less than or equal to 200 μm, or even less than or equal to 150 μm. In embodiments, the thickness of the adhesive belt 270 may be greater than or equal to 5 μm and less than or equal to 500 μm, greater than or equal to 20 μm and less than or equal to 450 μm, greater than or equal to 30 μm and less than or equal to 400 μm, greater than or equal to 50 μm and less than or equal to 350 μm, greater than or equal to 60 μm and less than or equal to 300 μm, greater than or equal to 70 μm and less than or equal to 250 μm, greater than or equal to 80 μm and less than or equal to 200 μm, or even greater than or equal to 90 μm and less than or equal to 150 μm, or any and all subranges formed between these endpoints.

In embodiments, the width of the adhesive belt 270 may greater than or equal to 0.1 mm, greater than or equal to 0.2 mm, greater than or equal to 0.5 mm, greater than or equal to 1 mm, or even greater than or equal to 2 mm. In embodiments, the width of the adhesive belt 270 is less than or equal to 30 mm, less than or equal to 20 mm, less than or equal to 10 mm, or even less than or equal to 5 mm. In embodiments, the width of the adhesive belt 270 may be greater than or equal to 0.1 mm and less than or equal to 30 mm, greater than or equal to 0.1 mm and less than 20 mm, greater than or equal to 0.1 mm and less than or equal to 10 mm, greater than or equal to 0.1 mm and less than or equal to 5 mm, greater than or equal to 0.2 mm and less than or equal to 30 mm, greater than or equal to 0.2 mm and less than 20 mm, greater than or equal to 0.2 mm and less than or equal to 10 mm, greater than or equal to 0.2 mm and less than or equal to 5 mm, greater than or equal to 0.5 mm and less than or equal to 30 mm, greater than or equal to 0.5 mm and less than 20 mm, greater than or equal to 0.5 mm and less than or equal to 10 mm, greater than or equal to 0.5 mm and less than or equal to 5 mm, greater than or equal to 1 mm and less than or equal to 30 mm, greater than or equal to 1 mm and less than 20 mm, greater than or equal to 1 mm and less than or equal to 10 mm, greater than or equal to 1 mm and less than or equal to 5 mm, greater than or equal to 2 mm and less than or equal to 30 mm, greater than or equal to 2 mm and less than 20 mm, greater than or equal to 2 mm and less than or equal to 10 mm, or even greater than or equal to 2 mm and less than or equal to 5 mm, or any and all sub-ranges formed from any of these endpoints.

The distal edge 276 of the adhesive belt 270 may be located a distance from the edge of the glass-based substrate 210 in a direction perpendicular to the thickness direction of the glass-based substrate 210. In embodiments, the distance between the distal edge 276 of the adhesive belt 270 and the edge of the glass-based substrate 210 may be greater than or equal to 100 nm and less than or equal to 1 mm, greater than or equal to 1 μm and less than or equal to 900 μm, greater than or equal to 50 μm and less than or equal to 800 μm, greater than or equal to 100 μm and less than or equal to 700 μm, greater than or equal to 200 μm and less than or equal to 600 μm, or even greater than or equal to 300 μm and less than or equal to 500 μm, or any and all sub-ranges formed between these endpoints.

Referring now to FIGS. 4-10, the adhesive belt 270 may include one or more channels extending from the distal edge 276 thereof to the proximal edge 278 thereof. The channels allow air to escape from between the glass-based substrate 210 and the mounting surface 230 when the uncured adhesive composition is applied, preventing the formation of unsightly bubbles beneath the glass-based substrate 210. The adhesive belt 270 may include a plurality of channels, such as two, three, four, five, six, seven, eight, or more channels. In embodiments, the channel may have a depth extending from the second major surface 274 of the adhesive belt 270 greater than or equal to 5 μm and less than or equal to 200 μm, greater than or equal to 25 μm and less than or equal to 175 μm, greater than or equal to 50 μm and less than or equal to 150 μm, greater than or equal to 75 μm and less than or equal to 125 μm, or even greater than or equal to 90 μm and less than or equal to 10 μm, or any and all sub-ranges formed between these endpoints. The channel may extend through the entirety of the thickness of the adhesive belt, such that the channel extends from the first major surface 272 of the adhesive belt 270 to the second major surface 274 of the adhesive belt 270.

In embodiments, the channel may have a width extending parallel to an edge of the adhesive belt 270. The width of the channel may be greater than or equal to 0.005 mm and less than or equal to 5 cm, greater than or equal to 0.01 mm and less than or equal to 4 cm, greater than or equal to 0.1 mm and less than or equal to 3 cm, greater than or equal to 0.5 mm and less than or equal to 2 cm, greater than or equal to 1 mm and less than or equal to 1 cm, greater than or equal to 2 mm and less than or equal to 9 mm, greater than or equal to 3 mm and less than or equal to 8 mm, greater than or equal to 4 mm and less than or equal to 7 mm, or even greater than or equal to 5 mm and less than or equal to 6 mm, or any and all sub-ranges formed between these endpoints.

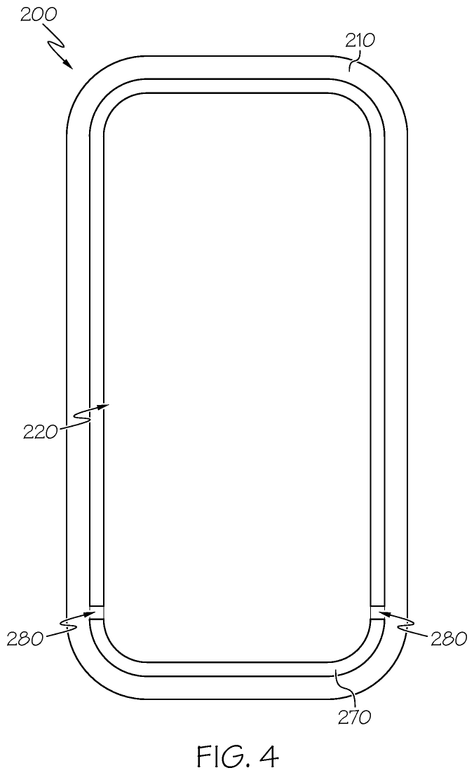

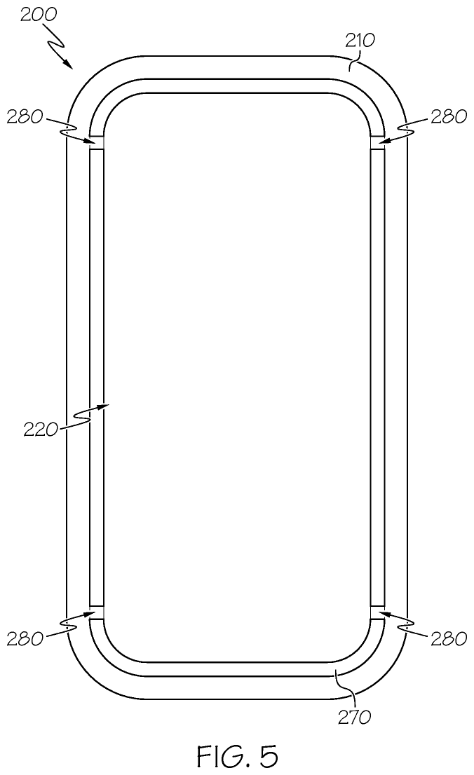

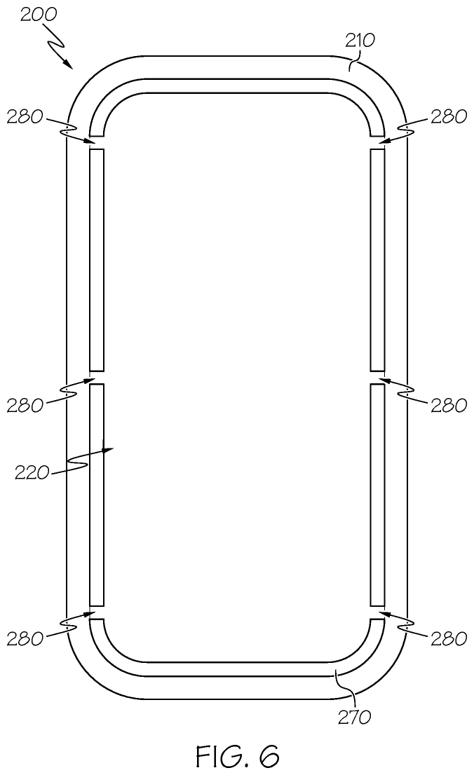

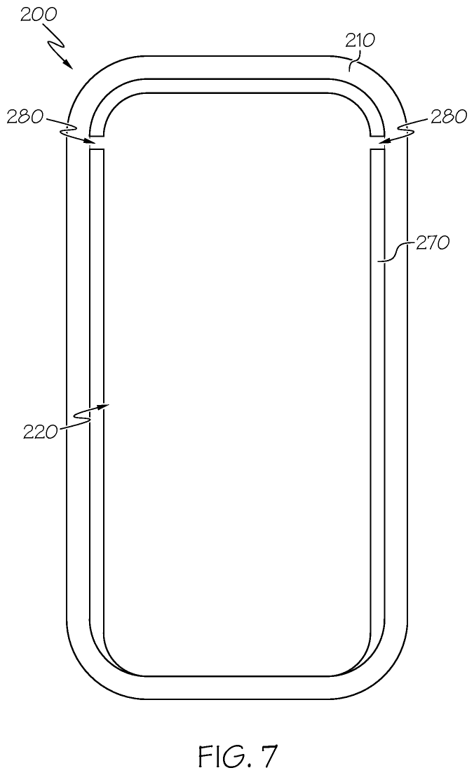

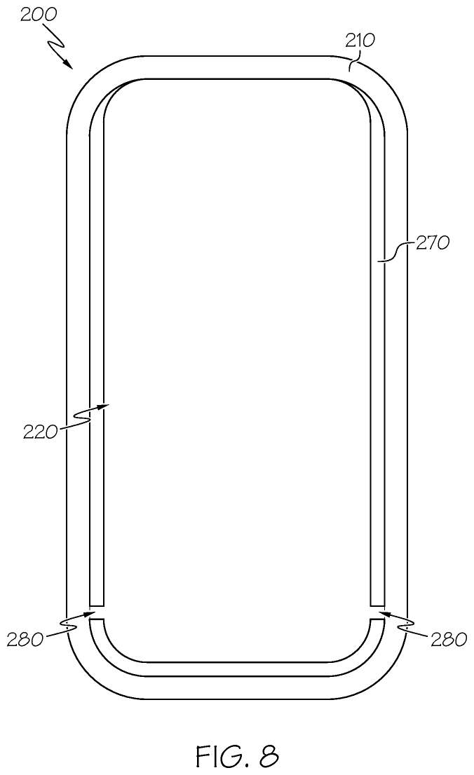

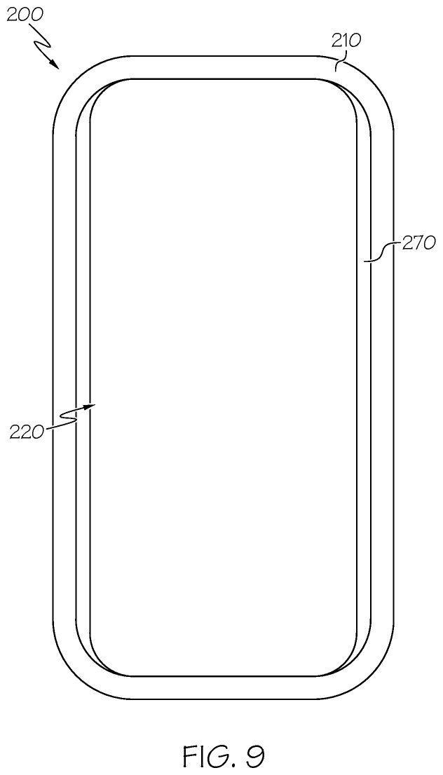

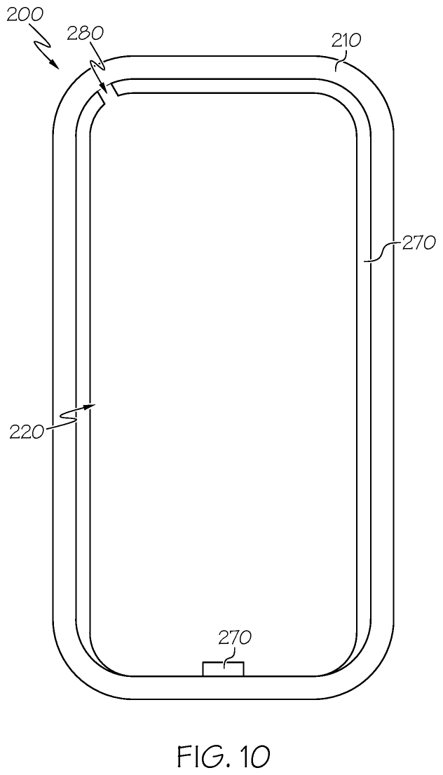

The arrangement of channels in the adhesive belt 270 may be according to any of the embodiments illustrated in FIGS. 4-10. The location of the channels is selected to correspond to the areas in which bubble formation is commonly observed. As shown in FIG. 4, a screen protector 200 includes two channels 280 in the adhesive belt 270, wherein the channels 280 are located near two corners of the screen protector 200. As shown in FIG. 5, a screen protector 200 includes four channels 280 in the cured adhesive composition 220, wherein the channels 280 are located near the corners of the screen protector 200. As shown in FIG. 6, a screen protector 200 includes six channels 280 in the adhesive belt, wherein the channels 280 are located near the corners of the screen protector 200 and at approximately the mid-point of a longer side of the screen protector 200. As shown in FIG. 7, a screen protector 200 includes two channels 280 in the adhesive belt 270, wherein the channels 280 are located near two upper corners of the screen protector 200 and the adhesive belt 270 does not extend along a lower short side of the screen protector 200. As shown in FIG. 8, a screen protector 200 includes two channels 280 in the adhesive belt 270, wherein the channels 280 are located near two lower corners of the screen protector 200 and the adhesive belt 270 does not extend along an upper short side of the screen protector. As shown in FIG. 9, a screen protector 200 does not include a channel in the adhesive belt 270, wherein the adhesive belt 270 does not extend along the upper or lower short side of the screen protector 200. Experiments have demonstrated that leakage is less likely from the short sides of the screen protector 200, and as a result the cured adhesive composition 220 may be adequately contained even when the short sides of the screen protector 200 do not include the adhesive belt 270. As shown in FIG. 10, a screen protector 200 includes a channel 280 located near an upper corner of the screen protector 200 and the adhesive belt 270 extends along a portion of the lower short side of the screen protector 200 at a center of the screen protector 200.

The channels 280 in the adhesive belt 270 may be formed by any appropriate method. In embodiments, the channels 280 may be formed by die cutting, laser cutting, digital knife cutting, or water cutting. The channels 280 may also be formed by laminating pieces of the adhesive belt 270 to the glass-based substrate 210 separately, such that gaps are formed between the pieces to form the channels 280. The channels 280 may also be formed by printing a liquid adhesive ink on the desired location with the target thickness followed by a curing process, such that the channels 280 are formed by controlling the location of printing.

The strength of adhesion of the adhesive belt 270 to the glass-based substrate 210 and the mounting surface 230 may be selected to ensure that the screen protector 200 remains adhered to the mounting surface 230 in normal use and may be removed without excessive difficulty when desired. If the peel force is too low, the adhesive belt 270 may be dislodged from the mounting surface 230 during normal usage and the uncured adhesive composition may leak before it is cured. When the peel force is too high, it may not be possible to remove the adhesive belt 270 from the mounting surface 230 without damaging the mounting surface 230. The strength of adhesion of the adhesive belt 270 may be characterized by the peel force. In embodiments, the peel force on the surface of the adhesive belt 270 adhered to the glass-based substrate 210 may be different than the peel force on the surface of the adhesive belt 270 adhered to the mounting surface 230. In embodiments, the surface of the adhesive belt 270 adhered to the glass-based substrate 210 may have a peel force on glass greater than or equal to 500 gf/inch and less than or equal to 5000 gf/inch, greater than or equal to 500 gf/inch and less than or equal to 2500 gf/inch, greater than or equal to 1000 gf/inch and less than or equal to 2000 gf/inch, greater than or equal to 100 gf/inch and less than or equal to 4000 gf/inch, greater than or equal to 1000 gf/inch and less than or equal to 4000 gf/inch, or even greater than or equal to 2000 gf/inch and less than or equal to 4000 gf/inch, or any and all sub-ranges formed between these endpoints. In embodiments, the surface of the adhesive belt 270 adhered to the mounting surface 230 may have a peel force on glass greater than or equal to 20 gf/inch and less than or equal to 5000 gf/inch, greater than or equal to 30 gf/inch and less than or equal to 4500 gf/inch, greater than or equal to 40 gf/inch and less than or equal to 4000 gf/inch, greater than or equal to 50 gf/inch and less than or equal to 3500 gf/inch, greater than or equal to 100 gf/inch and less than or equal to 3000 gf/inch, greater than or equal to 500 gf/inch and less than or equal to 2500 gf/inch, greater than or equal to 1000 gf/inch and less than or equal to 2000 gf/inch, greater than or equal to 100 gf/inch and less than or equal to 4000 gf/inch, greater than or equal to 1000 gf/inch and less than or equal to 4000 gf/inch, or even greater than or equal to 2000 gf/inch and less than or equal to 4000 gf/inch, or any and all sub-ranges formed between these endpoints.

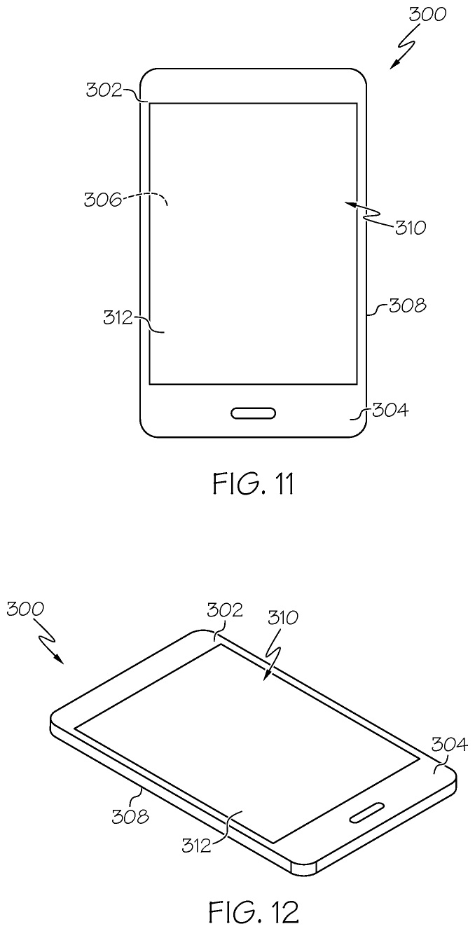

An exemplary device to which the screen protectors described herein may be applied is shown in FIGS. 11 and 12. Specifically, FIGS. 11 and 12 show a consumer electronic device 300 including a housing 302 having front 304, back 306, and side surfaces 308; electrical components (not shown) that are at least partially inside or entirely within the housing and including at least a controller, a memory, and a display 310 at or adjacent to the front surface of the housing; and a cover glass 312 at or over the front surface of the housing such that it is over the display. The cover glass 312 and/or the housing 302 may form a portion or all of the mounting surface to which the screen protector described herein is adhered. In embodiments, the cover glass 312 and/or housing 302 may include a fluoropolymer coating, such that the mounting surface to which the screen protector is adhered includes the fluoropolymer coating. In embodiments, the mounting surface to which the screen protector is adhered is disposed over the display 310.

Use of application fixtures described herein allow for screen protectors to be applied quickly, easily, and successfully by consumers who may have no experience with installing screen protectors. Correct installation of screen protectors onto handheld electronic devices is a critical component of the success of the screen protector functionality.

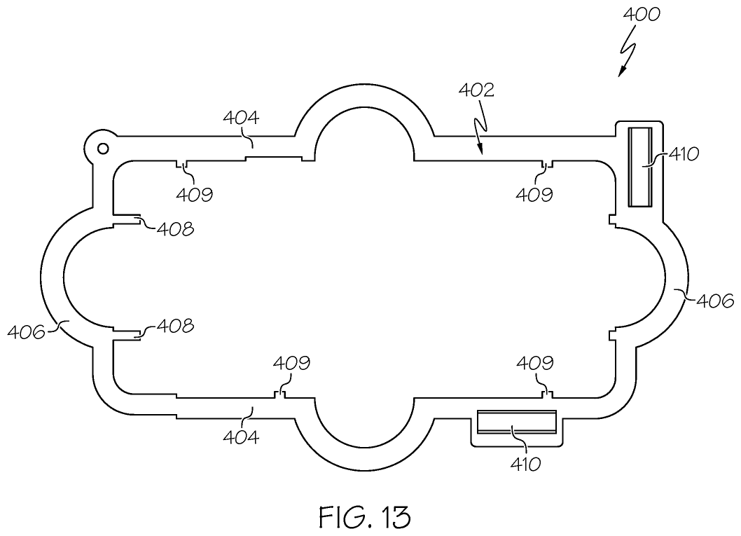

Referring now to FIG. 13, an exemplary application fixture for securing a screen protector to a cover glass is shown at 400. The application fixture 400 provides the required levelness during screen protector application. If the electronic device to which the screen protector is being applied is not level, the uncured adhesive composition may flow randomly before it is cured, which may result in bubble formation. The application fixture 400 includes a rectangular frame 402 having a pair of length sides 404 and a pair of width sides 406. The pair of length sides 404 are generally perpendicular to the pair of width sides 406. A plurality of tabs 408 extend from one of the pair of width sides 406 in a direction perpendicular to the pair of width sides 406. The electronic device rests on the plurality of tabs 108 during application of the screen protector. A plurality of protrusions 409 extend from each of the pair of length sides 404 in a direction perpendicular to the pair of length sides 404. The screen protector lies under the plurality of protrusions 409 during application of the screen protector. At least one level 410 is positioned in one of at least one of the pair of length sides 404 and the pair of width sides 406. The application fixture 400 is configured to allow an electronic device to be placed therein to determine the levelness of the electronic device prior to application of a screen protector.

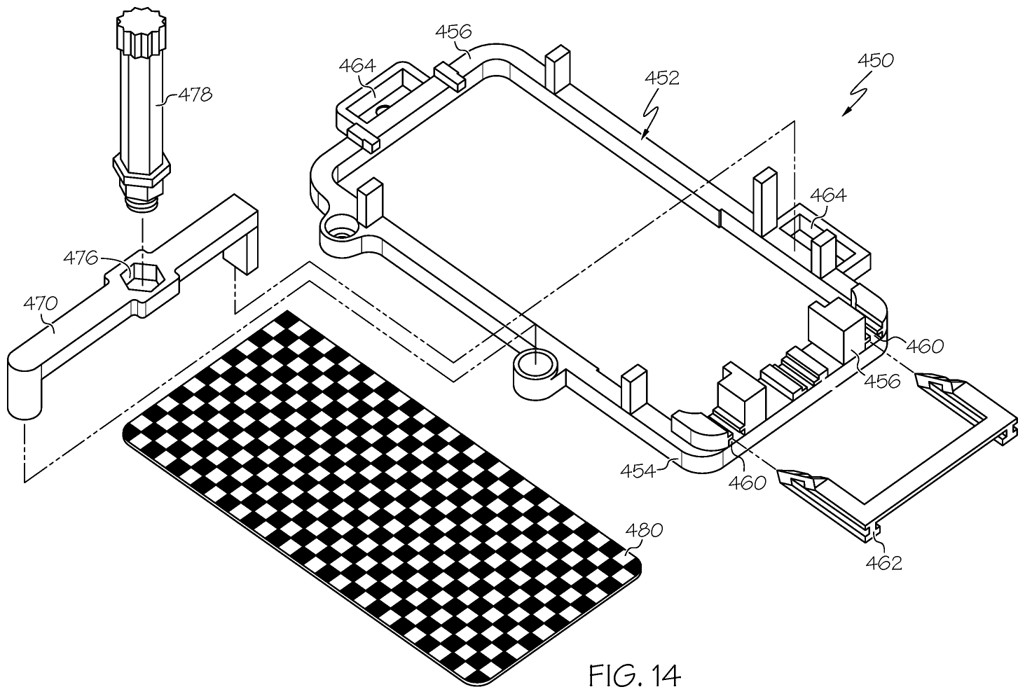

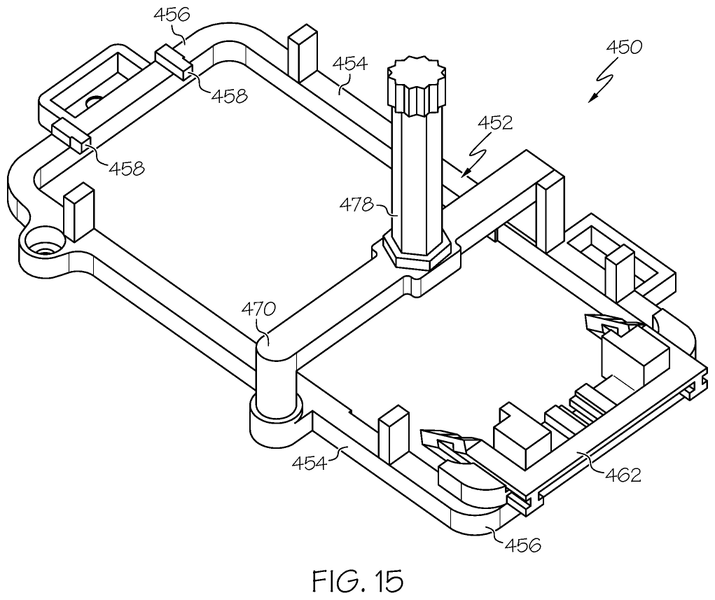

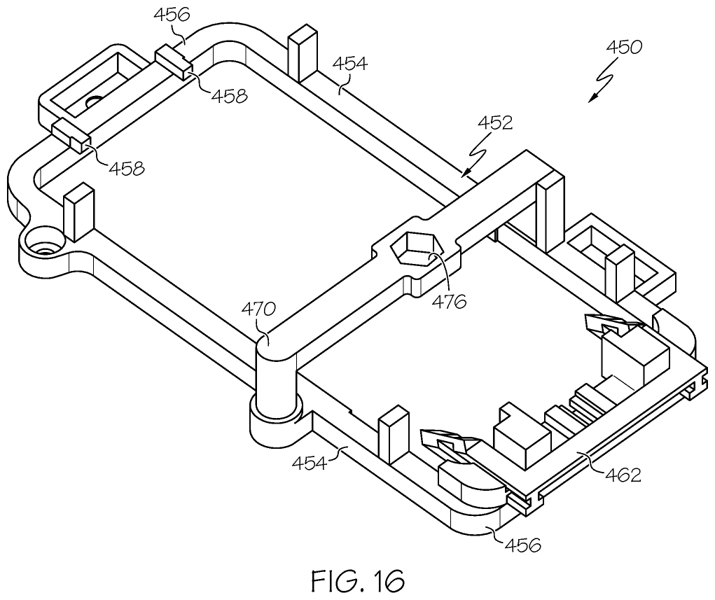

Referring now to FIGS. 14-16, another application fixture for securing a screen protector to a cover glass is shown at 450. The application fixture 450 includes a multiage degree sliding wedge that provides assistance with the uncured adhesive composition application to ensure the correct location, screen protector angle, and speed of contact with the uncured adhesive composition and the resulting wave front of the uncured adhesive composition, which spreads the uncured adhesive composition to all areas between the screen protector and device cover glass.

The application fixture 450 includes a rectangular frame 452 having a pair of length sides 454 and a pair of width sides 456. The pair of length sides 454 are generally perpendicular to the pair of width sides 456. A plurality of tabs 458 extend from one of the pair of width sides 456. At least one groove 460 is included in the other of the pair of width sides 456. A wedge slider 462 is insertable into the at least one groove 460. As shown, the at least one groove 460 may comprise two grooves and the wedge slider 462 may comprise a double wedge slider insertable into the two grooves. The application fixture 450 may further include at least one level 464 positioned in one of one at least one of the pair of length sides 454 and pair of width sides 456. The application fixture 450 may further include an applicator arm 470. The applicator arm 470 extends between and is connectable to the pair of width sides 456. The applicator arm 470 includes an opening 476 configured to hold an adhesive container 478 therein. The application fixture 450 may further include a leveling mat 480.

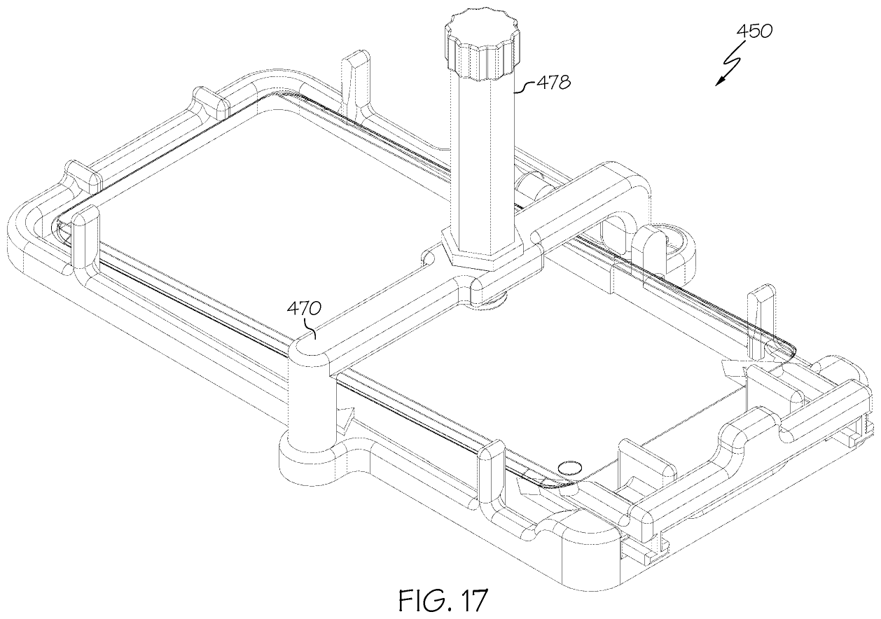

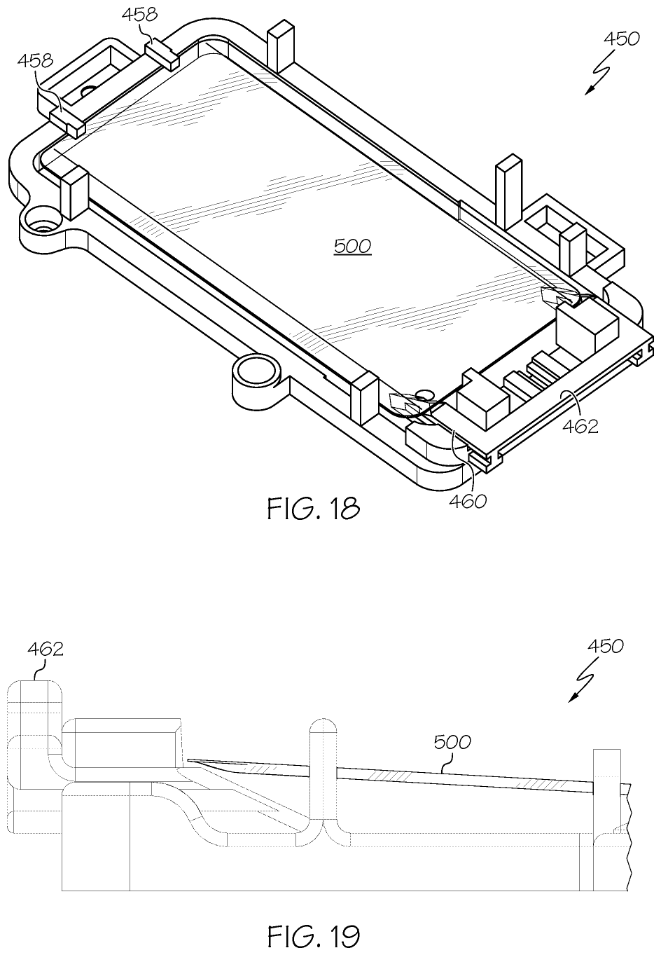

During application of a screen protector to an electronic device, an electronic device is placed on the leveling mat 480 and the levelness of the electronic device is determined and adjusted as necessary. Referring now to FIG. 17, the applicator arm 470 is placed over the electronic device. The adhesive container 478 is placed into the opening 476 of the applicator arm 470. The uncured adhesive composition contained in the adhesive container 478 is disposed onto the electronic device. The applicator arm 470 is rotated and removed away from the electronic device. If the application fixture 450 does not include an applicator arm, the uncured adhesive composition contained in the adhesive container 478 is manually disposed onto the electronic device. The wedge slider 462 is inserted into the at least one groove 460 as shown in FIG. 18. A screen protector 500 is placed against the plurality of tabs 458 and lowered onto and rested on the wedge slider 462. The wedge slider 462 is gently pulled out from the application fixture 450 to allow the screen protector 500 to lower into place. At this point, the uncured adhesive composition will flow under the screen protector 500 and to all corners. Once the adhesive composition has fixed (e.g., after 10 minutes), the user presses down on the electronic device and removes the application fixture 450 from the electronic device.

In embodiments, the uncured adhesive composition described herein may be applied without the use of an application kit such as those described herein. In embodiments, the uncured adhesive composition described herein may be applied using a different application kit than the application kits described herein.

In embodiments, a screen protector application kit includes a glass-based substrate 110 (FIG. 1) having an adhesive belt 270 (FIGS. 2 and 3) and an adhesive container 478 (FIG. 15) of an uncured adhesive composition. The glass-based substrate 110 may include features as described hereinabove. The uncured adhesive composition comprises 30 wt % to 99.9 wt % of at least one of: (i) a monomer; and (ii) an oligomer; and 0.01 wt % to 10 wt % of a visible-light photoinitiator. The uncured adhesive composition may further include features as described hereinabove. The adhesive belt 270 comprises a first major surface 272 adhered to the glass-based substrate 110, a second major surface 274, a distal edge 276 extending between the first major surface 272 and the second major surface 274, and a proximal edge 278 extending between the first major surface 272 and the second major surface 274. The adhesive belt 270 may further include features as described hereinabove.

In embodiments, a screen protector application kit includes a glass-based substrate 110 (FIG. 1), an adhesive container 478 (FIG. 15) of an uncured adhesive composition, and an application fixture. The glass-based substrate 110 may include features as described hereinabove. The uncured adhesive composition comprises greater than or equal to 30 wt % and less than or equal to 99.9 wt % of at least one of: (i) a monomer; and (ii) an oligomer; and greater than or equal to 0.01 wt % and less than or equal to 10 wt % of a visible-light photoinitiator. The uncured adhesive composition may further include features as described hereinabove. In embodiments, the application fixture 400 (FIG. 13) comprises a rectangular frame 402 having a pair of length sides 404 and a pair of width sides 406. In embodiments, the application fixture 400 further comprises a plurality of tabs 408 extending from one of the pair of width sides 406 in a direction perpendicular to the pair of width sides 406, a plurality of protrusions 409 extending from each of the length sides 404 in a direction perpendicular to the pair of length sides, and at least one level 410 positioned in one of at least one of the pair of length sides 404 and the pair of width sides 406. In embodiments, the application fixture 450 (FIGS. 14-16), comprises a rectangular frame 452 having a pair of length sides 454 and a pair of width sides 456. In embodiments, the application fixture 450 comprises a plurality of tabs 458 extending from one of the pair of width sides 456 in a direction perpendicular to the pair of width sides 456; at least one groove 460 in the other of the pair of width sides 456; and a wedge slider 462 insertable into the at least one groove 460. In embodiments, the application fixture 450 further comprises at least one level 464 positioned in one of at least one of the pair of length sides 454 and the width sides 456. In embodiments, the application fixture 450 further comprises an applicator arm 470 extending between and being connectable to the pair of width sides 456, the applicator arm 470 having an opening 476 configured to hold the adhesive container 478 therein. In embodiments, the application fixture 450 further comprises a leveling mat 480. In embodiments, the glass-based substrate 110 of the screen protector application kit further includes an adhesive belt 270 (FIGS. 2 and 3). The adhesive belt 270 may further include features as described hereinabove.

### EXAMPLES

Embodiments will be further clarified by the following examples. It should be understood that these examples are not limiting to the embodiments described above.

### Example 1—The Effects of Thickness and Properties of Cured Adhesive Compositions on Ultrasonic Sensor Functionality

The effect of the thickness and properties of a cured LOCA on the performance of ultrasonic sensors was tested. Samples were prepared by laminating optically clear adhesives of different thicknesses on glass substrates. The adhesive composition materials are reported in Table I. The adhesive compositions were deliberately chosen due to their differences in rheological properties

TABLE I

| Adhesive | Composition | Description |
|---|---|---|
| 1 | 1,6-Hexanediol diacrylate (HDDA) | Irgacure 819 |
| | 1 wt % photoinitiator | photoinitiator |
| 2 | Isobornyl acrylate (IBOA) | Irgacure 819 |
| | 1 wt % photoinitiator | photoinitiator |
| 3 | 1,6-Hexanediol diacrylate (HDDA) | NOA89 |
| | Mercapto-ester | |
| | photoinitiator | |
| 4 | IBOA 36 wt % | Commercially |
| | HDDA 13 wt % | available acrylate |
| | Bisoflex 23 wt% | |
| | Hydrocarbon acrylate 11 wt % | |
| | photoinitiator 2 wt % | |
| 5 | IBOA + additives | TP2500 |
| 6 | Acrylate based | 821x |

Adhesives 1 and 2 in Table I were acrylate monomers with commercially available photoinitiators. Adhesives 3-6 are commercially available materials.

The adhesive compositions were tested on commercially available Samsung S10 and S10+ devices, which include an under-display ultrasonic fingerprint sensor. Adhesives 1-5 were applied to the devices in a liquid state. Then, the screen protector glass was applied onto the Adhesives 1-5. The thickness of the liquid adhesive layers was controlled by four pieces of double-sided tape placed between the screen protector glass and the device cover glass to act as spacers. The liquid adhesive layers were then cured by irradiation with an ultraviolet (UV) lamp. Adhesive 6 was purchased as a solid film and laminated on the glass by a laminator. The glasses used in the tests were alkali aluminosilicate glasses, and the properties of the glasses are reported in Table II. The glasses were tested in both chemically strengthened (with a stress profile) and in non-strengthened form. The different properties of the glasses and the presence of a stress profile did not produce a significant difference in the performance of the FPS response. The thicknesses of the glasses ranged from 100 μm to 500 μm, beyond which the aesthetics and touch sensitivity of the screen protector were degraded. The glass was cleaned by acetone and the film application/lamination was free of air bubbles.

TABLE II

| | | Young's | | Ultrasonic | Ultrasonic | Half |
|---|---|---|---|---|---|---|
| | Density | modulus | Poisson's | velocity | wavelength | wavelength |
| Glass | (g/cm³) | (GPa) | ratio | (m/s) | (μm) | (μm) |
| A | 2.39 | 69.3 | 0.22 | 5753.6 | 479.5 | 239.8 |
| B | 2.43 | 76.7 | 0.21 | 5960.8 | 496.7 | 248.4 |
| C | 2.4 | 77 | 0.21 | 6009.6 | 500.8 | 250.4 |

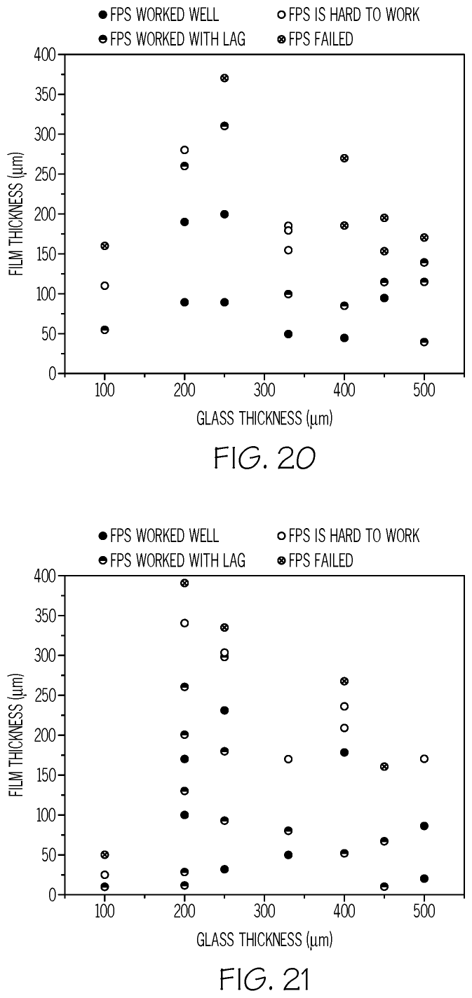

The results of FPS performance tests of screen protectors having various glass and polymer adhesive thickness combinations are presented in FIGS. 20-25. The FPS responses are shown by symbols: solid black circles represent where the FPS worked as well as without the screen protector or with acceptable minor lag, half-filled circles indicate that the FPS was functional but with noticeable and unpleasant lag, void circles indicate where the FPS required a very hard push, exhibited significant lag, or the device could not be unlocked by a registered fingerprint even though the registration was successful, a circle with an x indicates that the FPS could not register a fingerprint. The boundary of the region containing the solid black circles and the half-filled circles was considered as the boundary of the regime where the screen protector was compatible with the ultrasonic FPS.

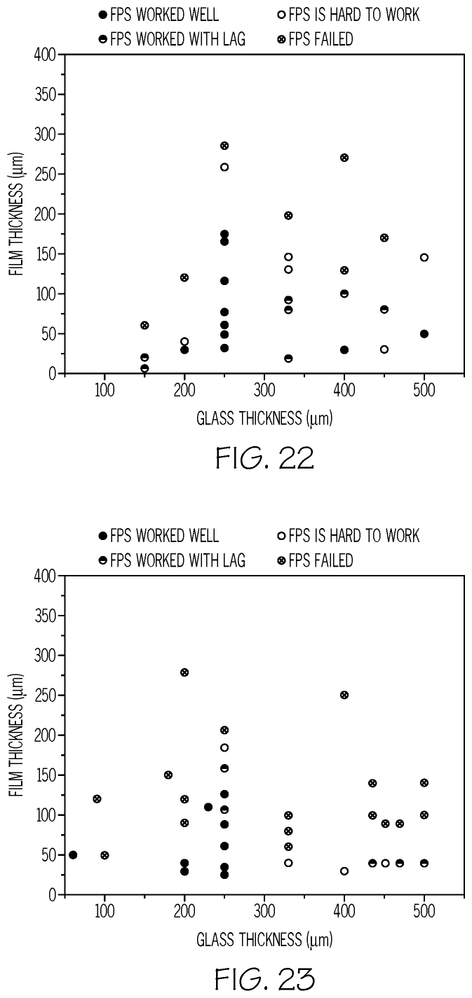

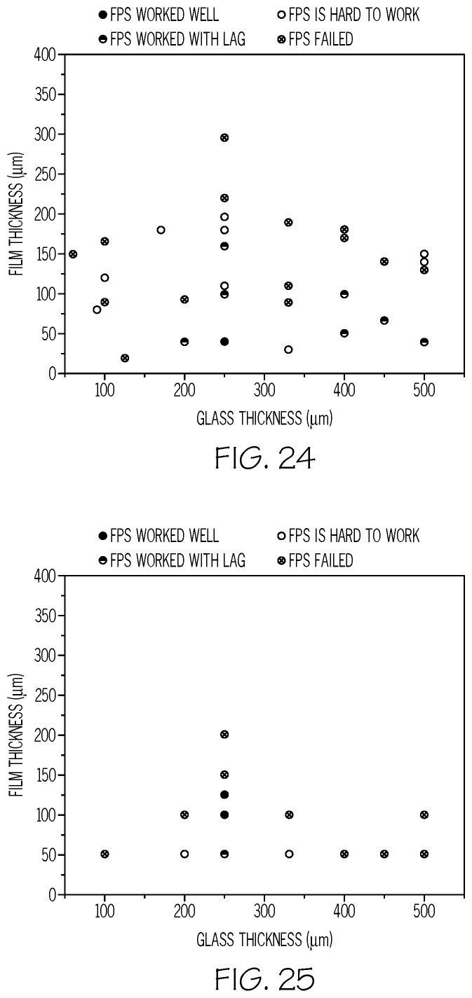

FIG. 20 utilized Adhesive 1. FIG. 21 utilized Adhesive 2. FIG. 22 utilized Adhesive 3. FIG. 23 utilized Adhesive 4. FIG. 24 utilized Adhesive 5. FIG. 25 utilized Adhesive 6.

As shown in FIGS. 20-25, the FPS response was best for a glass substrate thickness of 250 μm (±30 μm). In this glass thickness range, the FPS had the intended functionality (as indicated by the solid black and half-filled points) even with the largest thickness of the cured adhesive composition.

The calculated results for the ultrasonic velocity, ultrasonic wavelength, and half wavelength for the 12 MHz operating frequency of the tested FPS in the glass compositions are presented in Table II. As discussed above, a resonance at multiples of the half wavelength of the ultrasonic wave in the glass substrate increases the performance of the FPS. Accordingly, as shown in FIGS. 20-25, FPS is functional (sold black and half-filled data points) with the largest ranges of fill thicknesses for all 6 polymer adhesives when the glass substrate thickness of 250 μm (±30 μm), corresponding to the half wavelength of the ultrasonic wave. Moreover, the functional data points (solid black and half-filled data points) for all 6 cured adhesive compositions with glass thicknesses of 450-500 μm (approximately twice of the half wavelength) are also more than those with glass thicknesses other than 250 μm (±30 μm), but much less than those with glass thickness of 250 μm (±30 μm). This result, as shown in FIGS. 20-25, indicates that a glass thickness of about the half wavelength produces the best FPS performance for a variety of cured adhesive composition thicknesses.

Different adhesive materials exhibit significantly different responses to the ultrasonic FPS. As shown in FIGS. 20-25, for a given glass substrate thickness of 250 μm, Adhesive 1 (FIG. 20) can be as thick as 300 μm while achieving acceptable FPS performance, but Adhesive 5 (FIG. 24) has a maximum thickness of about 100 μm to achieve the desired functionality of the FPS. Generally, a thinner adhesive layer leads to better FPS functionality, which indicates that the damping of the cured adhesive composition is important to the performance of the FPS.

The rheological properties of the cured adhesive compositions were measured, as shown in FIGS. 26-28. For each cured adhesive composition, a temperature ramp test was conducted in tensile mode from −80° C. to 150° C. The storage modulus (E′), loss modulus (E″), and damping (tan(δ)) of the 6 cured adhesive compositions are presented in FIGS. 26, 27, and 28, respectively. In Table III, the values of E′, E″ and tan(δ) are listed at the reference temperature of 20° C. The maximum cured adhesive composition thickness that produces the desired FPS response with a glass substrate thickness of 250 μm was determined to quantify the cured adhesive composition performance. As shown in Table III and FIGS. 26-28, cured adhesive compositions with better FPS performance typically have a higher E′ and a lower tan(δ) at room temperature (20° C.) and a low frequency (1 Hz). The glass transition temperature (T_{g}) of each cured adhesive composition was obtained as the corresponding temperature with the largest tan(δ).

Since the polymer rheology is a function of frequency, the temperature sweep tests were also conducted for each cured adhesive composition to acquire E′, E″, and tan(δ) at ultrasonic frequencies. The frequency sweeps were performed from 0.1-100 Hz and a temperature range of 0-60° C. Rheology curves were then produced by using the principle of time-temperature superposition. A reference temperature close to T_{g} was assigned to each cured adhesive composition. The frequency sweep data at each temperature was then shifted horizontally along the x-axis by applying a multiplication factor to the measured frequency to produce a master curve based on a reduced frequency in Hz. After the master curve was constructed, the entirety of the master curve was shifted to a new reference temperature of 20° C. (room temperature) using the WLF (William, Landel, and Ferry) equation. The reduced frequencies of the original master curve were then transferred to a new set of frequencies at the new reference temperature of 20° C. by shifting factors. These new master curves of the adhesive materials are shown in FIGS. 29-31. The shifted values of E′, E″, and tan(δ) are listed in Table III with the operating frequency of 12 MHz at a reference temperature of 20° C.

TABLE III

| | | E′ | E″ | | E′ | E″ | | Max |
|---|---|---|---|---|---|---|---|---|
| | T_{g} | 1 Hz | 1 Hz | Tan(δ) | 12 MHz | 12 MHz | Tan(δ) | Thickness |
| Adhesive | (° C.) | (MPa) | (MPa) | 1 Hz | (MPa) | (MPa) | 12 MHz | (μm) |
| 1 | 90 | 1270 | 68.46 | 0.053 | 2120 | 83.5 | 0.039 | 350 |
| 2 | 70 | 1750 | 61.3 | 0.031 | 2000 | 39.2 | 0.025 | 300 |
| 3 | 12 | 7.6 | 3.12 | 0.408 | 603.7 | 21.5 | 0.037 | 200 |
| 4 | −22 | 0.17 | 0.065 | 0.371 | 355.6 | 123.1 | 0.348 | 150 |
| 5 | −51 | 0.59 | 0.27 | 0.457 | 30.3 | 11.0 | 0.386 | 100 |
| 6 | 4 | 0.88 | 0.89 | 1.015 | 788.3 | 179.8 | 0.229 | 125 |

The cured adhesive compositions tend to behave as stiff materials at high frequencies, as indicated by large E′ values (30-2200 MPa). The FPS performance is dependent on both E′ and tan(δ) at 20° C. at the operating frequency of 12 MHz. Remarkably, Adhesives 1 and 3 have the same (within the tolerance of rheology measurement) tan(δ) at 20° C. and 12 MHz. The better FPS performance of Adhesive 1 in comparison to Adhesive 3 can be attributed to the larger E′ of Adhesive 1. The acoustic impedance of Adhesive 1 is larger with a larger E′, leading to a smaller difference in acoustic impedance between the adhesive and glass substrate.

The larger acoustic impedance of Adhesive 1 produces less reflection at the adhesive-glass substrate interface and more ultrasonic transmission. Moreover, Adhesive 2 has even an smaller tan(δ) than Adhesives 1 and 3. E′ of Adhesive 2 is slightly smaller than Adhesive 1 and much larger than Adhesive 3. Therefore, the FPS performance of Adhesive 2 is slightly worse than Adhesive 1, but still much better than Adhesive 3. In comparison, Adhesive 4, 5, and 6 have large tan(δ) (>0.2) at 20° C. and the operating frequency of 12 MHz, indicating large damping of ultrasonic wave. Hence, the FPS functionalities of Adhesive 4, 5, 6 are not desirable compared to Adhesive 1, 2, 3, even though Adhesive 6 has similar E′ value as Adhesive 3. Therefore, for robust FPS performance, a glass screen protector should have an adhesive film having a thickness of 300 μm or less, with E′ greater than 300 MPa and tan(δ) less than 0.2 at room temperature and the operation frequency (20° C., 12 MHz), or even with E′ greater than 600 MPa and tan(δ) less than 0.05 (Adhesive 3 in Table III) at room temperature and operating frequency (20° C., 12 MHz). Based on the discussion above, generally, an adhesive material with a large E′ and a small tan(δ) at 20° C. and the operating frequency is preferred for FPS performance.

The material properties used in computational calculations are listed in Table IV.

TABLE IV

| | ρ | α | υₚ | Z |
|---|---|---|---|---|
| Material | (g/ca^{me}) | (dB/m) | (m/s) | (Pa.s/m³) |
| Skin | 1.15 | 920 | 1730 | 1.99 × 10⁶ |
| Glass A | 2.39 | 16 | 5754 | 13.7 × 10⁶ |
| Glass C | 2.4 | 16 | 6010 | 14.4 × 10⁶ |
| Adhesive 3 | 1.2 | 8600 | 2700 | 3.0 × 10⁶ |
| High Damping | 1.2 | 25000 | 2700 | 3.0 × 10⁶ |
| Adhesive | | | | |

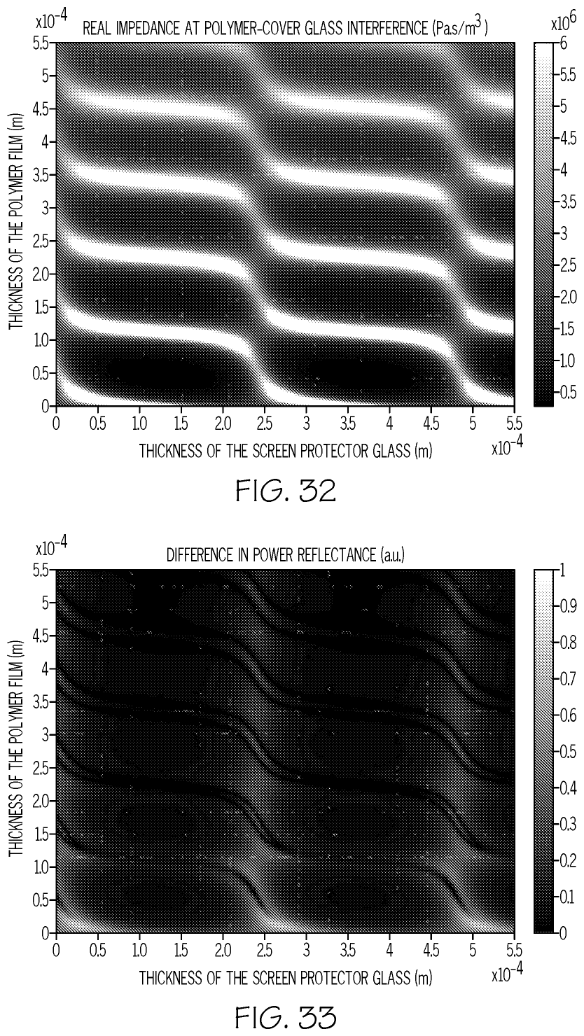

Utilizing the material properties in Table IV, the calculated equivalent real acoustic impedance at the interface of the adhesive and the device cover are shown in FIG. 32 as a function of glass thickness and adhesive film thickness. The difference in the ultrasonic power reflecting back to the sensor detector between fingerprint ridges and fingerprint valleys is shown in FIG. 33 as a function of glass thickness and adhesive film thickness. In FIGS. 32 and 33, the attenuation of the adhesive was calculated by the measured tan(δ) of Adhesive 3 (tan(δ)=0.037). The operational frequency of the ultrasonic wave in FIGS. 32 and 33 is 12 MHz.

As shown in FIG. 32, the equivalent real acoustic impedance at the adhesive-cover interface is periodic. The ideal design of the glass substrate and cured adhesive composition thicknesses should match the equivalent real acoustic impedance with the intrinsic acoustic impedance of finger skin (1.99×10⁶ Pa·s/m³ in Table IV), which corresponds to the grey region in FIG. 32. When the glass thickness is around 240 μm or 480 μm (±40 μm), the equivalent real impedance has the largest range of cured adhesive composition thicknesses appropriate for the desired functionality of the FPS. Other than the optimized glass thicknesses, the range of the cured adhesive composition thickness is relatively small (variation less than 10 μm), which cannot be achieved by the thickness control capability of sample preparation methods. In FIG. 33, the difference in power received by the ultrasonic detector between fingerprint ridges and fingerprint valleys shows a periodic dependence on the screen protector glass thickness, and was primarily controlled by the damping of the cured adhesive composition as a function of cured adhesive composition thickness. The maximum difference in power happens with glass thicknesses of around 240 μm or 480 μm (±40 μm). The calculations are consistent with the results of experimental tests shown in FIGS. 20-25, in which the FPS has the best performance with the glass thickness of 250 μm. Thinner cured adhesive compositions have a larger difference in power transmitted back to the ultrasonic sensor detector, resulting in better FPS response in the experimental tests (FIGS. 20-25). For Adhesive 3 with a 250 μm glass substrate thickness, the largest film thickness compatible with the functionality of the FPS was around 200 μm (FIG. 22), which corresponds to around 0.4 of the difference in power received by the ultrasonic detector (FIG. 33).

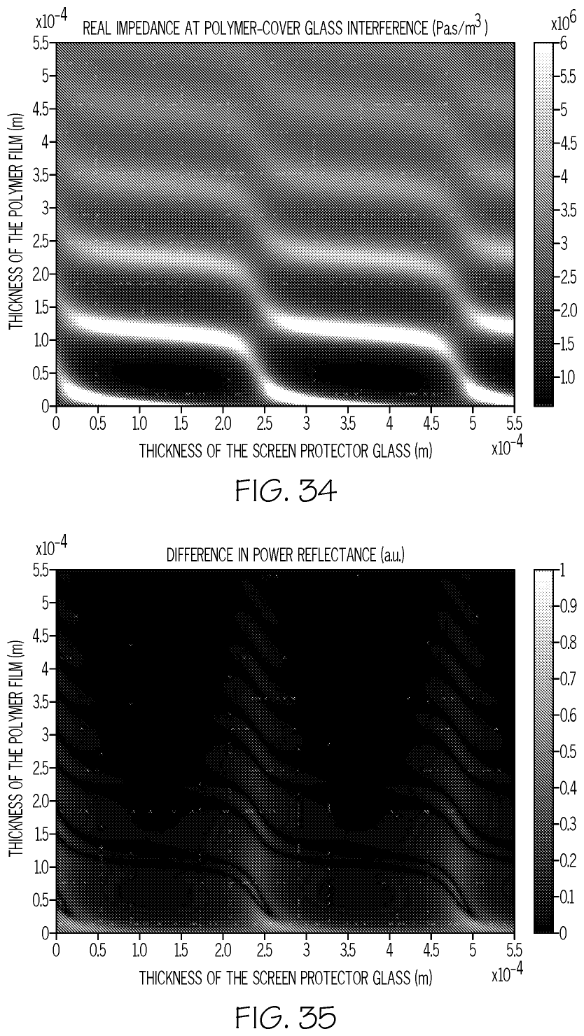

FIGS. 34 and 35 are the calculated real impedance and difference in power back to the detector using an adhesive with high damping (Table IV—High Damping Adhesive). The operational frequency of the ultrasonic wave in FIGS. 34 and 35 is 12 MHz. The increase in damping does not change the optimized glass thickness for the desired FPS functionality, but it significantly reduces the difference in the power received by the ultrasonic sensor detector. Assuming the difference in power received by the sensor detector should be at least 0.4 times of the original power, the High Damping Adhesive cannot be thicker than 100 μm for a 250 μm glass substrate thickness to achieve the desired FPS functionality.

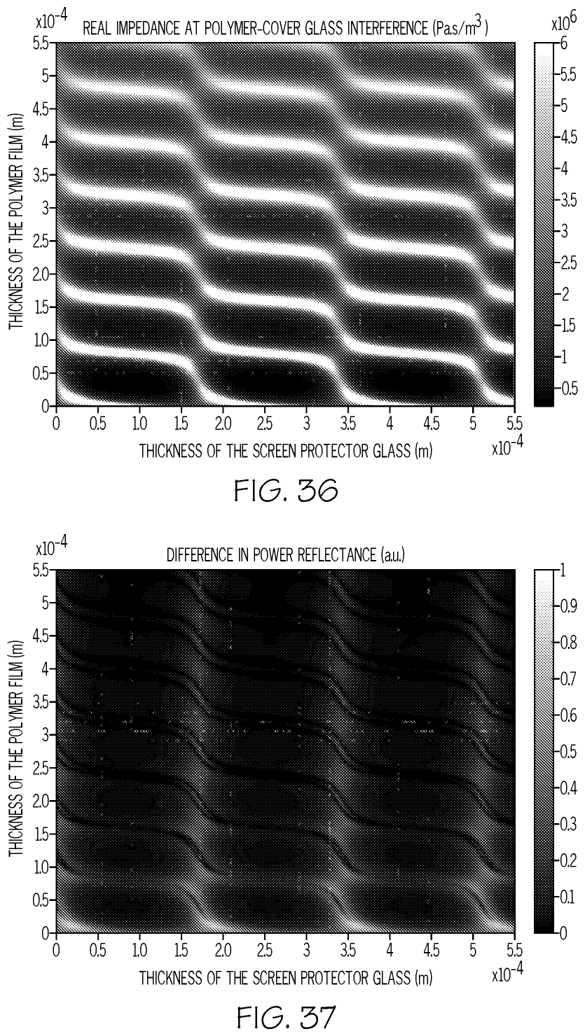

FIGS. 36 and 37 are the calculation of the real impedance and difference in power back to the detector using an adhesive with high damping (Table IV—High Damping Adhesive) for a higher ultrasonic frequency of 17 MHz rather than 12 MHz. The cured adhesive composition properties used in the calculation of FIGS. 36 and 37 are the same as those used in FIGS. 32 and 33. Increasing the frequency changes the optimized glass thickness to around 170 μm, 340 μm, and 510 μm, corresponding to ½ wavelength, 1 wavelength, and 1½ wavelength of the ultrasonic wave at the operating frequency of the sensor in the glass substrate. The thickness control of the glass substrate should be more accurate (±20 μm) since the frequency of the periodicity is larger. The change of frequency does not affect the dependence of returned power on the thickness of the cured adhesive composition. Additionally, the calculation is performed with the assumption of no dispersion of the ultrasonic wave in the glass substrate in the desired frequency range, which indicates that Young's modulus, Poisson's ratio, and velocity of the wave are constants. However, if the ultrasonic wave has non-negligible dispersion in a specific glass substrate, the wavelength and optimized glass substrate thickness are a function of the ultrasonic dispersion.

### Example 2—Addition of Visible-Light Photoinitiator

Table V lists visible-light photoinitiators used in experimental tests and their properties. The visible-light photoinitiators in Table V are commercially available as Irgacure 819, Irgacure 784, and H-Nu 740 MP and the absorption peaks reported in Table V were reported by the vendor. The experimental tests were performed with these visible-light photoinitiators dissolved in multiple acrylate monomers and commercially available liquid optically clear adhesives (LOCA) that cannot be cured by visible light, as reported in Table VI. The cure mechanism reported in Table VI is for the compositions prior to the addition of visible-light photoinitiators described herein. For the sake of simplicity, the performance of isobornyl acrylate (IBOA) monomer will primarily be described.

TABLE V

| | | | Absorption |
|---|---|---|---|
| | | | Peaks in |
| Photo- | | | methanol |
| initiator | Chemical Identity | Appearance | (nm) |
| Irgacure | Phosphine oxide, phenyl bis (2,4,6- | Light | 295, 370 |
| 819 | trimethyl benzoyl) | Yellow | |
| Irgacure | Bis (eta 5-2,4-cyclopentadien-1-yl) | Orange | 398, 470 |
| 784 | Bis [2,6-difluoro-3-(1H-pyrrol-1-yl) | | |
| | phenyl]titanium | | |
| H-Nu | 1-butyl-2-[5-(1-butyl-1,3-dihydro-3, | Blue | 646 |
| 640MP | 3-dimethyl-2H-indol-2-ylidene)-1, | | |
| | 3-pentadien-1-yl]-3,3-dimethyl-3H- | | |
| | indolium salt | | |

TABLE VI

| | Viscosity | Cure |
|---|---|---|
| Chemical composition | (cps) | mechanism |
| IBOA (Isobornyl acrylate) monomer | 6-10 | Not curable |
| HDDA (1,6-Hexanediol diacrylate) monomer | 9 | Not curable |
| HDDA; Mercapto-ester; UV photoinitiator | 20 | UV cure |
| IBOA (36%) + HDDA (13%) + Bisoflex | 10-20 | UV cure |
| (23%) + hydrocarbon acrylate (11%) + UV | | |
| photoinitiator (2%) | | |
| Urethane related resin based. Mercapto ester 1 | 250 | UV cure/ |
| (30-50%); Mercapto ester 2 (35-60%); | | heat cure |
| Benzophenone (0.1-3%) | | |
| IBOA + UV photoinitiators + silica particles + | 2500 | UV cure |
| other additives | | |

To demonstrate the polymerization by visible light, IBOA was mixed with 0.01-1.0 wt % and 0.5 wt % of one or more photoinitiators listed in Table V and applied onto a glass-based cover by pipette. The glass-based covers utilized in the tests were part of commercially available Samsung S8 and/or Samsung S8+ devices. The screen protector was applied onto the IBOA mixture and exposed to light from the display, a cold fluorescent light at 380-500 lux, a warm fluorescent light at 800-900 lux, a 5000 K LED light, and sunlight. The volume of the IBOA mixture was optimized as 1000 μL for the S8 and S8+ devices. A 100 μm thick adhesive film was laminated on the periphery of the screen protector glass to control the thickness of the IBOA layer for the purposes of the test. The IBOA was demonstrated to be curable by all visible light sources. The power intensity of the light sources and the fix times are listed in Table VII. Each of the mixtures in Table VII were formed with IBOA.

TABLE VII

| | Fix Time | | | | | | | | | | |
|---|---|---|---|---|---|---|---|---|---|---|---|
| | | | Cold | | Warm | | 5000K | | | | |
| | Samsung S8 | | fluorescent | | fluorescent | | LED light | | | | Sunlight |
| | Display | | light | | light | | (4000-5000 | | UV lamp | | (8400-130000 |
| Mixture | (600 lux) | | (380 lux) | | (800-900 lux) | | lux) | | (13000 lux) | | lux) |
| 1 wt % | Not fixed in | | 30 | min | 15 | min | 22-25 | min | 5-7 | s | 5 s |
| Irgacure 819 | 60 | min | | | | | | | | | |
| 1 wt % | 3.5 | min | 10-15 | min | 5-6 | min | 7 | min | Not fixed in | | |
| Irgacure 784 | | | | | | | | | 4 min | | |
| 0.5 wt % | 6 | min | 20-25 | min | 10 | min | | | | | |
| Irgacure784 | | | | | | | | | | | |

| | | | | | | | | | |
|---|---|---|---|---|---|---|---|---|---|
| 0.1 wt % | Not fixed in | 18-20 | min | 5-6 | min | 16-17 | min | 5-7 | s |
| H-Nu640MP + | 60 min | | | | | | | | |
| 1 wt % | | | | | | | | | |
| Irgacure 819 | | | | | | | | | |

As observed by the naked eye, immediately after the application of the mixtures, a screen protector with 1 wt % Irgacure 819 does not show noticeable color deviation or reduction of transmission; a screen protector with 0.5 wt % Irgacure 784 is slightly yellow; a screen protector with 1 wt % Irgacure 784 is obviously yellow; a screen protector with 0.1 wt % H-Nu640MP and 1 wt % Irgacure 819 is obviously blue. The yellow color of the screen protector with both 0.5 wt % and 1 wt % Irgacure 784 and the blue color of the screen protector with 0.1 wt % H-Nu640MP+1 wt % Irgacure 819 are not uniform, with a more yellow/blue appearance on the sides and a less yellow/blue appearance in the center. The photobleaching of Irgacure 784 reduces the yellow color over time. Under cold fluorescent light of 380-500 lux, the color of the screen protector with 0.5 wt % Irgacure 784 was unnoticeable after 6 hours. The color of the screen protector with 1 wt % Irgacure 784 was also more uniform and lighter after 6 hours, which is acceptable for the application of a screen protector. H-Nu640MP photoinitiator photobleaches much faster than Irgacure 784. The fading of the blue color is significant within 5 min of exposure under 200 lux of Samsung S8+ display light. The polymerization reaction of IBOA monomer does not have enough time to occur before the photobleaching of H-Nu640MP. Therefore, we added both 0.1 wt % H-Nu640MP and 1 wt % Irgacure 819 to cure IBOA monomer. As shown in Table VII, the addition of 0.1 wt % H-Nu640MP to IBOA with 1 wt % Irgacure 819 significantly accelerated the polymerization reaction and decreased the fix time of IBOA under visible light sources of cold and warm fluorescent light and 5000 K LED light, even though IBOA with only 0.1 wt % H-Nu640MP but without 1 wt % Irgacure 819 cannot be fixed due to the fast photobleaching of H-Nu640MP.

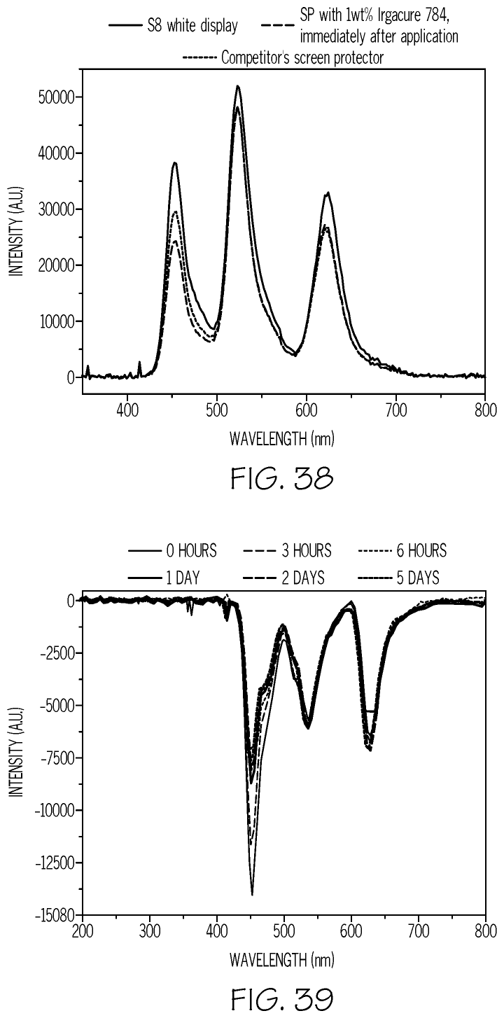

To quantify the optical effects of the visible-light photoinitiators, the spectra of a Samsung S8 and S8+ display without a screen protector and with a screen protector were measured. All the measurements were taken under the maximum brightness of the display, without auto brightness adjustment, without blue light filter, and with an integration time of 3 seconds. Each reported result was the average of 3 measured spectra. As shown in FIG. 38, the spectrum of the Samsung S8 white display (shown as square data points) has three peaks: 451 nm (blue), 523 nm (green), and 622 nm (red). With a screen protector, the intensities of all three peaks decrease. The intensities of the green and red peaks for a screen protector of the type described herein with IBOA+1 wt % Irgacure 784 are shown in FIG. 38 (shown as circular data points). A commercially available screen protector was also measured and the intensities are shown in FIG. 38 (shown as star-shaped data points). The intensity of the blue peak for the screen protector of the type described herein with IBOA+1 wt % Irgacure 784 was lower than the commercially available screen protector, correlating to the appearance of yellow color because of the absorption of light by Irgacure 784.

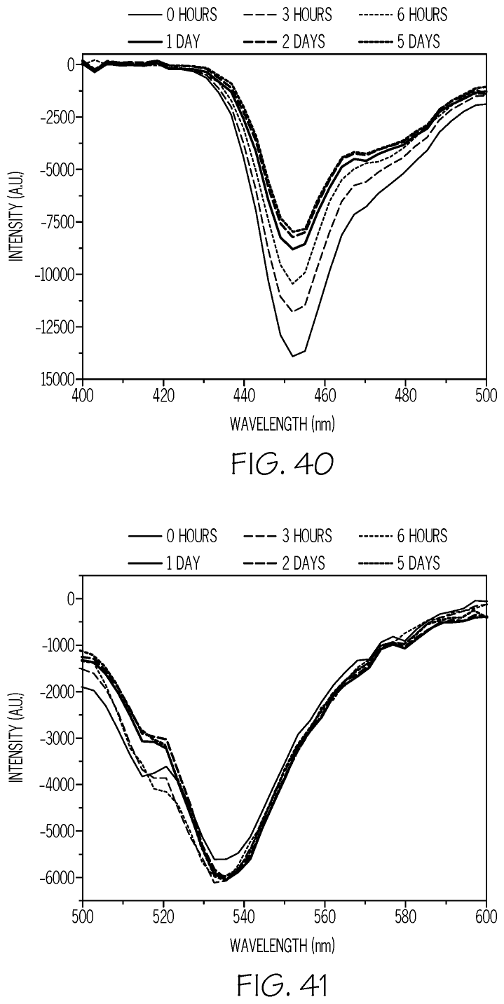

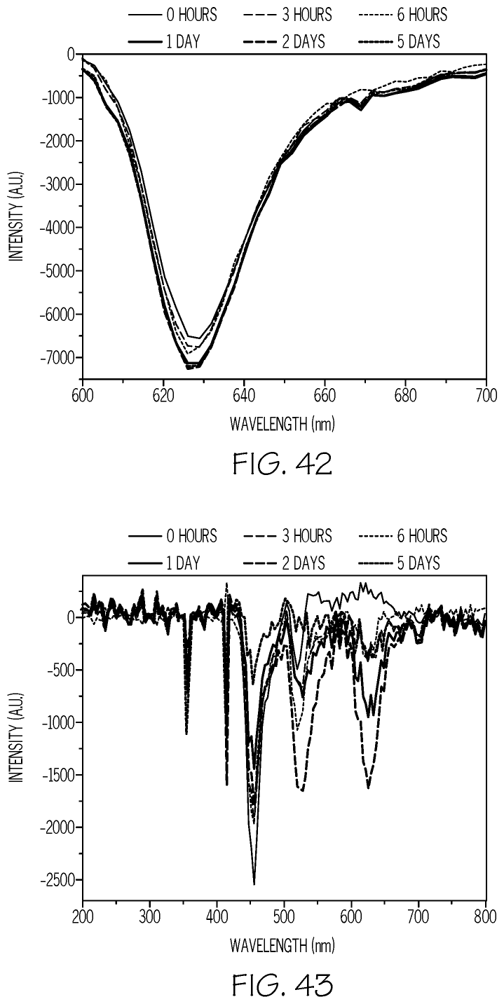

In FIG. 39, the effect of Irgacure 784 on the display spectra over time are shown by subtracting the white light display spectra without a screen protector from that with a screen protector utilizing the 1 wt % Irgacure 784 adhesive. The screen protector with 1 wt % Irgacure 784 decreased the intensity of all three peaks of the display light spectrum. The spectra shown in FIGS. 39-42 were acquired at times of 0 hours (immediately after application), 3 hours, 6 hours, 1 day, 2 days, and 5 days after application, and the intensity along the y-axis of the spectrum with a screen protector was subtracted from the spectrum without the screen protector. During the aging, the device and the screen protector were irradiated by a cold fluorescent light (380-500 lux). In FIG. 40, the intensity of the blue peak decreased with aging time under fluorescent light, which is a strong indication of photobleaching. After aging for 2 days, the display spectrum did not change significantly with time. As observed by the naked eye, after approximately 6 hours, the yellow color becomes acceptably faint and is uniform across the screen protector. After 5 days, a slight yellow color is still noticeable though not strong. In FIGS. 41 and 42, the green and red peaks increased slightly after aging. The changes of the display white spectra indicate that 1 wt % Irgacure 784 becomes increasingly clear and white under the effects of visible fluorescent light.

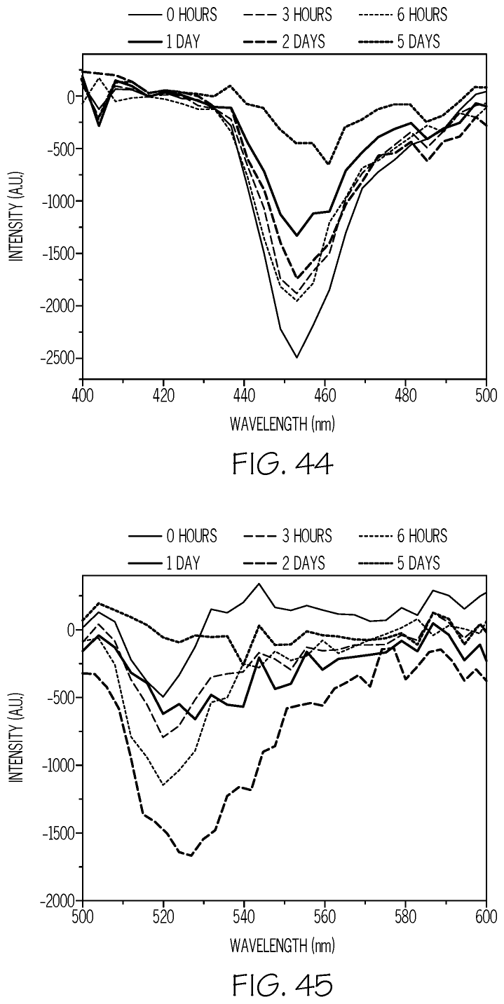

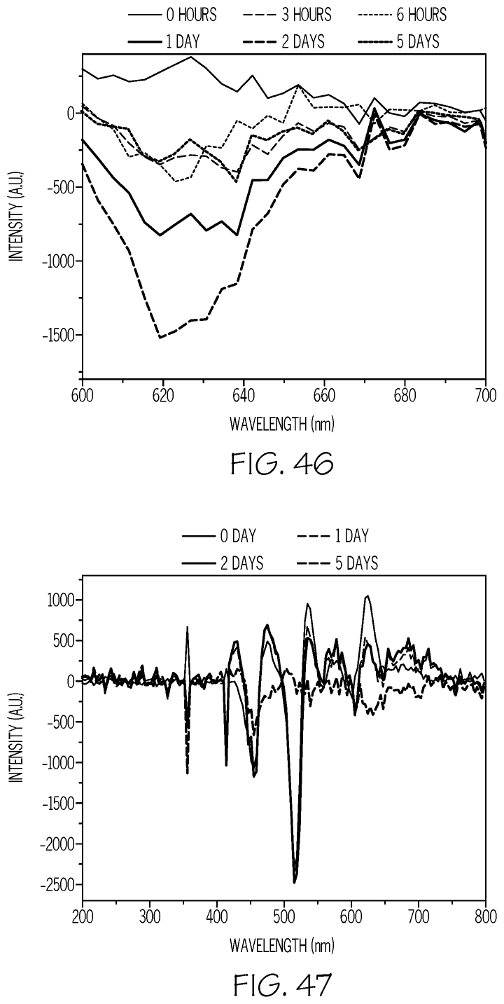

FIG. 43 shows the difference of display white spectra with and without a screen protector using IBOA+0.5 wt % Irgacure 784. The spectra shown in FIGS. 43-46 were acquired at times of 0 hours (immediately after application), 3 hours, 6 hours, 1 day, 2 days, and 5 days after application, and the intensity along the y-axis of the spectrum with a screen protector was subtracted from the spectrum without the screen protector. During the aging, the device and the screen protector were irradiated by a fluorescent light (380-500 lux). Immediately after application (0 h), the screen protector had a strong absorption in the blue wavelength as shown by the peak at 453 nm in FIG. 44. The effects of the screen protector are negligible in the green and red wavelengths immediately after application, as shown in FIGS. 45 and 46 (0 hrs). During 1 day of aging, the absorption in the blue wavelength became weaker (FIG. 44) and the absorption in the green and red wavelength became stronger (FIGS. 45 and 46). These changes in the spectra indicate that the color of the IBOA+0.5 wt % Irgacure 784 film changes from yellow/orange to slightly yellow/white. Observation also indicated that the screen protector became much less yellow without noticeable opacity or transmission haze after aging for 1 day. After aging for 2 days, the intensity of the blue peak increased slightly. The intensities of the green and red peaks also increased and became comparable with the intensity of the blue peak. After aging for 5 days, the decrease in intensity of all three peaks was very weak, indicating that the screen protector did not have a significant effect on the display white light when viewing vertically (90°) to the display after aging for 5 days.

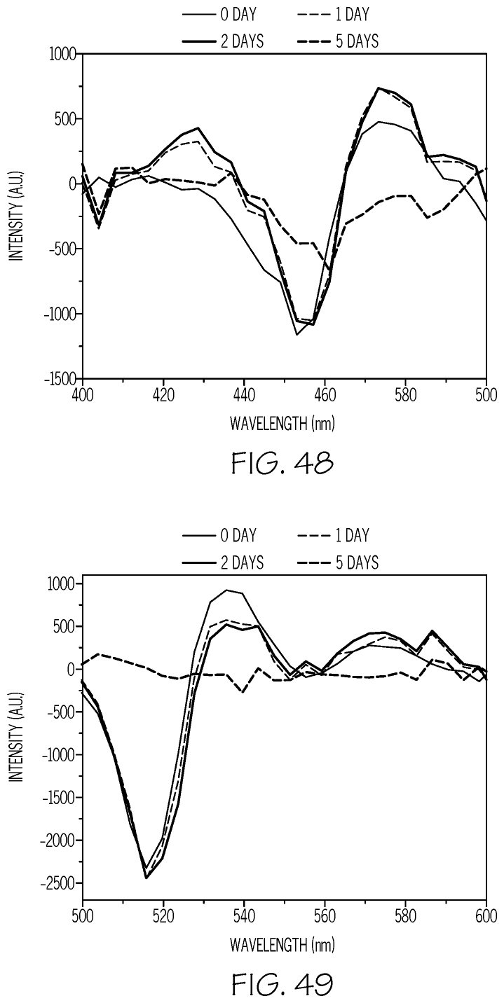

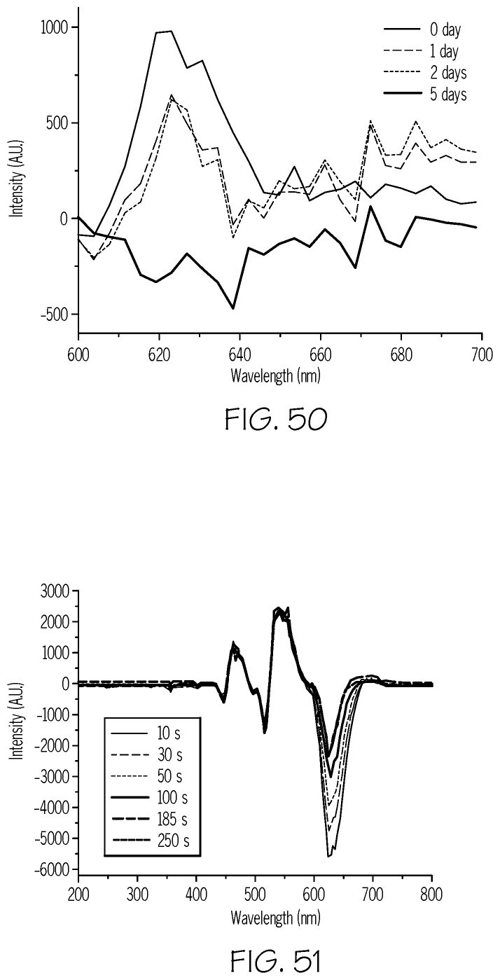

FIG. 47 shows the difference of display white spectra with and without a screen protector using IBOA+1 wt % Irgacure 819. The spectra shown in FIGS. 47-50 were acquired at times of 0 hours (immediately after application), 3 hours, 6 hours, 1 day, 2 days, and 5 days after application, and the intensity along the y-axis of the spectrum with a screen protector was subtracted from the spectrum without the screen protector. During the aging, the device and the screen protector were irradiated by a cold fluorescent light (380-500 lux). In FIG. 47, the difference of the spectra does not show three peaks in the blue, green, and red wavelengths. Therefore, a large portion of the effects may result from the layer stacks of the screen protector structure rather than the absorption of visible light by the visible-light photoinitiator. After two days of aging, the peaks of blue (around 456 nm) and green (around 517 nm) wavelengths were prominent. After aging for 5 days, the difference of the display white spectra was negligible with and without a screen protector.

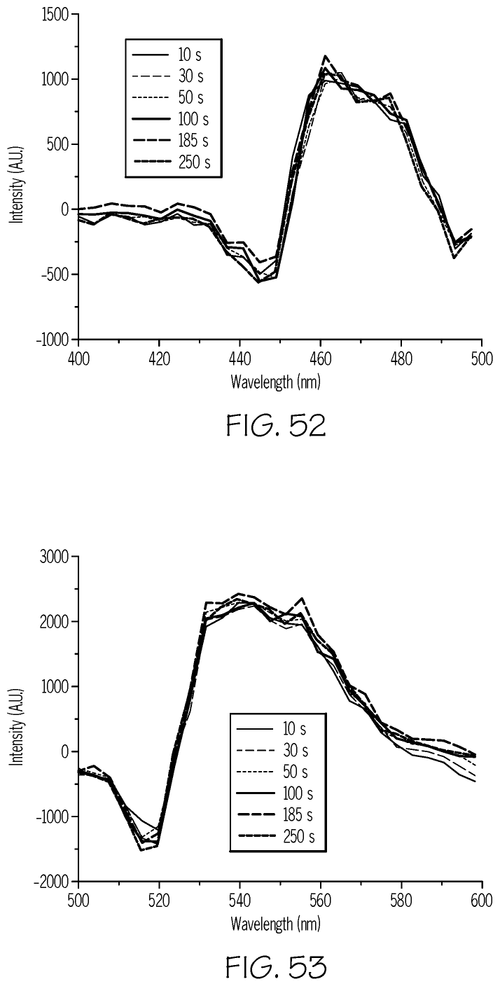

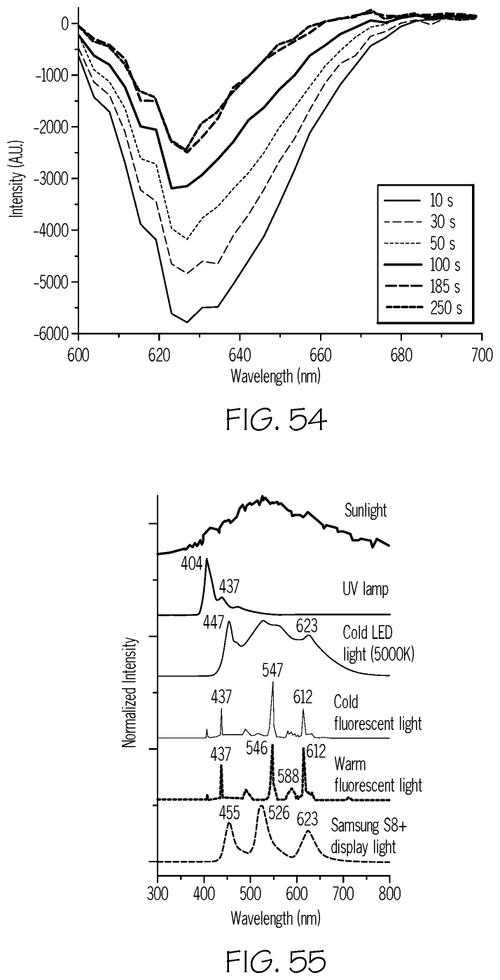

FIG. 51 shows the difference of display white spectra with and without a screen protector using IBOA+0.1 wt % H-Nu640MP+1 wt % Irgacure 819. The spectra shown in FIGS. 51-54 were acquired at times of 10 s, 20 s, 50 s, 100 s, 185 s, and 250 s after application, and the intensity along the y-axis is the spectrum without a screen protector subtracted from the spectrum with the screen protector. Due to the fast photobleaching of H-Nu640MP photoinitiator, the intensity of the display light was lowered to 200 lux. The screen protector was irradiated only by the display light during the aging. In FIG. 52 and FIG. 53, the intensities of the blue wavelength (400-500 nm in FIG. 52) and the green wavelength (500-600 nm in FIG. 53) were enhanced by the screen protector and do not vary with aging time. It shows that the changes in the intensities of blue and green wavelength ranges are due to the effect of the screen protector stack rather than the absorption of the photoinitiators. In FIG. 54, the intensity of the red wavelength (600-700 nm) was greatly reduced by the screen protector with a peak position of 626 nm, matching with the absorption peak of H-Nu640MP as reported by the vendor. The decrease of red-wavelength intensity becomes smaller as time increases from 10 s to 185 s. The intensity does not have much change after 185 s, meaning that most of the photo bleaching of H-Nu640MP happens within 3 min after application.

The spectra and the power of lighting sources used in testing were quantified. FIG. 55 shows normalized intensity spectra of the display white light of a Samsung S8+, a cold fluorescent light, a warm fluorescent light, a 5000 K light, a UV lamp, and sunlight. The sunlight spectrum covers a wide range of UV, visible, and infrared light.

The absorption spectra of Irgacure 784 and Irgacure 819 visible-light photoinitiators were measured with the cured IBOA films having different visible-light photoinitiator concentrations (0.05, 0.25, 0.50, 0.75, 1.00, and 1.25 wt %). To minimize photobleaching effects, the IBOA+Irgacure 784 solutions were cured under the warm fluorescent light (800-900 lux) and exposed for a fixed time of 30 min. IBOA+0.05 wt % Irgacure 784 cannot be cured by either fluorescent light or UV lamp within a reasonable time, and therefore is not reported in the results. The IBOA+Irgacure 819 solutions were cured under a UV lamp (1300 lux) for 4 min due to the long time required for curing under fluorescent light with Irgacure 819 concentrations lower than 1.00 wt %. The cured films were stored in a plastic bag covered by black tape to block ambient light until spectroscopic measurements could be performed.

Both transmission and reflection spectra were collected for each cured film. The transmission spectra and reflection spectra of Irgacure 784 and Irgacure 819 were characterized after minimal photobleaching. Then absorbance normalized by film thicknesses (A/l) and absorptivity were calculated from the transmission and reflection spectra.

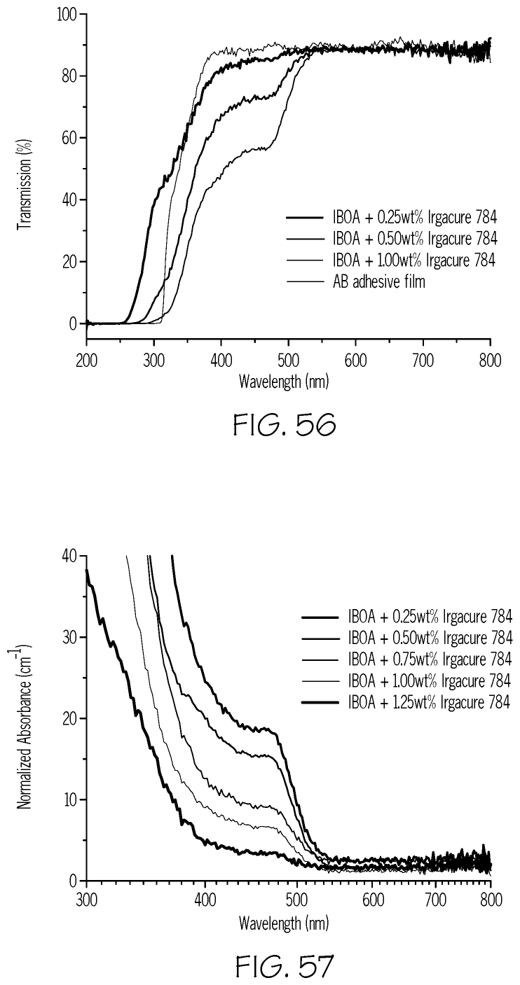

In FIG. 56 the transmission spectra of IBOA+0.25 wt %, 0.50 wt %, and 1.00 wt % Irgacure 784 are compared with a commercial solid adhesive film (RFD 450, a film commonly used in screen protector applications (i.e., the AB film having an A-side with high adhesion, a B-side with low adhesion, and a transferring layer)). The thickness of the IBOA films was 0.12-0.15 mm. The thickness of the RFD 450 film was 0.45 mm, which is the same as the typical thickness when used as a screen protector adhesive. For visible wavelengths larger than 550 nm, both IBOA films and the RFD 450 film had high transmission (87-90%). For wavelengths <450 nm, the RFD 450 film retains high transmission at wavelengths of 390-450 nm, which is almost optically clear in all the visible light wavelength range (380-750 nm). The spectra of IBOA+Irgacure 784 films are concentration dependent. With 0.25 wt % concentration of Irgacure 784, the spectrum shows high transmission (>80%) in all the wavelengths of visible light. With 0.50 wt % and 1.00 wt % Irgacure 784, the transmission drops dramatically when the wavelength is lower than 495 nm to 510 nm, indicating the absorption of visible light in the green/blue wavelengths. This absorption enables the curing of the acrylates under visible light but also leads to the yellow color of the screen protector.

In FIG. 57, the absorbance spectra of IBOA+Irgacure 784 films were normalized by the thickness of the films. Below a wavelength of 530 nm, the normalized absorbance was larger for higher concentration. In visible light wavelengths, an absorption plateau is in the range of 400-480 nm; the absorption dramatically increases in the UV wavelengths. For wavelengths >530 nm, the absorbance is almost zero for all the concentrations.

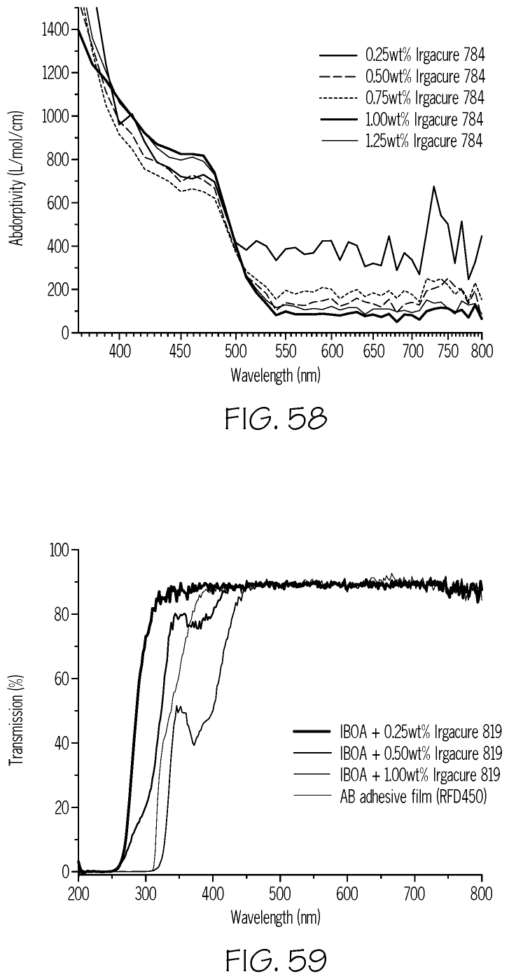

The absorptivity of Irgacure 784 was calculated as described above and is shown in FIG. 58. For wavelengths >530 nm, the absorptivity of all the concentrations was weak (80-200 L/mol/cm), except for the spectrum of 0.25 wt % Irgacure 784. The high absorptivity of 0.25 wt % Irgacure 784 is possibly due the difficulty in sample preparation with low amount of photoinitator. With a low concentration of visible-light photoinitiator, the film is hard to cure, and the thickness and surface uniformity are also hard to control, leading to lower transmission of the light. For wavelengths <530 nm, the absorptivity of all the concentrations is the same within measurement accuracy. The absorptivity increases to a plateau of 650-850 L/mol/cm at the wavelengths of 400-480 nm, then increases dramatically in the UV wavelengths.

Generally, the absorption spectra show that 0.25-1.25 wt % Irgacure 784 has a considerable absorption of the visible wavelengths of 380-530 nm. This absorption range may utilizes the 447 nm peak of an LED flashlight, the 437 nm peak of fluorescent light, and the 455 nm peak of the Samsung S8+ display light. Irgacure 784 thus enables curing under different visible light sources. However, IBOA+1 wt % Irgacure 784 cannot be fixed by the UV lamp as shown in Table III. Even though Irgacure 784 has a strong absorption in the peak wavelengths of 404 and 437 nm of the UV lamp (FIG. 55), it photobleaches within several seconds under the strong radiation of the UV lamp. The time of photobleaching is not sufficient for the curing of IBOA.

In FIG. 59, the transmission spectra of IBOA+0.05 wt %, 0.50 wt %, and 1.00 wt % Irgacure 819 are compared with the RFD 450 film. The thickness of all the IBOA films was 0.2 mm. The thickness of the RFD 450 film was 0.45 mm. For visible wavelengths >450 nm, both IBOA films and the RFD 450 film have high transmission of 85-90%. For wavelengths <450 nm, the RFD 450 film retains the high transmission in the wavelengths of 390-450 nm, which is almost optically clear in all the visible light wavelength range (380-750 nm). The spectrum of IBOA+Irgacure 819 film is concentration dependent. With a 0.05 wt % concentration of Irgacure 819, the spectrum shows high transmission at wavelengths larger than 330 nm, which is optically clear in all the visible light wavelengths. With 0.50 wt % and 1.00 wt % Irgacure 819, the transmission drops when the wavelength is lower than 420 nm and 450 nm, indicating the absorption of visible light in the blue wavelengths. This absorption enables the curing of the acrylates under visible light but also leads to the slight yellow color of the screen protector.

In FIG. 60, the absorbance of IBOA+Irgacure 819 films was normalized by the thickness of the films. As shown in FIG. 60, 0.05 wt % Irgacure 819 has almost zero absorbance in the visible light range. The normalized absorbances of 0.25 wt %, 0.50 wt %, and 0.75 wt % Irgacure 819 are slightly different in the range of 3-7 cm⁻¹. The normalized absorbance of 1 wt % Irgacure 819 is much higher, which is around 17 cm⁻¹. The normalized absorbance of 1.25 wt % Irgacure 819 is high due to the high concentration, which is around 20 cm⁻¹. Close to the visible light wavelength range, the absorbance is in the wavelength of 350-440 nm with a peak of 375 nm. For all the concentrations other than 0.05 wt %, Irgacure 819 has large absorbance in the UV wavelengths (<380 nm).

The calculated absorptivity of Irgacure 819 is shown in FIG. 61, which is also concentration dependent. The film with 0.05 wt % Irgacure 819 has almost zero absorptivity at wavelengths >370 nm. The absorptivity of 0.25 wt %, 0.50 wt %, and 0.75 wt % Irgacure 819 is the same, within the error of the measurement. The absorptivity spectra have a peak in the wavelengths <440 nm with a center at 374 nm. The highest absorptivity is 370±30 L/mol/cm. The absorptivity of 1.00 wt % and 1.25 wt % Irgacure 819 is the same, within the error of the measurement. The shape of the absorptivity curve of 1.00 wt % and 1.25 wt % is similar to that of 0.25 wt %, 0.50 wt %, and 0.75 wt % Irgacure 819, but the peak value of absorptivity is much higher. The peak location is still around 374 nm with the highest absorptivity of 700±40 L/mol/cm. Given the shifts of the absorbance and absorptivity as a function of concentration, it is reasonable to infer that Irgacure 819 molecules may form dimers/aggregates as the concentration increases. The interaction of the molecules shifts the absorption spectra of the liquid adhesive solution and the cured adhesive film.

Based on the absorption spectra, the concentrations of Irgacure 819<1 wt % are not recommended for curing under visible light due to the lack of absorption in the wavelengths >380 nm. But, they can be cured by sunlight or a UV lamp with enough UV range. The concentrations of Irgacure 819≥1 wt % are recommended for screen protector applications cured under visible light because they have enough absorption of light with wavelengths <440 nm. Based on the light source spectra shown in FIG. 55, concentrations of Irgacure 819≥1 wt % can effectively utilize the sunlight, 404 nm and 437 nm peaks of a UV lamp, partially utilize the 447 nm peak of an LED flashlight, and the 437 nm peak of fluorescent light. The matching of light source spectra and the absorption spectra of Irgacure 819 explains the slow curing speed in Table VII compared to Irgacure 784. Fast cure is observed with sunlight, the UV lamp, and the LED flashlight, the spectra of which match best with the absorption spectra of Irgacure 819. The display light of the Samsung S8+ is not effective to cure IBOA with >1 wt % Irgacure 819 because the 455 nm peak cannot be utilized by the absorption of Irgacure 819.

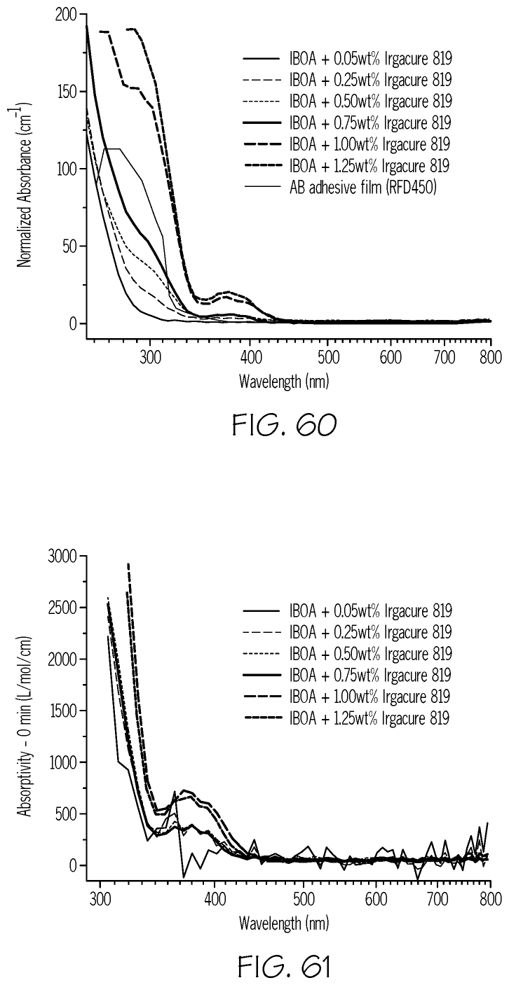

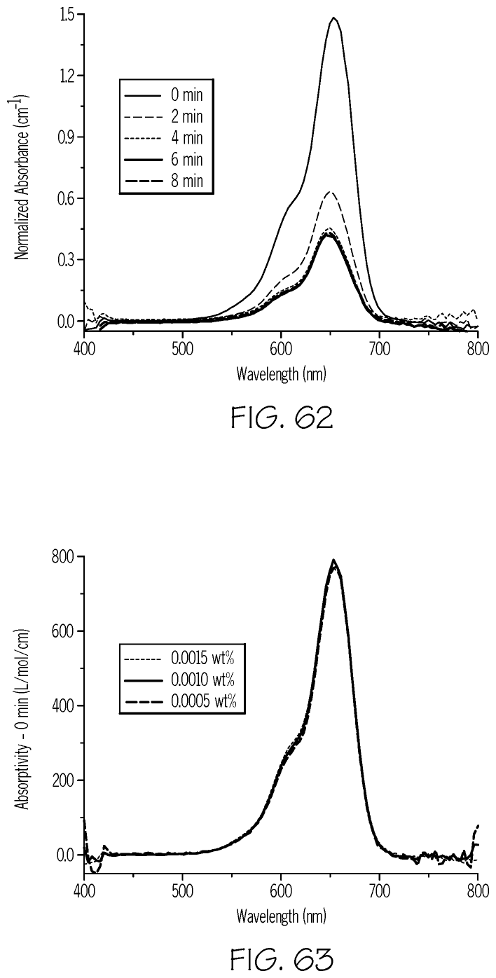

Due to the fast photobleaching of H-Nu640MP photoinitiator, the absorbance and absorptivity of H-Nu640MP cannot be measured by cured IBOA films with different H-Nu640MP concentrations. Instead, we filled solutions of H-Nu640MP dissolved in IBOA in cuvettes with a path length of 1 cm and measured the transmission spectra using a 5000 K LED light as the light source. The concentration of H-Nu640MP is diluted to 0.0005-0.005 wt %. The solutions do not contain Irgacure 819. A blank sample is pure IBOA filled in the cuvette with path length of 1 cm. In FIG. 62, the absorbance spectra of IBOA with 0.0015 wt % H-Nu640MP are present based on the calculation from the measured transmission spectra. The absorbance is shown as a function of time after the solution was exposed under the 5000 K LED light. All the spectra show a peak of about 650 nm and a shoulder of about 570-622 nm. The photobleaching (decrease in the height of the 650 nm peak) is significant in the first 4 min after exposure to the light. After 4 min, the absorbance spectra do not change with time. However, H-Nu640MP is not completely optically clear after photobleaching, since the absorption spectra after 4 min exposure time still show a peak at about 650 nm. The solution also still showed a slight blue color after 4 min exposure time.

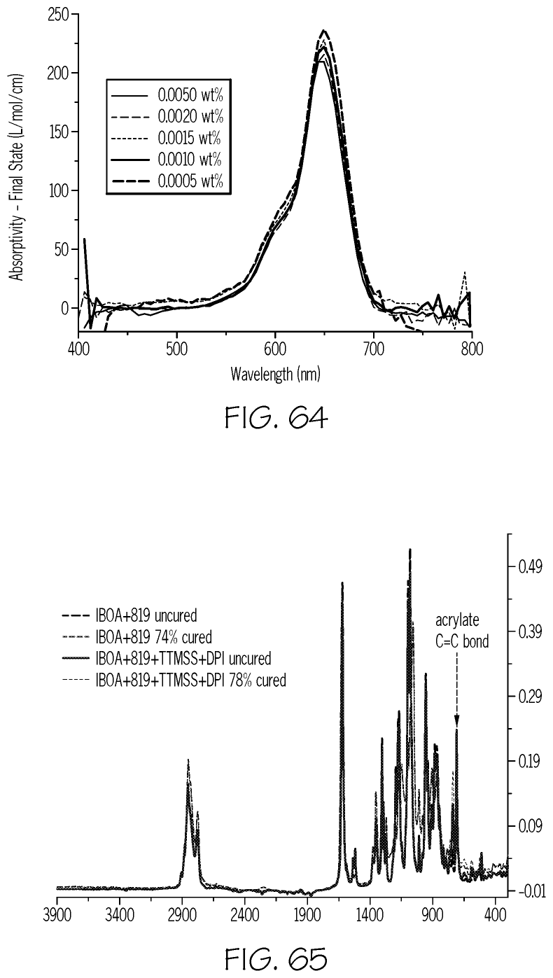

The absorptivity of H-Nu640MIP was calculated at an exposure time of 0 min (within 10 s of exposure to 5000 K LED light, presented in FIG. 63) and at the time after complete photobleaching (FIG. 64). The absorptivity spectra of different concentrations of H-Nu640MP overlap since the absorptivity is independent of concentration. In FIG. 63, the absorptivity at the peak of 653 nm is around 770-795 L/mol/cm for all the concentrations at exposure time 0 min. In FIG. 64 after complete photobleaching, the absorptivity at the peak of 650 nm is about 210-240 L/mol/cm.

### Example 3—Addition of Co-Initiators and Oxygen Inhibitors

Table VIII lists visible-light photoinitiators, co-initiators, and oxygen inhibitors used in experimental tests and their properties. Visible-light photoinitiators in Table VIII are commercially available as Irgacure 819 and Irgacure 784, and the absorption peaks reported in Table VIII were reported by the vendors. Two of the co-initiators in Table VIII are commercially available as DPI-PF₆ and SpeedCure 938, and the absorption peaks reported in Table VIII were reported by the vendors. Table IX lists acrylate monomers and oligomers used in experimental tests and their properties. Table X lists LOCA formulations comprising IBOA and 1 wt % Irgacure 819, different co-initiators, oxygen inhibitors, co-monomers, and cross-linkers.

TABLE VIII

| | | | UV/vis |
|---|---|---|---|
| | | | absorption peaks |
| | | | given by vendors |
| Materials | Chemical identity | Appearance | (nm) |
| Irgacure 819 | Phosphine oxide, phenyl bis (2,4,6- | Light yellow | 295, 370 in |
| | trimethyl benzoyl) | powder | methanol |
| Irgacure 784 | Bis (eta 5-2,4-cyclopentadien-1-yl) Bis | Orange powder | 398, 470 in |
| | [2,6-difluoro-3-(1H-pyrrol-1-yl) | | methanol |
| | phenyl]titanium | | |
| DPS | Diphenylsilane | Transparent | |
| | | liquid | |
| TTMSS | Tris(trimethylsilyl)silane | Transparent | |
| | | liquid | |
| DPI-PF₆ | Diphenyliodonium hexafluorophosphate | White powder | 225 in CH₂Cl₂ |
| SpeedCure | Bis(4-t-butylphenyl)iodonium | White powder | 241 |
| 938 | hexafluorophosphate | | |
| DMAPDP | 4-(dimethylamino)phenyl | White powder | |
| | diphenylphosphene | | |
| TPn | Triphenylphosphine | White powder | |

TABLE IX

| | | | Cure mechanism |
|---|---|---|---|
| | | Viscosity | (with visible light |
| Materials | Chemical composition | (cps) | photoinitiator) |
| IBOA (monomer) | IBOA (isobornyl acrylate) monomer | 6-10 | Radical |
| Miramer M120 | LA-C_{12,13} (lauryl acrylate) monomer | 5-15 | Radical |
| Miramer M4004 | PEOTA (pentaerythritol (EO)ₙ tetraacrylate) | 120-200 | Radical |
| | crosslinker | | |
| TEGO Rad | TR2200N (siliconepolyether acrylate) | 700-2500 | Radical |
| 2200N | monomer | | |
| TEGO Rad 2500 | TR2500 (polydimethylsiloxane acrylate) | 150 | Radical |
| | monomer | | |
| TEGO Rad 2650 | TR2650 (polysiloxane acrylate) monomer | 300-600 | Radical |
| ParB66 | PARALOID ™ B-66 100% resin, acrylic | solid | Radical |
| | copolymer resin | | |

TABLE X

| | DPS | TTMSS | DPI-PF₆ | DMAPDP | TPn | LA-C_{12,13} |
|---|---|---|---|---|---|---|
| Sample | (wt %) | (wt %) | (wt %) | (wt %) | (wt %) | (wt %) |
| 1 | | | | | | |
| 2 | | 3 | 2 | | | |
| 3 | 1 | | 0.5 | | | |
| 4 | 1 | | 0.5 | 1 | | |
| 5 | | | | 0.5-1 | | |
| 6 | | | | | | 10 |
| 7 | | | | | | |
| 8 | | | | | | |
| 9 | | | | 1 | | 10 |
| 10 | | | | 1 | | |
| 11 | | | | 1 | | |
| 12 | | | | | | |
| 13 | | | | 1 | | |
| 14 | 1 | | 0.5 | 0.5 | | |
| 15 | 1 | | 0.5 | 0.5 | | |
| 16 | | | | | 1 | |

| | | | | Observed | |
|---|---|---|---|---|---|
| | PEOTA | TR2200N | ParB66 | Fix time | Shrinkage |
| Sample | (wt %) | (wt %) | (wt %) | (min) | (wt %) |
| 1 | | | | 17-23 | 6-8 |
| 2 | | | | 9 | 0.5-2.1 |
| 3 | | | | 14 | 2.8-4.0 |
| 4 | | | | 2.7 | 0.7-2.2 |
| 5 | | | | 4-6 | 1.6-1.9 |
| 6 | | | | 16-17 | 5.1 |
| 7 | 10 | | | 9-15 | 2.9 |
| 8 | | 1 | | 15 | 4.3 |
| 9 | | | | 6 | 1.6-1.8 |
| 10 | 10 | | | 4 | 1.8-2.1 |
| 11 | | 1 | | 6 | 1.1-1.3 |
| 12 | | | 1 | 17 | 2.6-3.3 |
| 13 | | | 1 | 6.5 | 1.9 |
| 14 | | | 2.5 | 3.0-3.2 | 1.1-1.8 |
| 15 | | | 4.5 | 2.9-3.1 | 0.7-1.8 |
| 16 | 10 | | | 3-4 | |

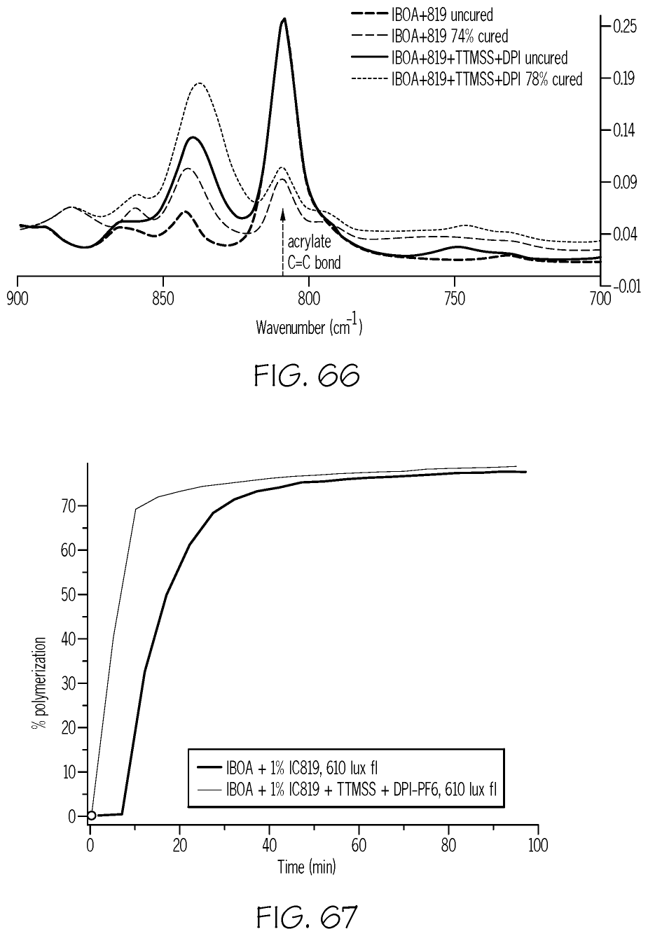

To demonstrate polymerization by visible light, the LOCA formulations of Table X were placed by pipette onto an attenuated total reflection (ATR) window of a Fourier transform infrared (FTIR) spectrophotometer and covered with screen protector glass in the dark. As shown in FIGS. 65 and 66, a first FTIR spectrum was recorded for Samples 1 and 2 prior to being exposed to light (shown as IBOA+819 uncured and IBOA+819+TTMSS+DPI uncured, respectively, in FIGS. 65 and 66). The time before the LOCA was exposed to light was defined as time zero (i.e., the time without initiation of polymerization).

Further spectra were recorded at regular intervals while Samples 1 and 2 were exposed to visible light at 510-675 lux above the screen protector glass to initiate polymerization (shown as IBOA+819 cured and IBOA+819+TTMSS+DPI cured, respectively, in FIGS. 65 and 66). FIG. 67 shows the percent of the polymerization as a function of time of Sample 1 and Sample 2 in 610 lux fluorescent light as measured under a 430-μm-thick glass screen protector with a 75-μm-thick decoration film. During the screen protector application, the indicated observed fixed time is the time when the screen protector is bonded by LOCA onto the cover glass and no uncured adhesive composition is observed to leak from the edges of the screen protector glass. The observed fixed time shown in Table X was measured for LOCA placed between screen protector glass and cover glass, on a white background, and under fluorescent lights (380 lux). After the observed fixed time, the electronic device is ready to use normally, but the ultrasonic FPS is not fully functional. The indicated observed cured time is defined as the time that the ultrasonic FPS is fully functional for both registration and unlocking. Note that “observed fixed time” and “observed cured time” were based on visual observations and do not redefine the phrases “fixed adhesive composition” and “cured adhesive composition” described herein.

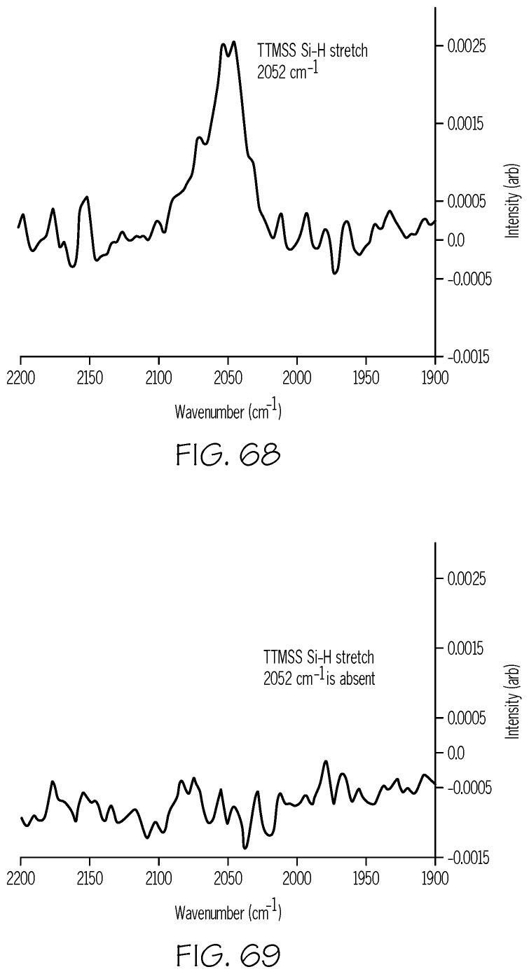

As illustrated in Table X, Sample 1 (only IBOA and 1 wt % of Irgacure 819) had the longest fix time of 17-23 minutes. Sample 2 (addition of 2 wt % DPI PF₆ and 3 wt % TTMSS) resulted in a decrease in fixing time of about 50% as compared to Sample 1. Sample 3 (addition of 0.5 wt % DPI PF₆ and 1 wt % DPS) resulted in a decrease in fixing time of about 25% as compared to Sample 1. While not wishing to be bound by theory, it is believed that the accepted mechanism of action for this co-initiator system is as follows:

$$D {\to }^{light} {D}^{*} \\ {D}^{*} + D P {I}^{+} \to {D}^{. +} + P h I + P {h}^{\cdot } \\ P {h}^{\cdot } + {R}_{3} S i H \to {R}_{3} S {i}^{\cdot } + P h H \\ {R}_{3} S {i}^{\cdot } + {O}_{2} \to {R}^{′} O {O}^{\cdot } \\ {R}^{′} O {O}^{\cdot } + {R}_{3} S i H \to {R}_{3} S {i}^{\cdot } + H {O}_{2}^{\cdot } \\ {R}_{3} S {i}^{\cdot } + D P {I}^{+} \to {R}_{3} S {i}^{+} + P h I + {Ph}^{\cdot }$$

where D is the dye molecule (i.e., Irgacure 819), D* is the excited state of D when activated by light, DPI⁺ is the cation of the iodonium salt, PhI is phenyl iodide, Ph is a phenyl radical, PhH is phenyl hydride, R₃SiH is the silane, R₃Si is the silyl radical after donating a hydrogen atom, and R′OO. is the oxidized silyl radical. Analysis by FTIR showed that TTMSS acted as a hydrogen-atom-donor co-initiator during the LOCA polymerization, as indicated by the disappearance of its Si—H bond, which has a stretching vibration mode at 2052 cm⁻¹ (FIGS. 68 and 69). Specifically, FIG. 68 shows the Si—H stretch vibration of TTMSS at 2052 cm⁻¹, obtained by subtracting the spectrum of uncured Sample 1 (i.e., IBOA+1 wt % Irgacure 819) from the spectrum of uncured Sample 2 (i.e., IBOA+1 wt % Irgacure 819+2 wt % DPI PF₆+3 wt % TTMSS). FIG. 69 shows the absence of the Si—H stretch vibration of TTMSS at 2052 cm⁻¹, obtained by subtracting the spectrum of cured Sample 1 (IBOA+1 wt % Irgacure 819) from the spectrum of cured Sample 2 (IBOA+1 wt % Irgacure 819+2 wt % DPI PF₆+3 wt % TTMSS) (the time during which the samples were exposed to visible light was greater than 90 minutes for both spectra).

The addition of 1 wt % DMAPDP as exemplified in Samples 4, 5, 9-11, and 13 or 1 wt % TPn as exemplified in Sample 16 decreased the fixing time by approximately 75% as compared to Sample 1 (i.e., the fixing speed increased by a factor of about 4). FIG. 70 shows the percent of the polymerization as a function of time of Sample 5 in 510 lux fluorescent light under a 250-μm-thick glass screen protector with a 27-μm-thick decoration film.

As exemplified, the addition of a co-initiator and an oxygen inhibitor decreased the fixing time of the uncured adhesive composition.

Note that the fixing times in Table X and FIGS. 67 and 70 cannot be compared directly for two reasons: (i) the illuminance (lux) of fluorescent light was different between the three measurement locations; and (ii) the data in Table X were for LOCA fixed on transparent cover glass on a white background, whereas the data in FIGS. 66 and 69 were for LOCA fixed directly on the attenuated total reflection window of an FTIR spectrophotometer.

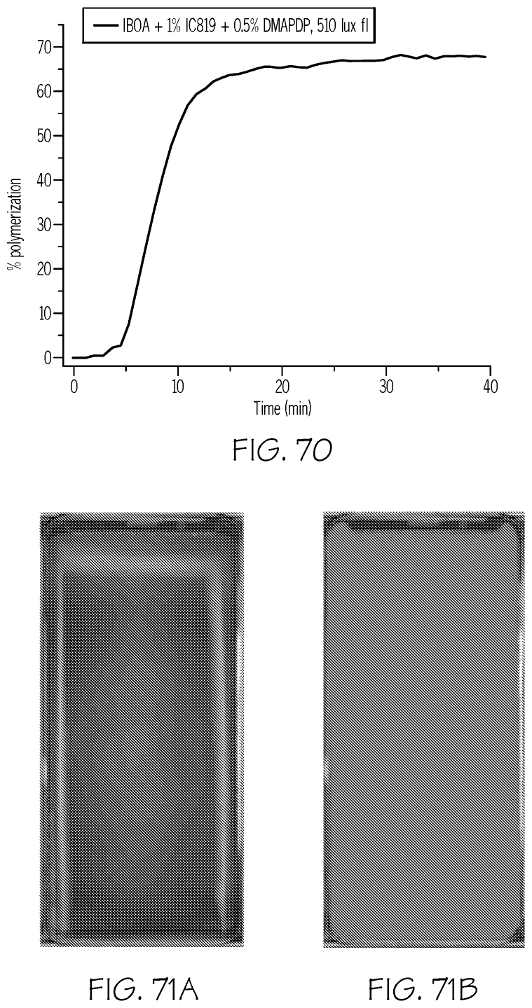

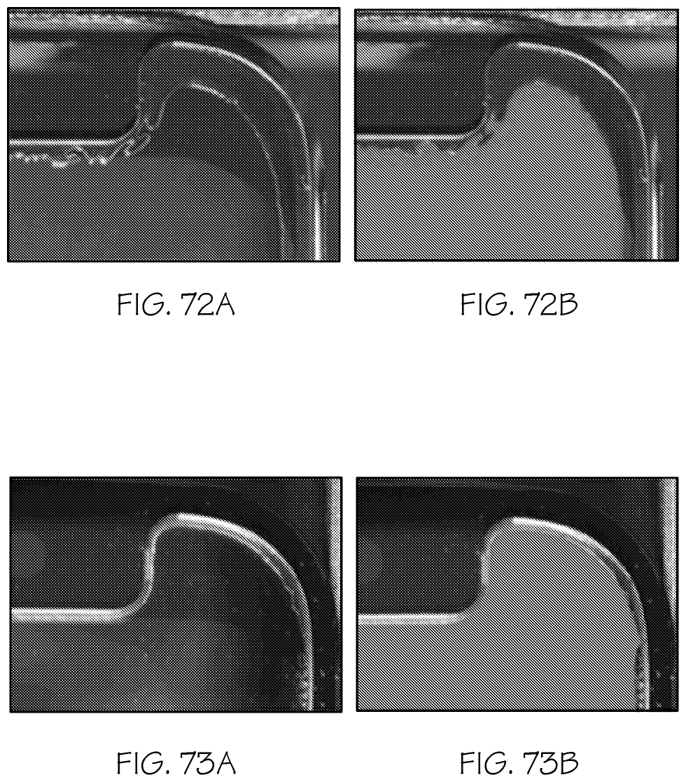

FIGS. 71A, 71B, 72A, 72B, 73A, and 73B are high-resolution photographs that illustrate the shrinkage of the cured IBOA-based LOCA described herein. FIGS. 71A, 71B, 72A, and 72B show Sample 1 of Table X seven days after being applied. FIGS. 73A and 73B shows Sample 5 of Table X eleven days after being applied. Each photograph was mapped, and the area occupied by LOCA was compared to the area occupied by the screen protector. The following equation was used to calculate the percent areal shrinkage in Table X:

$$\% areal shrinkage = \frac{{a}_{0} - {a}_{1 j}}{{a}_{0}} \times 100 \%$$

where a₀ is the area of the cover glass occupied by LOCA at time zero, which is generally the area of the screen protector glass when enough LOCA has been applied to the cover glass to spread all the way to the edges, and aₜ is the area of the cover glass occupied by LOCA at time t, typically measured in hours or days. Areal shrinkage is a good representation of the volume shrinkage of cured LOCA because the thickness of the LOCA layer between the screen protector glass and the cover glass is well controlled by controlling the volume of uncured LOCA applied and the area that the uncured LOCA spreads, which is the area of the screen protector glass.

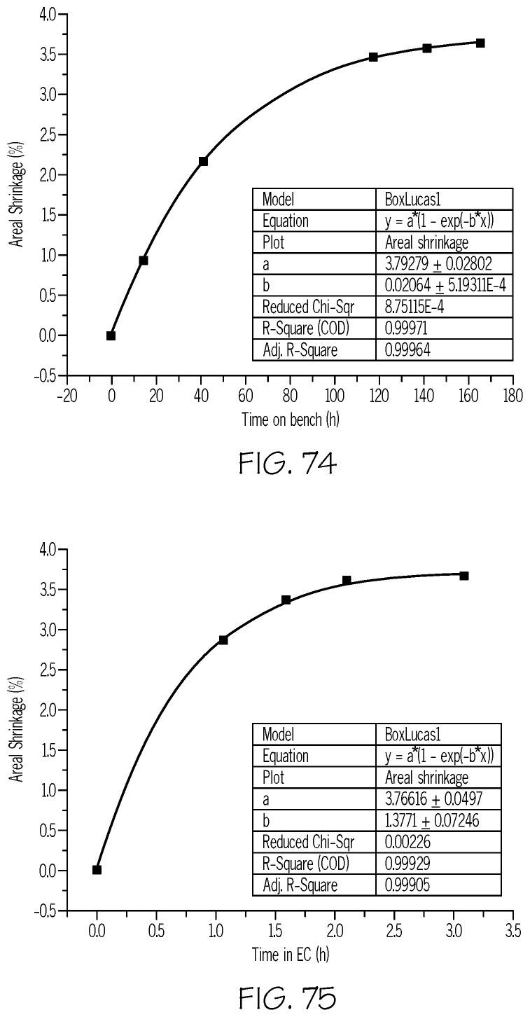

Table X shows the final percentage areal shrinkage for samples that had cured at room temperature and 50% relative humidity for more than 14 days, at which point the shrinkage of cured IBOA appeared to plateau. To accelerate the shrinkage for easier measure, sister samples were exposed to 80° C. and 50% relative humidity in an environmental chamber. FIGS. 74 and 75 compare the time evolution of the percentage areal shrinkage of Sample 1 at room temperature and 50% relative humidity to Sample 1 at 80° C. and 50% relative humidity in an environmental chamber. Fitting the shrinkage data to an exponential plateau function leads to a rate of shrinkage (FIG. 68) that is 60 to 70 times as fast at 80° C. as it is at room temperature. Thus, shrinkage of LOCA at 80° C. and 50% relative humidity for one hour is equivalent to shrinkage of LOCA at room temperature for approximately 2.8 days. Accordingly, 14 days of shrinkage at room temperature may be reproduced by approximately 5 hours of shrinkage in an environmental chamber at 80° C. and 50% relative humidity.

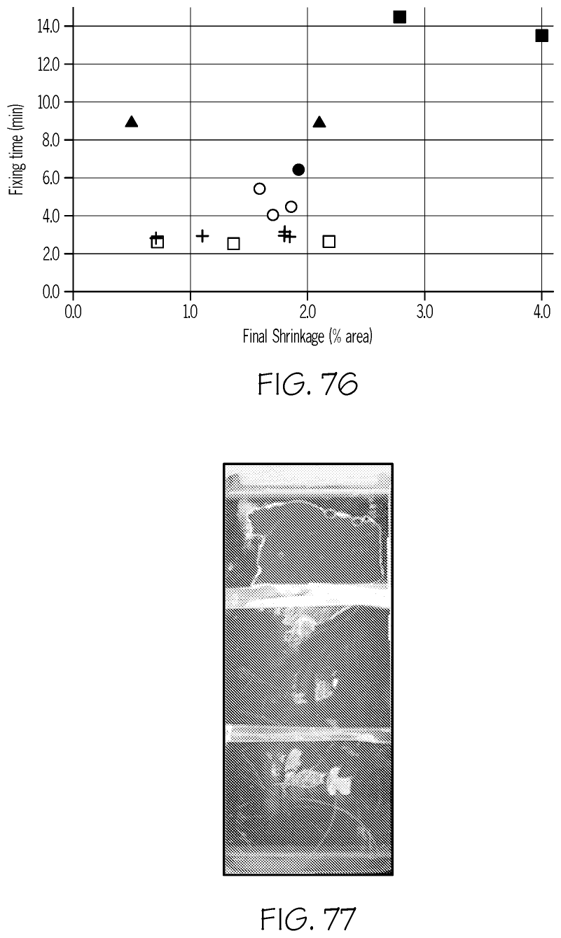

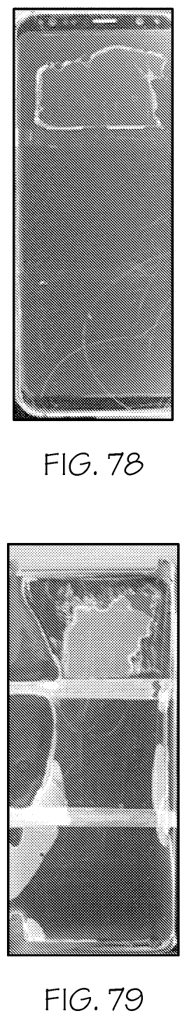

As shown in Table X, the addition of a co-initiator system decreased the shrinkage of the cured LOCA. The addition of 2 wt % DPI PF₆ and 3 wt % TTMSS of Sample 2 resulted in a decrease in shrinkage of about 80% as compared to Sample 1. The addition of 0.5 wt % DPI PF₆+1 wt % DPS of Sample 3 resulted in a decrease in shrinkage of about 50% as compared to Sample 1. As shown in FIG. 76, the decrease in shrinkage correlated with the decrease in fixing time, with greater decrease in shrinkage corresponding to greater decrease in fixing time.

As shown in Table X, the addition of 1 wt % DMAPDP (i.e., an oxygen inhibitor) of Sample 5 resulted in a decrease in shrinkage of about 75% as compared to Sample 1. Addition of 1 wt % DMAPDP to a formulation that also contained 0.5 wt % DPI PF₆ and 1 wt % DPS as in Sample 4 results in a further decrease in shrinkage of 50-60% beyond that of a formulation with 0.5 wt % DPI PF₆ and 1 wt % DPS alone as in Sample 3.

The addition of 1 wt % ParB66, a pre-cured acrylic co-oligomer, as in Sample 12 did not change the fixing time significantly, but the shrinkage decreased by about 60% compared to that of IBOA and 1 wt % Irgacure 819 alone as in Sample 1. Addition of ParB66 had no significant additional effect on fixing time or shrinkage, however, when added to formulations that contained co-initiators or oxygen inhibitors (see Table X).

To determine if cured LOCA formulations described herein left residue upon removal of the screen protector from the cover glass, samples were aged for 4 days in an environmental chamber at 80° C. and 50% relative humidity. Specifically, as shown in FIGS. 77-80, prior to applying the LOCA, the device cover glass had been sectioned off with 100-μm-thick double-stick tape into three sections. Table XI shows the uncured adhesive composition formulations of Table 10 added to the various sections of the device cover glass prior to application of the cover glass.

TABLE XI

| Cover Glass | Top | Middle | Bottom |
|---|---|---|---|
| FIG. 70 | Sample 1 | Sample 7 | Sample 10 |
| FIG. 71 | Sample 1 | Sample 7 | Sample 10 |
| FIG. 72 | Sample 1 | Sample 8 | Sample 11 |
| FIG. 73 | Sample 1 | Sample 8 | Sample 11 |

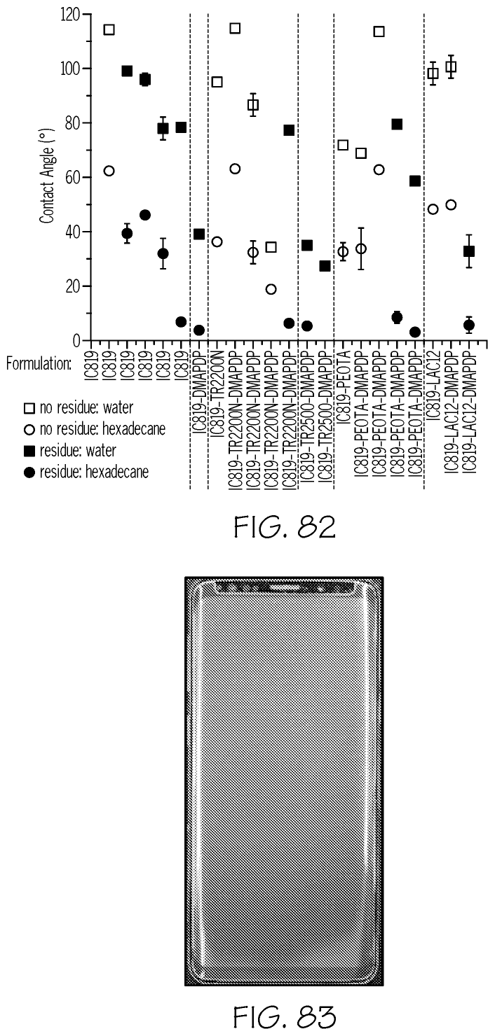

To quantify the degradation of the cover glass ETC layer after removal of the screen protector, the contact angles of both water (CA_{H}_{₂}_{O}) and hexadecane (CA_{HD}) were measured on the cover glass as shown in FIGS. 81 and 82. Specifically, the degradation of the ETC layer was quantified by measuring the contact angle for 2 μL drops of water (CA_{H}_{₂}_{O}, squares) and hexadecane (CA_{HD}, circles) on the surface of the cover glass.

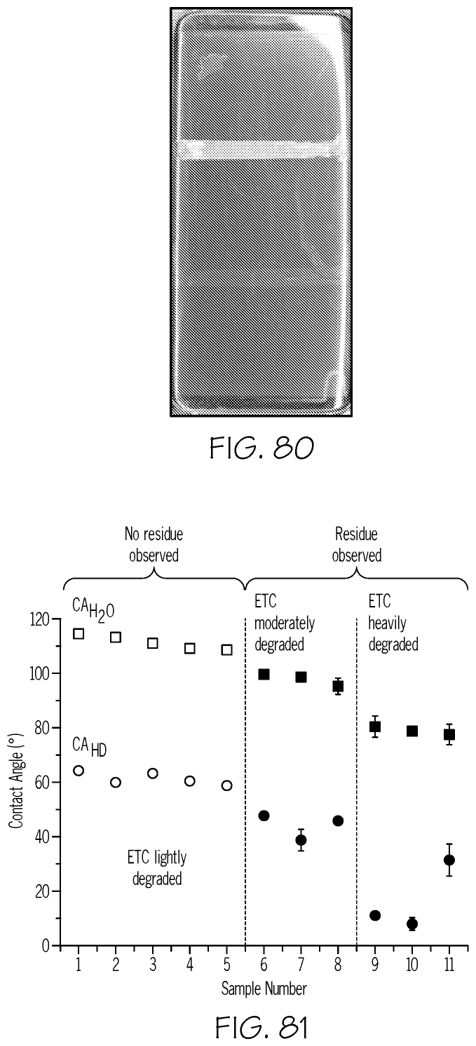

The top sections of FIGS. 78 and 80 show that a formulation with a visible-light photoinitiator but no other additives (i.e., Sample 1, IBOA with 1 wt % Irgacure 819), left visible residue on the cover glass when CA_{H2O}<1080 and CA_{HD}<60°, which was defined as a cover glass bearing a moderately or heavily degraded ETC layer. No visible residue remained for this formulation on a cover glass bearing pristine ETC layers or lightly degraded ETC layers.

Various additives may prevent this visible residue for all but the most heavily degraded ETC layers, which had a CA_{HD}<10° (FIG. 82). The hexadecane contact angle was a stronger driver than CA_{H}_{₂}_{O} for determining whether LOCA residue would remain on the cover glass. All formulations left visible residue on the cover glass when CA_{HD}<10°, regardless of CA_{H}_{₂}_{O}. Formulations containing a surfactant (e.g., 1 wt % TR2200N, which is an acrylate with a silicone polyether side chain), with (FIG. 80, bottom) or without (FIG. 80, middle) an oxygen inhibitor (e.g., 0.5-1 wt % DMAPDP), prevented residue when CA_{H}_{₂}_{O}>340 and CA_{HD}>19°. Formulations containing a crosslinker (e.g., 10 wt % PEOTA, which has four acrylate side chains), with (FIG. 78, bottom) or without (FIG. 78, middle) an oxygen inhibitor, prevented residue when CA_{H}_{₂}_{O}>690 and CA_{HD}>33°. A 12-carbon aliphatic acrylate, LA-C₁₂, with or without an oxygen inhibitor, also prevented residue when CA_{H}_{₂}_{O}>980 and CA_{HD}>48°. Table X shows that these surfactant, crosslinker, and aliphatic additives slightly decreased both the fixing time and shrinkage of the LOCA when used without an oxygen inhibitor; they had a small but insignificant effect on fixing time and shrinkage when used with an oxygen inhibitor.

### Example 4—Adhesive Belt

To demonstrate the effectiveness of the screen protector system, experimental tests were performed on commercially available mobile phones. The glass-substrates utilized in the examples have a thickness of 0.33 mm and included a two-layer anti-splinter film with a total thickness of 0.075 mm. The adhesive belt had a thickness of 0.10 mm and was in the form of a three-layer film applied as a belt near the periphery of the glass-based substrate. In examples containing channels in the adhesive belt, the channels were cut through the entire thickness of the adhesive belt and had a width of 10 mm. The liquid optically clear adhesive utilized to form the cured adhesive composition was isobornyl acrylate containing 1 wt % of commercially available visible-light photoinitiator Irgacure 819, and had a viscosity in the range of 7 to 10 cps.

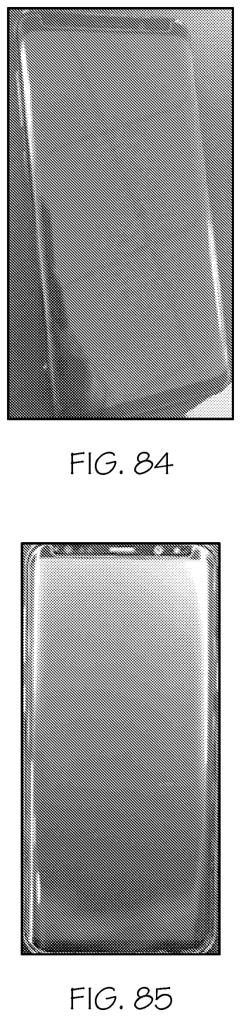

FIG. 83 shows a screen protector according to Example 4A, applied with the first adhesive belt but without application of the adhesive composition. The optical performance is not satisfactory, with a hazy effect observed and a rainbow-like interference pattern when viewed at an angle, as shown in FIG. 84. The screen protector of FIGS. 83 and 84 is comparable to screen protectors that include an adhesive belt near the periphery and an air gap in the central region over the display.

FIG. 85 shows a screen protector according to Example 4B, using the liquid optically clear adhesive but without the adhesive belt. The screen protector appears optically clear but has noticeable leakage during the application process, as reported in Table XII below.

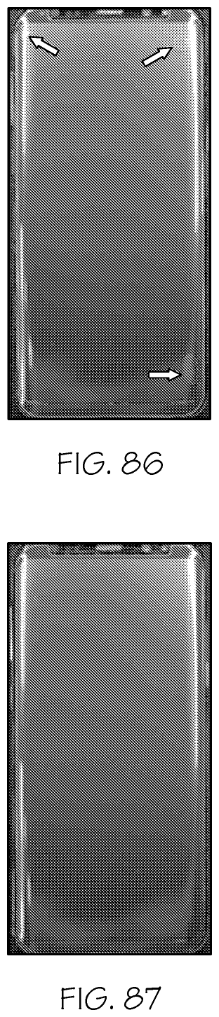

FIG. 86 shows a screen protector according to Example 4C, using the adhesive composition in combination with the adhesive belt but no channels cut in the adhesive belt. The adhesive belt effectively reduces leakage during the application process, as reported in Table XII. Prior to the complete curing of the liquid adhesive the device can still be normally operated by the user, albeit with extra caution. The screen protector of Example 4C has a negligible effect on the touch sensitivity of the display. The adhesive belt of Example 4C trapped bubbles (identified by arrows in FIG. 86) at the corners of the screen protector, due at least in part to the lack of channels in the adhesive belt.

FIG. 87 shows a screen protector according to Example 4D, which is the same as the screen protector of Example 4C except for the addition of four channels cut into the adhesive belt. The channels of Example 4D effectively dissipate bubbles, as shown in FIG. 87. In the application of the screen protector of Example 4D, the adhesive composition was applied by a pipette to the center of the mounting surface prior to the application of the adhesive belt and screen protector glass to the mounting surface.

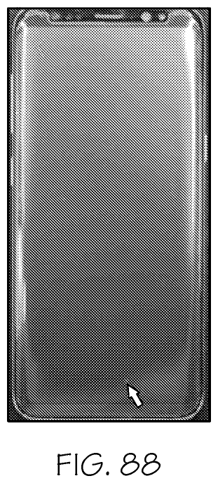

FIG. 88 shows a screen protector according to Example 4E, which is the same as the screen protector of Example 4D except for the method by which the adhesive composition is applied. The adhesive composition of Example 4E was applied after the application of the adhesive belt to the mounting surface by capillary action through a channel in the adhesive belt. Small bubbles were observed after the application of the adhesive composition, as identified by arrows in FIG. 88. The application of the liquid adhesive by capillary action took about 10 minutes.

The volume of liquid adhesive applied, measured leakage (mass loss) of liquid adhesive, leakage perception, and thickness of the liquid adhesive for examples are reported in Table XII below. Examples 4B₁ and 4B₂ utilized the screen protector design of Example 4B. Leakage (mass loss) of liquid adhesive was determined by: measuring the gross mass (m₁) of the screen protector glass, liquid adhesive, and device before application of the screen protector; measuring the gross mass (m₂) of the device with the applied screen protector and liquid adhesive; and subtracting m₁ from m₂.

TABLE XII

| | | | | Adhesive |
|---|---|---|---|---|
| | Applied | Leakage | Leakage | Thickness |
| Example | Volume (μL) | (g) | Perception | (mm) |
| 4A | 0 | — | — | — |
| 4B₁ | 500 | −0.112 | Minor | 0.03 ± 0.03 |
| 4B₂ | 1000 | −0.491 | Medium | 0.05 ± 0.04 |
| 4C | 1100 | −0.031 | Negligible | 0.11 ± 0.02 |
| 4D | 1100 | −0.069 | Minor | 0.10 ± 0.01 |
| 4E | 1100 | −0.034 | Minor | 0.14 ± 0.04 |

As shown in Table XII, the leakage of adhesive composition is noticeable and possibly messy for users of a screen protector without an adhesive belt (Examples 4B1 and 4B2), especially when the amount of adhesive composition is more than required. In the case of these examples, the ideal volume of adhesive composition is calculated as about 500 μL, which is just enough to wet and spread the full area of the display (Example 4B₁). Adding more adhesive composition (1000 μL) resulted in more leakage during the application (Example 4B₂). Moreover, since there is no thickness control due to the lack of an adhesive belt, the thickness variation of the adhesive composition applied is +0.03-0.04 mm (Examples 4B₁ and 4B₂).

The leakage of the adhesive composition was effectively reduced by the use of an adhesive belt on the edges of the screen protector (Examples 4C and 4D). However, without air channels in the belt, air bubbles were confined by the belt and accumulated at the corners (Example 4C). The bubbles were effectively released by adding four air channels at the corners of the adhesive belt (Example 4D), which also provided better thickness control (±0.01 mm) with just minor leakage through the channels. The leakage of the adhesive composition is also well controlled when the central area gap is filled by capillary force with an opening on the adhesive belt (Example 4E). The thickness of the adhesive composition of Example 4E had a large variation due to the slow flow of the adhesive composition. The adhesive composition was filled from the top edge to the bottom edge of the screen protector, resulting in a second adhesive layer that was thicker at the top (˜0.18 mm) and thinner at the bottom (˜0.10 mm) after curing. Moreover, the adhesive composition around the opening could flow and cure under the belt due to the low adhesion of belt caused by the opening.

The above embodiments, and the features of those embodiments, are exemplary and can be provided alone or in any combination with any one or more features of other embodiments provided herein without departing from the scope of the disclosure.

It will be apparent to those skilled in the art that various modifications and variations can be made to the present disclosure without departing from the spirit and scope of the disclosure. Thus, it is intended that the present disclosure cover the modifications and variations of this disclosure provided they come within the scope of the appended claims and their equivalents.

1. A screen protector application kit comprising:
a glass-based substrate having an adhesive belt, the adhesive belt comprising:
a first major surface being adhered to the glass-based substrate;
a second major surface opposite the first major surface;
a distal edge extending between the first major surface and the second major surface; and
a proximal edge extending between the first major surface and the second major surface; and
a container of an uncured adhesive composition, the uncured adhesive composition comprising:
greater than or equal to 30 wt % and less than or equal to 99.9 wt % of at least one of: (i) a monomer; and (ii) an oligomer; and
greater than or equal to 0.01 wt % and less than or equal to 10 wt % of a visible-light photoinitiator.

2. The screen protector application kit of claim 1, wherein the at least one of: (i) a monomer and (ii) an oligomer comprises cyclic hydrocarbon acrylate, aliphatic acrylate, polysiloxane acrylate, polydimethylsiloxane acrylate, silicone polyetheracrylate, urethane acrylate, monofunctional acrylate, difunctional acrylate, trifunctional acrylate, tetrafunctional acrylate, polyfunctional acrylate, or a combination thereof.

3. The screen protector application kit of claim 1, wherein the visible-light photoinitiator comprises phosphine oxide-based compounds, cyanine compounds, fluorone compounds, thioxanthone compounds, phenyl glyoxylate-based compounds, cyclic ketoester-based compounds, benzoin ether-based compounds, amine compounds, α-hydroxy ketone-based compounds, fluorinated diaryl titanocene compounds, or a combination thereof.

4. The screen protector application kit of claim 1, wherein the visible-light photoinitiator has an absorptivity greater than or equal to 200 L/mol/cm and less than or equal to 5000 L/mol/cm in the wavelength range of 380 nm to 750 nm.

5. The screen protector application kit of claim 1, wherein the visible-light photoinitiator has a thickness-normalized absorbance greater than or equal to 2 cm⁻¹ and less than or equal to 50 cm⁻¹ in the wavelength range of 380 nm to 750 nm.

6-10. (canceled)

11. The screen protector application kit of claim 1, wherein the uncured adhesive composition has a viscosity less than or equal to 500 cps as measured at 20° C.

12-19. (canceled)

20. The screen protector application kit of claim 1, wherein the adhesive belt has a thickness greater than or equal to 5 μm and less than or equal to 500 μm.

21. The screen protector application kit of claim 1, wherein the adhesive belt has a width between the distal edge and the proximal edge greater than or equal to 0.1 mm and less than or equal to 30 mm.

22. (canceled)

23. The screen protector application kit of claim 1, wherein the adhesive belt further comprises a plurality of channels extending from the distal edge to the proximal edge.

24. The screen protector application kit of claim 1, wherein the adhesive belt comprises silicone, acrylic, polyurethane, epoxy, cyanoacrylate, polyethylene terephthalate, or a combination thereof.

25. (canceled)

26. The screen protector application kit of claim 1, wherein the glass-based substrate comprises a strengthened glass-based substrate selected from a group consisting of a chemically strengthened glass-based substrate, a thermally strengthened glass-based substrate, and a chemically and thermally strengthened glass-based substrate.

27. The screen protector application kit of claim 1, wherein the glass-based substrate comprises a surface compressive stress greater than or equal to 150 MPa as measured by an FSM-6000 at a wavelength of 596 nm.

28. The screen protector application kit of claim 1, wherein the glass-based substrate comprises a depth of compression greater than or equal to 3 μm as measured by an FSM-6000 at a wavelength of 596 nm.

29. The screen protector application kit of claim 1, wherein the glass-based substrate has a central tension greater than or equal to 1 MPa and less than or equal to 120 MPa as measured by an FSM-6000 at a wavelength of 596 nm.

30. (canceled)

31. The screen protector application kit of claim 1, wherein the glass-based substrate has a thickness of mλ_{g}/2±mλ_{g}/10, where m is an integer greater than or equal to 1 and λ_{g}/2 is the half wavelength of an acoustic wave emitted through the glass-based substrate.

32. The screen protector application kit of claim 1, wherein the glass-based substrate has a thickness of mV_{S}/2f±mV_{S}/10f where m is an integer greater than or equal to 1, V_{S} is a velocity of propagation of an acoustic wave emitted through the glass-based substrate at f, and f is a frequency greater than or equal to 1 MHz and less than or equal to 100 MHz.

33-101. (canceled)

102. The screen protector application kit of claim 1, wherein the uncured adhesive composition further comprises greater than or equal to 0.1 wt % and less than or equal to 10 wt % of a co-initiator, the co-initiator being a silane, carbazole, iodonium salt, sulfonium salt, borate salt, amine, amine acrylate, acrylamide, or a combination thereof.

103. The screen protector application kit of claim 1, wherein the uncured adhesive composition further comprises greater than or equal to 0.1 wt % and less than or equal to 5 wt % of an oxygen inhibitor, the oxygen inhibitor being a phosphine, phosphite, amine, thiol, silane, hydrogen phosphite, stannane, aldehyde, vinyl amide, vinyl lactam, vinylcarbazole, diphenyl furan, dibutyl anthracene, or a combination thereof.

104. The screen protector application kit of claim 1, wherein the uncured adhesive composition is cured by irradiation with a visible light source to form a cured adhesive composition, the cured adhesive composition being a cured liquid optically clear adhesive such that the cured adhesive composition has a visible light transmission greater than 70%, a transmission haze less than 20%, and a clarity greater than 80% as measured by a technique set forth in ASTM D1003 with a standard CIE-C illuminant with a wavelength range of 380 nm to 720 nm at a thickness of 0.2 mm.

105. The screen protector application kit of claim 1, wherein the second major surface of the adhesive belt has a peel force on glass greater than or equal to 20 gf/inch and less than or equal to 5000 gf/inch as measured by a technique set forth in ASTM D3330.
